(19) United States
(12) Patent Application Publication
(10) Pub. No.: US 2008/0212770 A1
(43) Pub. Date: Sep. 4, 2008

(54) Key Information Generating Method and Device, Key Information Updating Method, Tempering Detecting Method and Device, and Data Structure of Key Information

(75) Inventors: Tomoya Satou, Nara (JP); Makoto Fujiwara, Kyoto (JP); Kentaro Shiomi, Kyoto (JP); Yusuke Nemoto, Hyogo (JP); Yuishi Torisaki, Hyogo (JP); Kazuya Shimizu, Osaka (JP); Shinji Inoue, Osaka (JP); Kazuya Fujimura, Nara (JP); Makoto Ochi, Osaka (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD., KADOMA-SHI, OSAKA (JP)

(21) Appl. No.: 11/793,702

(22) PCT Filed: Dec. 20, 2005
(86) PCT No.: PCT/JP05/23397

§ 371 Date: Mar. 31, 2008

(30) Foreign Application Priority Data
Dec. 20, 2004 (JP) 2004-367187

(51) Int. Cl. H04L 9/06

(52) U.S. Cl. 380/44

(57) ABSTRACT

A domain key is used to perform chaining decryption with respect to encrypted content key information (ST203-1), and first data is extracted (ST203-2). The extracted first data is compared with partial-check data (ST203-4). The first data as it is encrypted is extracted from the m pieces of encrypted content key information (ST203-6), and a predetermined operation is executed with respect to concatenated data including m extracted check values to generate second data (ST203-8). The second data is compared with whole-check data included in domain key information (ST203-11). If the first data matches the partial-check data (ST203-5) and the second data matches the whole-check data (ST203-12), it is determined that there is not tampering.

### TECHNICAL FIELD

The present invention relates to a method and a device for detecting the presence or absence of tampering in confidential information stored in a target apparatus or the like, a method and a device for generating confidential information for which the presence or absence of tampering is detected, and a data structure of confidential information for which the presence or absence of tampering is detected.

### BACKGROUND ART

It is necessary to protect contents relating to works, private information or the like (e.g., contents representatively including music data or video data) from unauthorized copying or external leakage. Such contents are stored in an encrypted state in a target apparatus. A host apparatus, when handling an encrypted content stored in the target apparatus, executes an authentication process between the host apparatus and the target apparatus. If the authentication is not successful, the host apparatus cannot obtain a content key for decrypting the encrypted content from the target apparatus. On the other hand, if the authentication is successful, the host apparatus can access and use the content stored in the target apparatus. With such a technique, encrypted contents are prevented from being decrypted by unauthorized host apparatuses. Note that, here, the target apparatus is, for example, a memory card (e.g., an SD card, etc.). The host apparatus is a semiconductor integrated circuit for reading data from the memory card, a set apparatus in which the semiconductor integrated circuit is mounted, or a content distributing apparatus for distributing a content to the target apparatus.

Next, a storage area in a conventional target apparatus and confidential information stored in the storage area will be described with reference to FIG. 32. Note that, hereinafter, the confidential information refers to information (e.g., key information, etc.) required to play a content.

The storage area in the target apparatus is divided into a system area 901, a protected area 902, and an ordinary area 903. The system area 901 is an area for storing information for performing authentication between the target apparatus and the host apparatus. The host apparatus can access the system area 901 only in a predetermined process in which access to the system area 901 is permitted. The protected area 902 is an area which a user (host apparatus) cannot arbitrarily access and can access only after authentication is successful. The ordinary area 903 is an area which a user can arbitrarily access. The system area 901 stores an authentication key. The protected area 902 stores an encrypted content key. The ordinary area 903 stores an encrypted content.

Also, in order to be able to store a number of contents in the target apparatus, the storage size of the ordinary area 903 for storing contents is set to be larger than the storage size of the protected area 902. Therefore, the amount of data which can be stored in the protected area 902 is smaller than the amount of data which can be stored in the ordinary area 903.

Next, a method by which the host apparatus decrypts and uses an encrypted content in the target apparatus, will be described. Initially, the host apparatus uses an authentication key stored in itself and an authentication key stored in the target apparatus to perform authentication. If the authentication is successful, the host apparatus uses these authentication keys to generate an authentication intermediate key. The authentication intermediate key is defined as a key for decrypting an encrypted content key. Therefore, the host apparatus obtains an encrypted content key from the target apparatus and decrypts the encrypted content key using the authentication intermediate key to generate a content key in plain text (in unencrypted form). Further, the host apparatus obtains an encrypted content from the target apparatus and decrypts the encrypted content using the content key in plain text to generate the content in plain text. Thereby, the content becomes usable. By executing the process as described above, only a host apparatus for which authentication is successful can use an encrypted content stored in the target apparatus.

In the above-described content decryption, if authentication is successful, an authentication intermediate key is generated. Therefore, if authentication is successful, an encrypted content can be decrypted. In other words, an encrypted content stored in the target apparatus can be used by any authentic host apparatus.

On the other hand, in recent years, there is an active trend in which, electronic distribution is used to transmit an encrypted content to a specific user so that the content is used only by the specific user. However, when such use of electronic distribution is assumed, the encrypted content to be transmitted to the specific user is required to be decrypted only by a specific host apparatus possessed by the specific user. However, the above-described method cannot satisfy the requirement.

Therefore, a method of setting a valid domain key only for a specific user has been newly contemplated. When the domain key is set, a content is encrypted using a content key, and the content key is encrypted using the domain key set only for the specific user, but not an authentication intermediate key. Also, the domain key itself is encrypted using an authentication intermediate key or another key which is generated using information about the authentication intermediate key before being stored into the target apparatus. Thereby, the confidentiality of the domain key itself is secured.

Confidential information which is stored in the storage area of the target apparatus when the domain key is set, will be described with reference to FIG. 33. Even when the domain key is set, the same method of dividing the area in the target apparatus needs to be used so as to maintain compatibility with conventional target apparatuses. Also, when both the domain key and the content key are stored in the protected area 902, the domain key is stored in an area having the same security level as that of the content key, though the domain key is a key for decrypting the content key. Therefore, in order to maintain compatibility with security, when the domain key is set, the domain key is stored in an encrypted state in the protected area 902. Also, the content key is stored in an encrypted state in the ordinary area 903.

The confidential information stored in the target apparatus will be described in more detail with reference to FIG. 34. In the protected area 902 of the target apparatus, n (n is an integer of 1 or more) encrypted domain keys Ku(1) to Ku(n) are stored. The domain keys Ku(1) to Ku(n) are given n pieces of domain key management information UR[u](1) to UR[u](n) in one-to-one correspondence.

In the ordinary area 903 of the target apparatus, a plurality of content keys are stored. Each content key corresponds to any one of the domain keys Ku(1) to Ku(n). In other words, one domain key can be used to decrypt a plurality of encrypted content keys. For example, m (m is an integer of 1 or more) content keys Kt(1-1) to Kt(1-m) correspond to the domain key Ku(1). The content keys Kt(1-1) to Kt(1-m) are given m pieces of content key management information UR[t](1-1) to UR[t](1-m) and m pieces of additional information info(1-1) to info(1-m) in one-to-one correspondence.

Note that, in FIG. 34, a set of the domain keys Ku(1) to Ku(n) and the domain key management information UR[u](1) to UR[u](n) is indicated by a “domain key group UKURE”, and a set of the content keys Kt(1-1) to Kt(1-m), the content key management information UR[t](1-1) to UR[t](1-m), and the additional information info(1-1) to info(1-m) is indicated by a “content key group TKURE(1)”.

A content key in plain text is required so as to decrypt an encrypted content. Also, a domain key is required so as to decrypt an encrypted content key. In order to quickly search for what content key is decrypted by what domain key, a key correspondence table Address List is also stored in the ordinary area. In the key correspondence table Address List, a correspondence relationship between domain keys and content keys is described. For example, the content keys Kt(1-1) to Kt(1-m) which can be decrypted using the domain key Ku(1) are put in correspondence with the domain key.

Thus, the encrypted content keys are stored in the ordinary area 903. Since the ordinary area 903 is an area which can be arbitrarily accessed by the user, it is important to guarantee the authenticity of the encrypted content keys stored in the ordinary area 903. In other words, it is important to check tampering.

When tampering is checked in confidential information stored in the target apparatus, there is a method which employs a hash function for each piece of confidential information. Here, a procedure for detecting the presence or absence of tampering in confidential information by executing a hash operation with respect to all information relating to the confidential information, will be described. Note that, here, “Enc” is used as a prefix indicating an encrypted state. For example, “EncUR[u](1)” indicates encrypted domain key management information UR[u](1).

Initially, the encrypted content keys EncKt(1-1) to EncKt(1-m) which can be decrypted using the domain key Ku(1), the encrypted content key management information EncUR[t](1-1) to EncUR[t](1-m) corresponding to the encrypted content keys EncKt(1-1) to EncKt(1-m), and the additional information info(1-1) to info(1-m) corresponding to the encrypted content keys EncKt(1-1) to EncKt(1-m) are all concatenated together and are subjected to a hash operation. A hash value Hash(Ku(1)) obtained by the hash operation is stored into the domain key management information UR[u](1).

Next, when tampering is checked in the encrypted content key EncKt(1-1), the host apparatus references the key correspondence table Address List to read out the content key group TKURE(1) from the ordinary area 903 of the target apparatus, and executes a hash operation. On the other hand, the host apparatus uses an authentication intermediate key obtained by authentication to decrypt the encrypted domain key management information EncUR[u](1) stored in the protected area 902 of the target apparatus. Next, the host apparatus extracts the hash value Hash(Ku(1)) from the domain key management information UR[u](1) obtained by the decryption. Next, the host apparatus compares the hash value obtained by the hash operation with the hash value extracted from the domain key management information UR[u](1). When both the values are equal to each other, the host apparatus determines that there is not tampering and decrypts the encrypted content key. On the other hand, when both the values are not equal to each other, the host apparatus determines that there is tampering and does not decrypt the encrypted contents. Patent Document 1: Japanese Unexamined Patent Application Publication No. 2001-203686

### DISCLOSURE OF THE INVENTION

### Problems to be Solved by the Invention

However, the processing amount is considerably large in the tampering detecting method as shown in FIG. 34. Specifically, in order to check tampering in one content key (the content key Kt(1-1)), the host apparatus needs to read out, from the target apparatus, all content keys which can be decrypted using the same domain key and all information (the content key group TKURE(1)) associated with the content keys, and subject the information thus read out to a hash operation. In particular, as the number of contents stored in the target apparatus is increased, the number of content keys is also increased. As a result, the number of content keys corresponding to one domain key is increased, so that the processing time further increases.

Also, it is contemplated that a content and a content key are distributed as a set of data via a network or the like. In such a case, a content key corresponding to one domain key is added/deleted. However, according to conventional methods, when a content key is added/deleted, all content keys corresponding to one domain key (the domain key Ku(1)) and all information (the content key group TKURE(1)) associated with the content keys need to be subjected to a hash operation again, and the calculated hash value need to be buried in domain key management information (domain key management information UR[u](1)) associated with the domain key. Thus, a huge process needs to be executed every time a content key is added/deleted.

Here, it is also contemplated that a hash operation is executed for not all content keys which can be decrypted using the domain key and not all information (the content key group TKURE(1)) associated with the content keys, a hash operation is previously executed each of a plurality of content keys related to one domain key to calculate hash values, and the calculated hash values are buried in domain key management information.

However, as the number of content keys is increased, the number of calculated hash values also increases. Therefore, it is difficult to store all the hash values in the protected area 902 having a small storage size. In this case, the storage size of the protected area 902 needs to be increased, so that the storage size of the ordinary area 903 is reduced, which is not preferable.

Therefore, an object of the present invention is to reduce the amount of data to be stored in a predetermined area and reduce a processing amount during detection of tampering. More specifically, an object of the present invention is to provide a data structure of key information with which the amount of data to be stored in a predetermined area is small and the processing amount during detection of tampering is small, a method and a device for generating the key information, a method and a device for detecting tampering in the key information, and a method for updating the key information.

### Solution to the Problems

According to one aspect of the present invention, in a key information generating method, key information is generated by a host apparatus. The key information includes domain key information and m (m is a natural number) pieces of content key information. The presence or absence of tampering is detected in the key information. The host apparatus comprises a data generating section and a data writing section. The data generating section generates the key information. The data writing section writes the key information generated by the data generating section into a target apparatus. The target apparatus includes a first memory area and a second memory area having a higher security level than that of the first memory area. Each of the m pieces of content key information includes a content key used for encryption and decryption of a content. The domain key information includes a domain key used for encryption and decryption of the m pieces of content key information. The method comprises the steps (A) to (E). In the step (A), the data generating section adds first data to each of the m pieces of content key information, and subjects each of the m pieces of content key information to cipher block chaining using the domain key. The first data corresponds to partial-check data used for a tampering detecting process. In the step (B), the data generating section extracts the first data as it is encrypted from each of the m pieces of content key information encrypted in the step (A). In the step (C), the data generating section executes a predetermined operation with respect to concatenated data including the m pieces of first data extracted in the step (B) to generate second data. In the step (D), the data generating section adds the second data generated in the step (C) as whole-check data to the domain key information. In the step (E), the data writing section writes the m pieces of encrypted content key information into the first memory area and the domain key information into the second memory area.

In the key information generating method, data used for the tampering detecting process is generated in a plurality of separate stages. Also, not all the data used for the tampering detecting process is stored in a predetermined area (the second memory area having a higher security level), and check data for the final stage is stored in the predetermined area. Thereby, the amount of data to be stored in the predetermined area can be reduced. Also, if first data obtained by executing a predetermined process with respect to one piece of content key information is compared with previously prepared partial-check data, the presence or absence of tampering can be detected in the content key information. Also, if second data generated based on m pieces of first data is compared with whole-check data, the presence or absence of tampering can be detected in the whole key information. Therefore, not the whole key information needs to be subjected to the process, thereby making it possible to reduce a processing amount during the tampering detecting process.

Also, in a key information generating method, key information is generated by a host apparatus. The key information includes domain key information and m pieces of content key information. The presence or absence of tampering is detected in the key information. The host apparatus comprises a data generating section and a data writing section. The data generating section generates the key information. The data writing section writes the key information generated by the data generating section into a target apparatus. The target apparatus includes a first memory area and a second memory area having a higher security level than that of the first memory area. Each of the m pieces of content key information includes a content key used for encryption and decryption of a content. The domain key information includes a domain key used for encryption and decryption of the m pieces of content key information. The method comprises the steps (A) to (E). In step (A), the data generating section adds first data to each of the m pieces of content key information, and subjects each of the m pieces of content key information to cipher block chaining using the domain key. The first data corresponds to partial-check data used for a tampering detecting process. In the step (B), the data generating section extracts the first data as it is encrypted from each of the m pieces of content key information encrypted in the step (A). In the step (C), the data generating section executes cipher block chaining with respect to concatenated data including second data and the m pieces of first data extracted in the step (B) and extracts the second data as it is encrypted from the encrypted concatenated data. In the step (D), the data generating section adds the second data extracted in the step (C) as whole-check data to the domain key information. In the step (E), the data writing section writes the m pieces of encrypted first data included in the concatenated data encrypted in the step (C) into the first memory area. Also, in the step (E), the data writing section writes the m pieces of encrypted content key information into the first memory area and the domain key information into the second memory area.

Also, in a key information generating method, key information is generated by a host apparatus. The key information includes domain key information and m pieces of content key information. The presence or absence of tampering is detected in the key information. The host apparatus comprises a data generating section and a data writing section. The data generating section generates the key information. The data writing section writes the key information generated by the data generating section into a target apparatus. The target apparatus includes a first memory area and a second memory area having a higher security level than that of the first memory area. Each of the m pieces of content key information includes a content key used for encryption and decryption of a content. The domain key information includes a domain key used for encryption and decryption of the m pieces of content key information. The method comprises the steps (A) to (E). In the step (A), the data generating section encrypts each of the m pieces of content key information using the domain key. In the step (B), the data generating section executes a first operation with respect to each of the m pieces of content key information encrypted in the step (A) to generate m pieces of first data. In the step (C), the data generating section executes a second operation with respect to concatenated data including the m pieces of first data generated in the step (B) to generate second data. In the step (D), the data generating section adds the second data generated in the step (C) as whole-check data to the domain key information. In the step (E), the data writing section writes the m pieces of first data as m pieces of partial-check data into the first memory area. Also, in the step (E), the data writing section writes the m pieces of encrypted content key information into the first memory area and the domain key information into the second memory area.

According to another aspect of the present invention, in a key information updating method, key information is updated by a host apparatus. The presence or absence of tampering is detected in the key information. The host apparatus comprises a data updating section and a data writing section. The data updating section adds new content key information to the key information and updates the key information. The data writing section writes the key information updated by the data updating section into a target apparatus. The target apparatus includes a first memory area and a second memory area having a higher security level than that of the first memory area. The key information includes domain key information and m pieces of content key information. Each of the m pieces of content key information includes a content key used for encryption and decryption of a content, and first data corresponding to partial-check data used for a tampering detecting process. The domain key information includes a domain key used for encryption and decryption of the m pieces of content key information, and whole-check data. Each of the m pieces of content key information is encrypted. The updating method comprises the steps (A) to (E). In the step (A), the data updating section adds the first data to the new content key information and executes cipher block chaining with respect to the content key information using the domain key. In the step (B), the data updating section extracts the first data as it is encrypted from the content key information encrypted in the step (A). In the step (C), the data updating section executes a predetermined operation with respect to concatenated data including the first data extracted in the step (B) and the first data included in each of the m pieces of encrypted content key information, to generate second data. In the step (D), the data updating section rewrites the whole-check data included in the domain key information with the second data generated in the step (C). In the step (E), the data writing section writes the m pieces of encrypted content key information and the encrypted new content key information into the first memory area and the domain key information into the second memory area.

In the key information updating method, when key information is updated, not the whole key information needs to be subjected to a predetermined process. Therefore, a processing amount during updating of the key information can be reduced. Also, in the updated key information, not all data used for a tampering detecting process is stored in a predetermined area (the second memory area having a higher security level), and check data in a final stage is stored in the predetermined area. Thereby, the amount of data to be stored in the predetermined area can be reduced. Also, when a tampering detecting process is executed with respect to the updated key information, not the whole key information needs to be subjected to the process, a processing amount during detection of tampering can be reduced.

Also, in a key information updating method, key information is updated by a host apparatus. The presence or absence of tampering is detected in the key information. The host apparatus comprises a data updating section and a data writing section. The data updating section adds new content key information to the key information and updates the key information. The data writing section writes the key information updated by the data updating section into a target apparatus. The target apparatus includes a first memory area and a second memory area having a higher security level than that of the first memory area. The key information includes domain key information, m pieces of content key information, m pieces of encrypted first data, and second data. Each of the m pieces of content key information includes a content key used for encryption and decryption of a content, and first data corresponding to partial-check data used for a tampering detecting process. The domain key information includes a domain key used for encryption and decryption of the m pieces of content key information, and whole-check data. Each of the m pieces of content key information is encrypted. The updating method comprises the steps (A) to (E). In the step (A), the data updating section adds the first data to the new content key information and executes cipher block chaining with respect to the content key information using the domain key. In the step (B), the data updating section extracts the first data as it is encrypted from the content key information encrypted in the step (A). In the step (C), the data updating section executes cipher block chaining using the domain key with respect to concatenated data including the second data, the m pieces of encrypted first data, and the first data extracted in the step (B), and extracts the second data as it is encrypted from the encrypted concatenated data. In the step (D), the data updating section rewrites the whole-check data included in the domain key information with the second data generated in the step (C). In the step (E), the data writing section writes the (m+1) pieces of first data included in the concatenated data encrypted in the step (C) into the first memory area. Also, in the step (E), the data writing section writes the m pieces of encrypted content key information and the encrypted new content key information into the first memory area, and the domain key information into the second memory area.

Also, in a key information updating method, key information is updated by a host apparatus. The presence or absence of tampering is detected in the key information. The host apparatus comprises a data updating section and a data writing section. The data updating section adds new content key information to the key information and updates the key information. The data writing section writes the key information updated by the data updating section into a target apparatus. The target apparatus includes a first memory area and a second memory area having a higher security level than that of the first memory area. The key information includes domain key information, m pieces of content key information, and m pieces of partial-check data. Each of the m pieces of content key information includes a content key used for encryption and decryption of a content. The domain key information includes a domain key used for encryption and decryption of the m pieces of content key information, and whole-check data. Each of the m pieces of content key information is encrypted. The updating method comprises the steps (A) to (E). In the step (A), the data updating section encrypts the new content key information. In the step (B), the data updating section executes a first operation with respect to the new content key information encrypted in the step (A) to generate first data. In the step (C), the data updating section executes a second operation with respect to concatenated data including the m pieces of partial-check data and the first data generated in the step (B), to generate second data. In the step (D), the data updating section rewrites the whole-check data included in the domain key information with the second data generated in the step (C). In the step (E), the data writing section writes the m pieces of partial-check data and the first data as (m+1) pieces of partial-check data into the first memory area. Also, in the step (E), the data writing section writes the m pieces of encrypted content key information and the encrypted new content key information into the first memory area, and the domain key information into the second memory area.

Also, in a key information updating method, key information is updated by a host apparatus. The presence or absence of tampering is detected in the key information. The host apparatus comprises a data updating section and a data writing section. The data updating section deletes any one piece of content key information from the key information in which the presence or absence of tampering can be detected, and updates the key information. The data writing section writes the key information updated by the data updating section into a target apparatus. The target apparatus includes a first memory area and a second memory area having a higher security level than that of the first memory area. The key information includes domain key information and m pieces of content key information. Each of the m pieces of content key information includes a content key used for encryption and decryption of a content, and first data corresponding to partial-check data used for a tampering detecting process. The domain key information includes a domain key used for encryption and decryption of the m pieces of content key information, and whole-check data. Each of the m pieces of content key information is encrypted. The updating method comprises the steps (A) to (E). In the step (A), the data updating section deletes any one of the m pieces of encrypted content key information. In the step (B), the data updating section extracts first data as it is encrypted from each of the (m−1) pieces of encrypted content key information which are not deleted in the step (A). In the step (C), the data updating section executes a predetermined operation with respect to concatenated data including the (m−1) pieces of first data extracted in the step (B) to generate second data. In the step (D), the data updating section rewrites the whole-check data included in the domain key information with the second data generated in the step (C). In the step (E), the data writing section writes the (m−1) pieces of encrypted content key information into the first memory area and the domain key information into the second memory area.

Also, in a key information updating method, key information is updated by a host apparatus. The presence or absence of tampering is detected in the key information. The host apparatus comprises a data updating section and a data writing section. The data updating section deletes any one piece of content key information from the key information in which the presence or absence of tampering can be detected, and updates the key information. The target apparatus includes a first memory area and a second memory area having a higher security level than that of the first memory area. The key information includes domain key information, m pieces of content key information, m pieces of encrypted first data, and second data. Each of the m pieces of content key information includes a content key used for encryption and decryption of a content, and first data corresponding to partial-check data used for a tampering detecting process. The domain key information includes a domain key used for encryption and decryption of the m pieces of content key information, and whole-check data. The m pieces of encrypted first data are in one-to-one correspondence with the m pieces of content key information. Each of the m pieces of content key information is encrypted. The updating method comprises the steps (A) to (E). In the step (A), the data updating section deletes any one of the m pieces of content key information. In the step (B), the data updating section extracts first data as it is encrypted from each of the (m−1) pieces of encrypted content key information which are not deleted in the step (A). In the step (C), the data updating section deletes first data corresponding to content key information deleted in the step (A) of the m pieces of encrypted first data. In the step (C), the data updating section executes cipher block chaining using the domain key with respect to concatenated data including the second data and the (m−1) encrypted first data which are not deleted in the step (B), and extracts the second data as it is encrypted from the encrypted concatenated data. In the step (D), the data updating section rewrites the whole-check data included in the domain key information with the second data extracted in the step (C). In the step (E), the data writing section writes the (m−1) pieces of first data included in the concatenated data encrypted in the step (C) into the first memory area. Also, in the step (E), the data writing section writes the (m−1) pieces of encrypted content key information into the first memory area, and the domain key information into the second memory area.

Also, in a key information updating method, key information is updated by a host apparatus. The presence or absence of tampering is detected in the key information. The host apparatus comprises a data updating section and a data writing section. The data updating section deletes any one piece of content key information from the key information in which the presence or absence of tampering can be detected, and updates the key information. The target apparatus includes a first memory area and a second memory area having a higher security level than that of the first memory area. The target apparatus includes a first memory area and a second memory area having a higher security level than that of the first memory area. The key information includes domain key information, m pieces of content key information, and m pieces of partial-check data. Each of the m pieces of content key information includes a content key used for encryption and decryption of a content. The domain key information includes a domain key used for encryption and decryption of the m pieces of content key information, and whole-check data. The m pieces of partial-check data are in one-to-one correspondence with the m pieces of content key information. Each of the m pieces of content key information is encrypted. The updating method comprises the steps (A) to (E). In the step (A), the data updating section deletes any one of the m pieces of encrypted content key information. In the step (B), the data updating section deletes partial-check data corresponding to the content key information deleted in the step (A) of the m pieces of partial-check data. In the step (C), the data updating section executes a second operation with respect to concatenated data including the (m−1) partial-check data which are not deleted in the step (B) to generate second data. In the step (D), the data updating section rewrites the whole-check data included in the domain key information with the second data generated in step (C). In the step (E), the data writing section writes the (m−1) partial-check data which are not deleted in the step (B) into the first memory area. Also, in the step (E), the data writing section writes the (m−1) pieces of encrypted content key information into the first memory area, and the domain key information into the second memory area.

According to still another aspect of the present invention, in a tampering detecting method, the presence or absence of tampering is detected by a host apparatus in key information stored in a target apparatus. The key information includes domain key information and m (m is a natural number) pieces of content key information. Each of the m pieces of content key information includes a content key used for encryption and decryption of a content, and first data corresponding to partial-check data used for a tampering detecting process. The domain key information includes a domain key used for encryption and decryption of the m content keys, and whole-check data. Each of the m pieces of content key information is encrypted. The detecting method comprises the steps (A) to (E). In the step (A), chaining decryption is executed using the domain key with respect to any one of the m pieces of encrypted content key information, and the first data is extracted from the decrypted content key information. In the step (B), the first data extracted in the step (A) is compared with previously prepared partial-check data. In the step (C), the first data as it is encrypted is extracted from each of the m pieces of content key information, and a predetermined operation is executed with respect to concatenated data including the m pieces of extracted first data to generate second data. In the step (D), the second data generated in the step (C) is compared with the whole-check data included in the domain key information. In the step (E), it is determined that the key information has not been tampered if the first data matches the partial-check data in the step (B) and the second data matches the whole-check data in the step (D).

In the tampering detecting method, not the whole key information needs to be subjected to a process. Therefore, a processing amount during the tampering detecting process can be reduced. Also, not all data used for the tampering detecting process needs to be stored in a predetermined area (the second memory area having a higher security level), and check data used in a final stage only needs to be stored in the predetermined area. Thereby, the amount of data to be stored in the predetermined area can be reduced.

Also, in a tampering detecting method, the presence or absence of tampering is detected by a host apparatus in key information stored in a target apparatus. The key information includes domain key information, m pieces of content key information, m pieces of encrypted first data, and second data. Each of the m pieces of content key information includes a content key used for encryption and decryption of a content, and first data corresponding to partial-check data used for a tampering detecting process. The domain key information includes a domain key used for encryption and decryption of the m content keys, and whole-check data. Each of the m pieces of content key information is encrypted. The detecting method comprises the steps (A) to (E). In the step (A), chaining decryption is executed using the domain key with respect to any one of the m pieces of encrypted content key information, and the first data is extracted from the decrypted content key information. In the step (B), the first data extracted in the step (A) is compared with previously prepared partial-check data. In the step (C), chaining decryption is executed using the domain key with respect to concatenated data including the whole-check data included in the domain key information and the m pieces of encrypted first data, and the whole-check data is extracted from the decrypted concatenated data. In the step (D), the second data is compared with the whole-check data extracted in the step (C). In the step (E), it is determined that the key information has not been tampered if the first data matches the partial-check data in the step (B) and the second data matches the whole-check data in the step (D).

Also, in a tampering detecting method, the presence or absence of tampering is detected by a host apparatus in key information stored in a target apparatus. The key information includes domain key information, m pieces of content key information, and m pieces of partial-check data. Each of the m pieces of content key information includes a content key used for encryption and decryption of a content. The domain key information includes a domain key used for encryption and decryption of the m content keys, and whole-check data. The m pieces of partial-check data are in one-to-one correspondence with the m pieces of content key information. Each of the m pieces of content key information is encrypted. The detecting method comprises the steps (A) to (E). In the step (A), a first operation is executed with respect to any one of the m pieces of encrypted content key information to generate first data. In the step (B), the first data generated in the step (A) is compared with partial-check data corresponding to content key information subjected to the first operation in the step (A) of the m pieces of partial-check data. In the step (C), a second operation is executed with respect to concatenated data including the m pieces of partial-check data to generate second data. In the step (D), the second data generated in the step (C) is compared with the whole-check data included in the domain key information. In the step (E), it is determined that the key information has not been tampered if the first data matches the partial-check data in the step (B) and the second data matches the whole-check data in the step (D).

According to even still another aspect of the present invention, a data structure of key information comprises m pieces of content key information and domain key information. The key information is stored in a target apparatus. Also, the presence or absence of tampering is detected in the key information by a host apparatus. The target apparatus includes a first memory area and a second memory area having a higher security level than that of the first memory area. The m pieces of content key information are stored in the first memory area. The domain key information is stored in the second memory area. Each of the m pieces of content key information includes a content key used for encryption and decryption of a content, and first data corresponding to partial-check data used for a tampering detecting process by the host apparatus. The domain key information includes a domain key used for encryption and decryption of the m pieces of content key information, and whole-check data used for the tampering detecting process by the host apparatus. Each of the m pieces of content key information is encrypted. The whole-check data corresponds to data which is obtained by extracting the first data as it is encrypted from each of m pieces of encrypted content key information which have not been tampered, and executing a predetermined operation with respect to concatenated data including the m pieces of extracted first data.

In the key information data structure, not all the data used for the tampering detecting process is stored in a predetermined area (the second memory area having a higher security level), and check data for the final stage is stored in the predetermined area. Thereby, the amount of data to be stored in the predetermined area can be reduced. Also, if first data obtained by executing a predetermined process with respect to one piece of content key information is compared with previously prepared partial-check data, the presence or absence of tampering can be detected in the content key information. Also, if second data generated based on m pieces of first data is compared with whole-check data, the presence or absence of tampering can be detected in the whole key information. Therefore, not the whole key information needs to be subjected to the process, thereby making it possible to reduce a processing amount during the tampering detecting process.

Also, a data structure of key information comprises m pieces of content key information, domain key information, m pieces of encrypted first data, and second data. The key information is stored in a target apparatus. Also, the presence or absence of tampering is detected in the key information by a host apparatus. The target apparatus includes a first memory area and a second memory area having a higher security level than that of the first memory area. The m pieces of content key information, the m pieces of encrypted first data, and the second data are stored in the first memory area. The domain key information is stored in the second memory area. Each of the m pieces of content key information includes a content key used for encryption and decryption of a content, and first data corresponding to partial-check data used for a tampering detecting process by the host apparatus. The domain key information includes a domain key used for encryption and decryption of the m pieces of content key information, and whole-check data used for the tampering detecting process by the host apparatus. The m pieces of encrypted first data are in one-to-one correspondence with the m pieces of content key information. Each of the m pieces of content key information is encrypted. The whole-check data corresponds to second data which is obtained by executing cipher block chaining using the domain key with respect to concatenated data including m pieces of encrypted first data which have not been tampered and the second data, and extracting the second data as it is encrypted from the encrypted concatenated data.

Also, a data structure of key information comprises m pieces of content key information, domain key information, and m pieces of partial-check data. The key information is stored in a target apparatus. Also, the presence or absence of tampering is detected in the key information by a host apparatus. The target apparatus includes a first memory area and a second memory area having a higher security level than that of the first memory area. The m pieces of content key information and the m pieces of partial-check data are stored in the first memory area. The domain key information is stored in the second memory area. Each of the m pieces of content key information includes a content key used for encryption and decryption of a content. The domain key information includes a domain key used for encryption and decryption of the m pieces of content key information, and whole-check data used for a tampering detecting process by the host apparatus. The m pieces of partial-check data are in one-to-one correspondence with the m pieces of content key information. Each of the m pieces of partial-check data corresponds to data which is obtained by executing a first operation with respect to content key information which corresponds to the partial-check data and has not been tampered. The whole-check data corresponds to data which is obtained by executing a second operation with respect to concatenated data including m pieces of partial-check data which have not been tampered.

### EFFECT OF THE INVENTION

As described above, not all data used for the tampering detecting process is stored in a predetermined area (the second memory area having a higher security level), and check data for the final stage is stored in the predetermined area. Thereby, the amount of data to be stored in the predetermined area can be reduced.

Also, not the whole key information needs to be subjected to the process, thereby making it possible to reduce a processing amount during the tampering detecting process.

Also, when the key information is updated, not the whole key information needs to be subjected to a predetermined process. Therefore, a processing amount during updating of the key information can be reduced.

### BRIEF DESCRIPTION OF THE DRAWINGS

FIG. 1 is a block diagram showing a whole configuration of a confidential information processing system according to a first embodiment of the present invention.

FIG. 2 is a diagram showing confidential information stored in a target apparatus in the first embodiment of the present invention.

FIG. 3 is a diagram for describing encryption/decryption of a domain key and encryption/decryption of a content key.

FIG. 4 is a diagram for describing a procedure for generating a hash list and whole-check data shown in FIG. 2.

FIG. 5 is a schematic flowchart showing an operation of the confidential information processing system.

FIG. 6 is a diagram for describing an authentication process.

FIG. 7 is a flowchart of a tampering detecting method in the first embodiment of the present invention.

FIG. 8 is a diagram for describing a procedure for updating a hash list and whole-check data when content key information is added.

FIG. 9 is a diagram for describing a procedure for updating a hash list and whole-check data when content key information is deleted.

FIG. 10 is a diagram for describing a variation of the confidential information of FIG. 2.

FIG. 11 is a diagram for describing a variation of the confidential information of FIG. 2.

FIG. 12 is a diagram for describing cipher block chaining.

FIG. 13 is a block diagram showing a whole configuration of a confidential information processing system according to a second embodiment of the present invention.

FIG. 14 is a diagram showing confidential information stored in a target apparatus shown in FIG. 13.

FIG. 15 is a diagram for describing a procedure for generating whole-check data shown in FIG. 14.

FIG. 16 is a diagram for describing a procedure of a tampering detecting process which uses a check value.

FIG. 17 is a flowchart of a tampering detecting method in the second embodiment of the present invention.

FIG. 18 is a diagram for describing a procedure for updating whole-check data when content key information is added.

FIG. 19 is a diagram for describing a procedure for updating whole-check data when content key information is deleted.

FIG. 20 is a diagram for describing a one-way function type hash operation (DES HASH).

FIG. 21 is a diagram showing an algorithm for executing the hash operation of FIG. 20.

FIG. 22 is a diagram for describing a one-way function type hash operation (C2).

FIG. 23 is a diagram for describing cipher block chaining (DES E-CBC).

FIG. 24 is a diagram showing an algorithm for executing the cipher block chaining of FIG. 23.

FIG. 25 is a diagram for describing cipher block chaining (C2 E-CBC).

FIG. 26 is a diagram for describing a variation of the confidential information of FIG. 14.

FIG. 27 is a diagram showing confidential information stored in a target apparatus in a third embodiment of the present invention.

FIG. 28 is a diagram for describing a procedure for generating a check value list and whole-check data shown in FIG. 27.

FIG. 29 is a diagram for describing a procedure of a tampering detecting process which uses a whole-check value and a check value list.

FIG. 30 is a diagram for describing a procedure for updating a check value list and whole-check data when content key information is added.

FIG. 31 is a diagram for describing a procedure for updating a check value list and whole-check data when content key information is deleted.

FIG. 32 is a diagram showing confidential information stored in a conventional target apparatus.

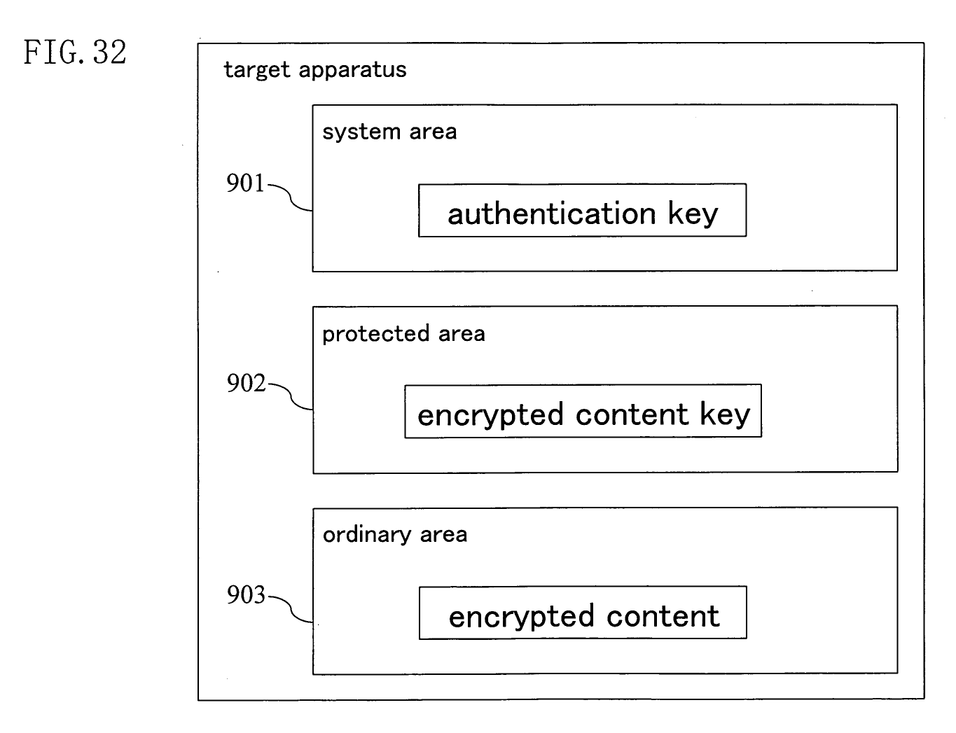

FIG. 33 is a diagram showing confidential information stored in a target apparatus when a domain key is set.

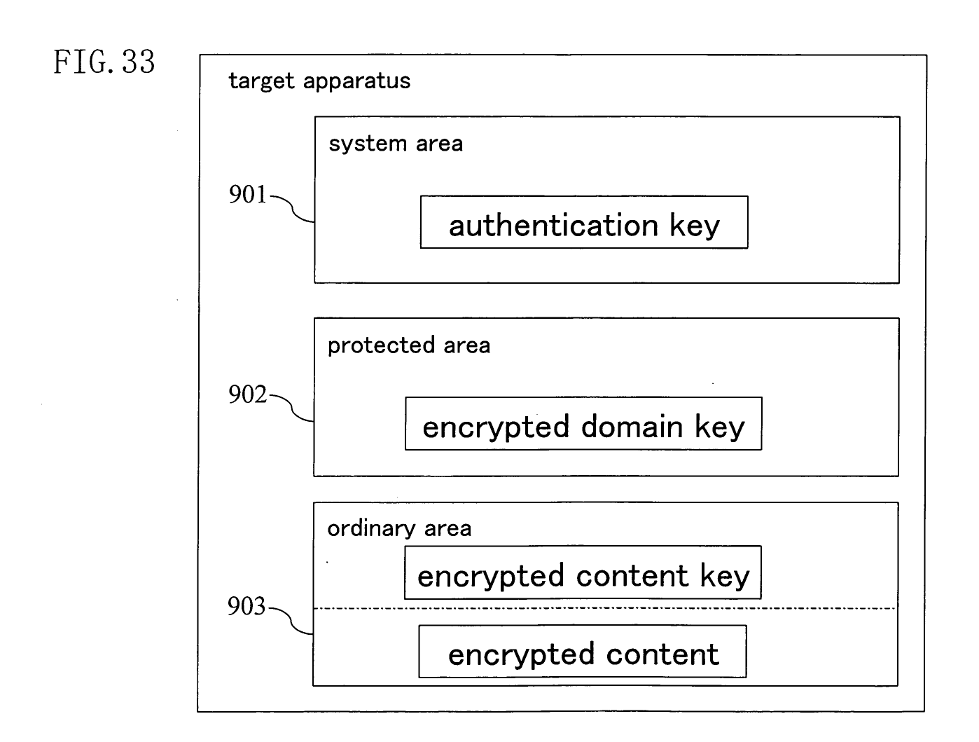

FIG. 34 is a diagram showing the confidential information stored in the target apparatus in more detail.

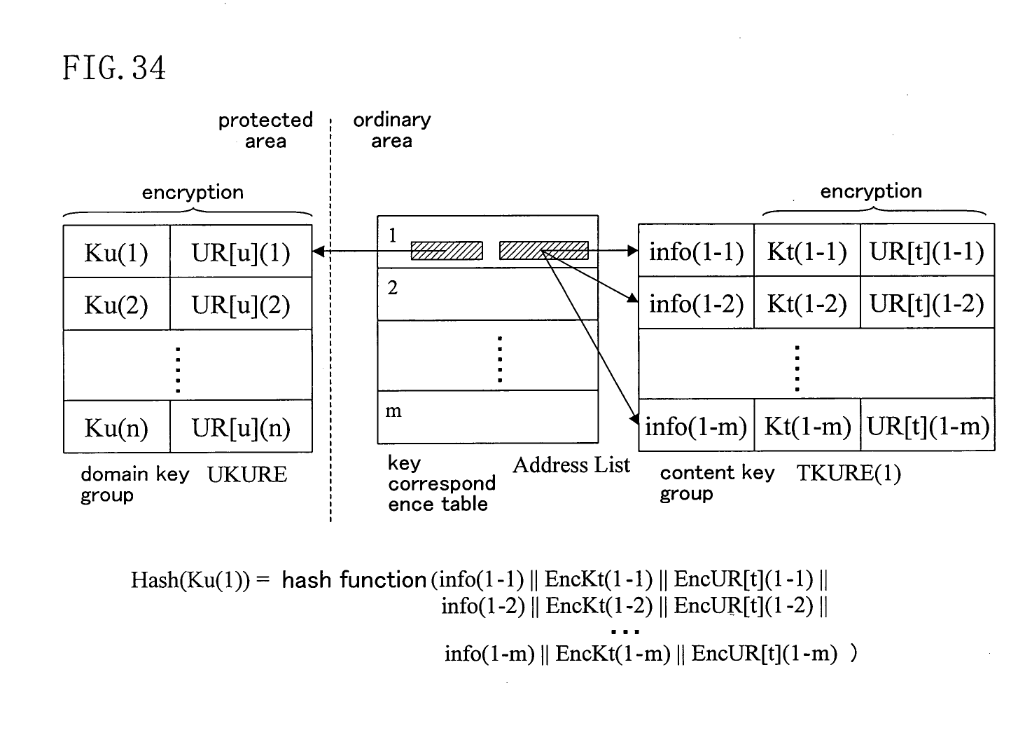

### DESCRIPTION OF THE REFERENCE CHARACTERS

(10) target apparatus
(11) host apparatus
(101, 901) system area
(102, 902) protected area
(103, 903) ordinary area
(111) internal bus
(112) target I/F section
(113) confidential information processing section
(114) host I/F section
(115) host CPU
(116) ROM
(117) RAM

### BEST MODE FOR CARRYING OUT THE INVENTION

Hereinafter, embodiments of the present invention will be described in detail with reference to the accompanying drawings. Note that the same or like parts are indicated by the same reference numerals and will not be repeatedly described.

### First Embodiment

<Whole Configuration>

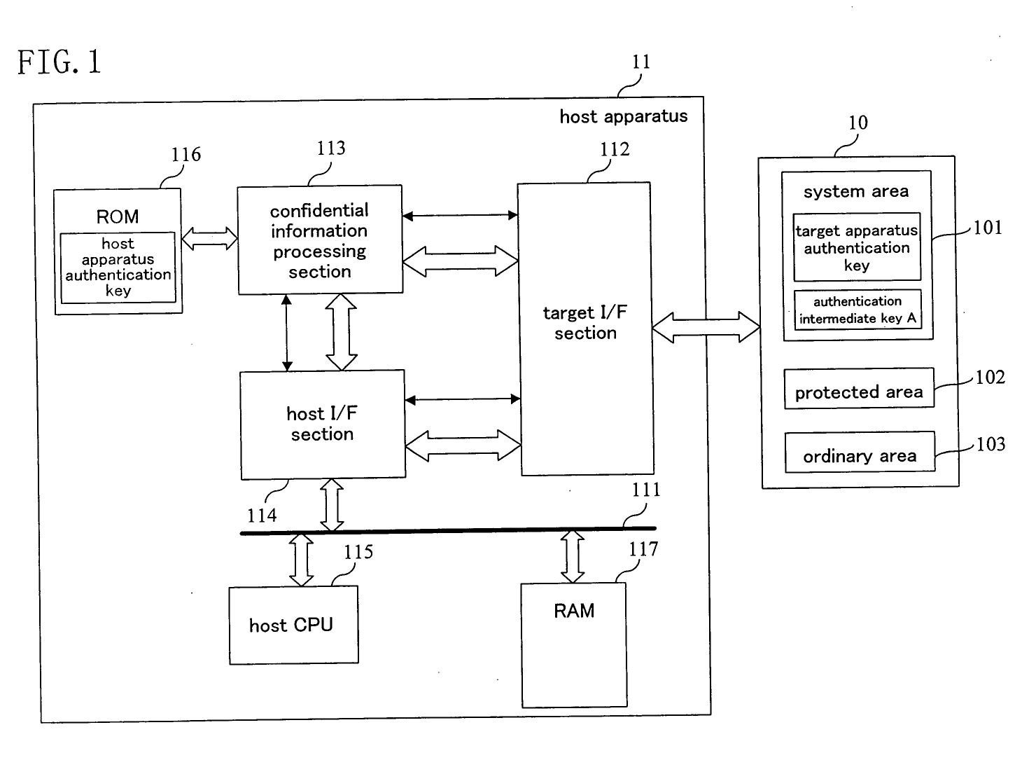

FIG. 1 shows a whole configuration of a confidential information processing system according to a first embodiment of the present invention. The confidential information processing system comprises a target apparatus 10 and a host apparatus 11. The target apparatus 10 is a portable memory device, such as a memory card (e.g., representatively, an SD card), and stores data including key information. The host apparatus 11, to which the target apparatus 10 is connected, reads and writes key information from and to the target apparatus 10. Note that the target apparatus 10 and the host apparatus 11 may be integrated together.

<Internal Configuration of Target Apparatus>

The target apparatus 10 includes a system area 101, a protected area 102, and an ordinary area 103. A storage size of each of the system area 101, the protected area 102 and the ordinary area 103 is previously set. For example, ideally, about 1% of the whole storage area (e.g., 512 MB) of the target apparatus 10 is allocated for the system area 101 and the protected area 102, and the remainder is allocated for the ordinary area 103.

[System Area]

The system area 101 is divided into an area which can be accessed by the host apparatus 11 and an area which cannot be accessed by the host apparatus 11. In the area of the system area 101 which can be accessed by the host apparatus 11, information (target apparatus authentication key) required for an authentication process executed between the target apparatus 10 and the host apparatus 11 is stored. In the area of the system area 101 which cannot be accessed by the host apparatus 11, an authentication intermediate key A obtained as a result of mutual authentication is previously stored. Information which should be stored in the system area 101 is previously written during a manufacturing stage, and cannot be rewritten after shipment of the product.

[Protected Area]

The protected area 102 is an area which can be accessed by the host apparatus 11 only after the authentication process executed between the target apparatus 10 and the host apparatus 11 is successful. In the protected area 102, at least one piece of domain key information is stored. The domain key information includes a domain key. Also, the domain key information may include domain key management information. For example, information for specifying a host apparatus which can use the domain key is written in the domain key management information.

[Ordinary Area]

The ordinary area 103 is an area which can be arbitrarily accessed by the host apparatus 11. In the ordinary area 103, a plurality of pieces of content key information and a plurality of contents are stored. Each of the pieces of content key information corresponds to any one of the pieces of domain key information stored in the protected area 102. Each of the pieces of content key information includes a content key. Also, each of the pieces of content key information may include content key management information. In the content key management information, the limit number of times of playing of a content, the limit number of times of copying of a content, information about the copyright of a content, and the like are written. The pieces of contents are in one-to-one correspondence with the pieces of content key information.

The domain key information is encrypted using the authentication intermediate key A. Each of the pieces of content key information is encrypted using a corresponding domain key. The contents are encrypted using the respective corresponding content keys.

<Internal Configuration of Host Apparatus>

The host apparatus 11 includes an internal bus 111, a target I/F section 112, a confidential information processing section 113, a host I/F section 114, a host CPU 115, a ROM 116, and a RAM 117. The target I/F section 112 receives and outputs data from and to the target apparatus 10. The confidential information processing section 113 executes authentication with the target apparatus 10 in accordance with a predetermined sequence. Also, the confidential information processing section 113 executes encryption/decryption of confidential information stored in the target apparatus 10. The host I/F section 114 receives and outputs data from and to the target I/F section 112, the confidential information processing section 113, and the host CPU 115. The host CPU 115 causes the confidential information processing section 113 to execute a predetermined sequence. The ROM 116 stores a host apparatus authentication key. The RAM 117 is used as a work area for temporarily storing data for the host CPU 115 and the confidential information processing section 113.

When reading/writing of confidential information is performed between the target apparatus 10 and the host apparatus 11, authentication needs to be performed between the target apparatus 10 and the host apparatus 11. In this case, the confidential information processing section 113 is activated by the host CPU 115 so that the confidential information processing section 113 performs an authentication process. If authentication is successful, the host apparatus 11 reads out confidential information via the target I/F section 112 from the target apparatus 10, and the confidential information is decrypted by the confidential information processing section 113.

The confidential information processing section 113 is confidential hardware. Also, the confidential information processing section 113, when activated by the host CPU 115, executes only a predetermined sequence(s) whose security is established or is less required.

<Confidential Information>

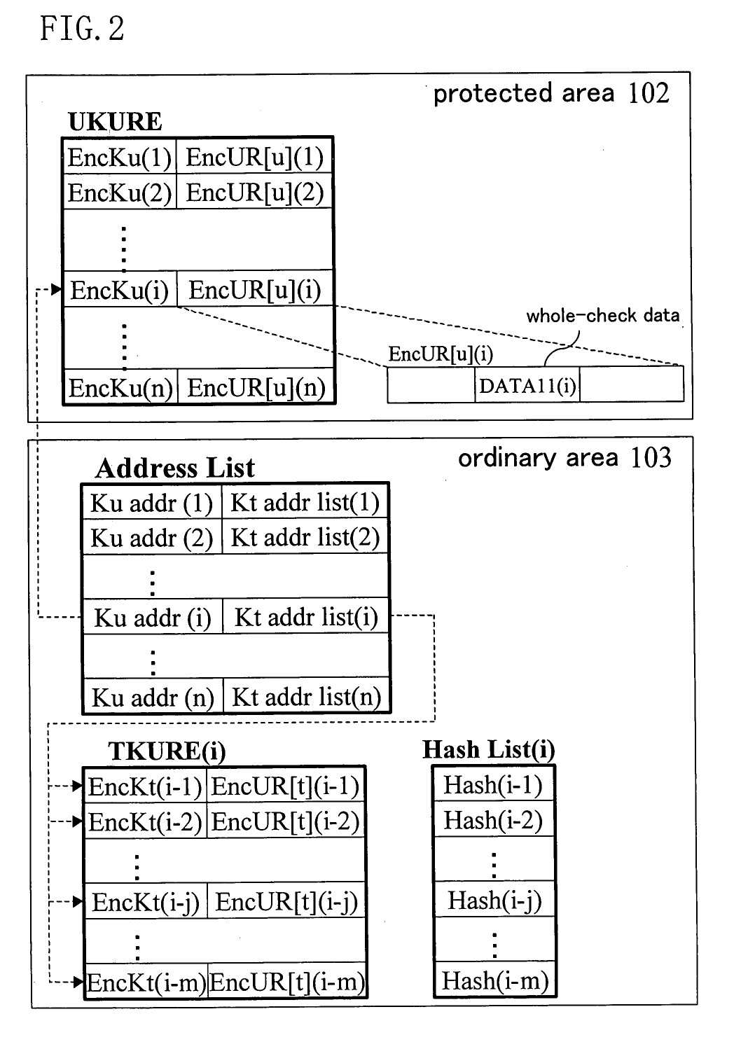

Next, confidential information stored in the target apparatus 10 will be described with reference to FIG. 2. The protected area 102 stores a domain key group UKURE. The ordinary area 103 stores a key correspondence table Address List, a content key group TKURE(i), and a hash list Hash List(i). Although the ordinary area 103 also stores an encrypted content, the encrypted contents are not shown in FIG. 2.

[Domain Key Group]

The domain key group UKURE includes n (n is an integer of 1 or more) encrypted domain keys EncKu(1) to EncKu(n), and n pieces of encrypted domain key management information EncUR[u](1) to EncUR[u](n).

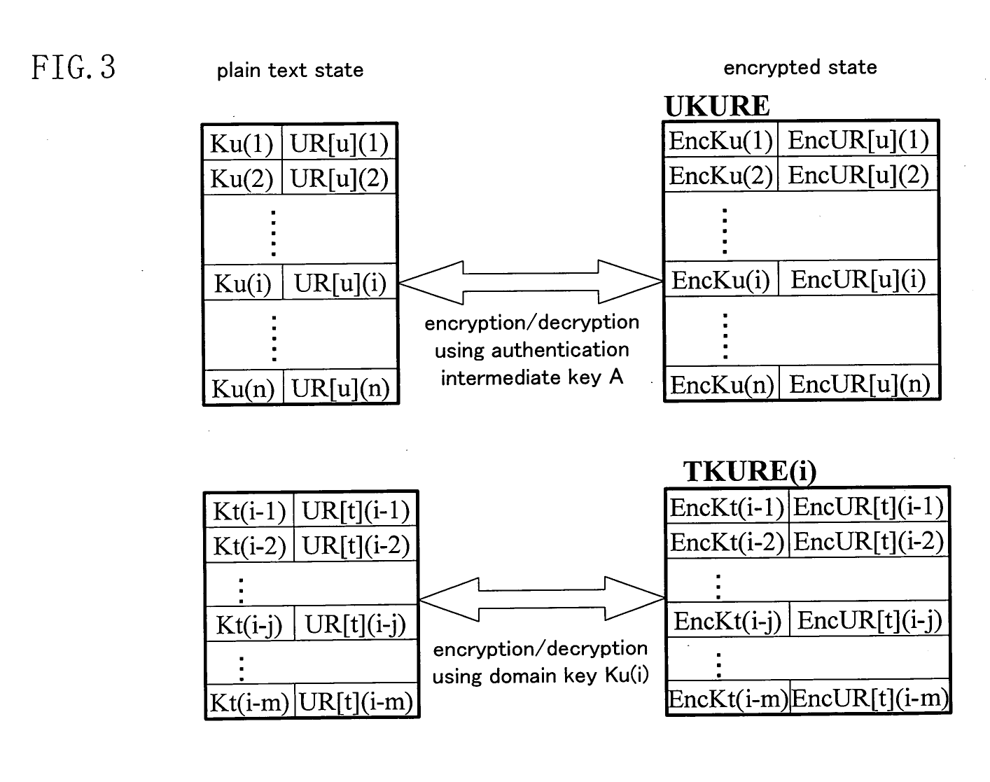

A plurality of encrypted content keys (one content key group) are put in correspondence with each of the encrypted domain keys EncKu(1) to EncKu(n). Also, as shown in FIG. 3, the encrypted domain keys EncKu(1) to EncKu(n) are decrypted using the authentication intermediate key A into domain keys Ku(1) to Ku(n). Each of the domain keys Ku(1) to Ku(n) is used to encrypt/decrypt a plurality of content keys which are put in correspondence with itself. In other words, one domain key can be used to encrypt/decrypt a plurality of content keys.

The encrypted domain key management information EncUR[u](1) to EncUR[u](n) are in one-to-one correspondence with the encrypted domain keys EncKu(1) to EncKu(n). Also, as shown in FIG. 3, the encrypted domain key management information EncUR[u](1) to EncUR[u](n) are decrypted using the authentication intermediate key A into domain key management information UR[u](1) to UR[u](n). Further, whole-check data is stored at a predetermined position in each of the encrypted domain key management information EncUR[u](1) to EncUR[u](n). The whole-check data is generated based on a content key group corresponding to the encrypted domain key management information. For example, whole-check data DATA11(i) generated based on the content key group TKURE(i) is stored at a predetermined position in i-th encrypted domain key management information EncUR[u](i) (i is an integer and 1≦i≦n) of the encrypted domain key management information EncUR[u](1) to EncUR[u](n).

Note that, in FIG. 2, although only the content key group TKURE(i) corresponding to the encrypted domain key EncKu(i) is shown, other encrypted domain keys as well as the encrypted domain key EncKu(i) may be in one-to-one correspondence with content key groups.

[Content Key Group]

The content key group TKURE(i) is a set of content keys which can be encrypted/decrypted using the domain key Ku(i), and information associated with the content keys. The content key group TKURE(i) includes m (m is an integer of 1 or more) encrypted content keys EncKt(i−1) to EncKt(i−m) and m pieces of encrypted content key management information EncUR[t](i−1) to EncUR[t](i−m).

As shown in FIG. 3, the encrypted content keys EncKt(i−1) to EncKt(i−m) are decrypted using the domain key Ku(i) into content keys Kt(i−1) to Kt(i−m). Each of the content keys Kt(i−1) to Kt(i−m) is used to encrypt/decrypt a content (not shown) corresponding to itself.

The encrypted content key management information EncUR[t](i−1) to EncUR[t](i−m) are in one-to-one correspondence with the encrypted content keys EncKt(i−1) to EncKt(i−m). Also, as shown in FIG. 3, the encrypted content key management information EncUR[t](i−1) to EncUR[t](i−m) are decrypted using the domain key Ku(i) into content key management information UR[t](i−1) to UR[t](i−m).

[Key Correspondence Table]

In the key correspondence table Address List, addresses Ku addr(1) to Ku addr(n) of n encrypted domain keys are put in correspondence with n content key tables Kt addr list(1) to Kt addr list(n). The n content key tables are in one-to-one correspondence with n content groups (only the content key group TKURE(i) is shown in FIG. 2). Also, in each content key table, addresses of encrypted content keys included in a corresponding content key group are written. For example, the content key group TKURE(i) (specifically, the encrypted content keys EncKt(i−1) to EncKt(i−m)) corresponding to the domain key Ku(i) can be searched for by referencing the content key table Kt addr list(i) corresponding to the address Ku addr (i) of the domain key Ku(i). Thus, a correspondence relationship between domain keys and content keys can be quickly searched by referencing the key correspondence table Address List.

[Hash List]

The hash list Hash List(i) corresponds to the content key group TKURE(i). Also, the hash list Hash List(i) includes m hash values Hash(i−1) to Hash(i−m). The hash values Hash(i−1) to Hash(i−m) are in one-to-one correspondence with the encrypted content keys EncKt(i−1) to EncKt(i−m). Although only the hash list Hash List(i) corresponding to the content key group TKURE(i) is shown in FIG. 2, hash lists corresponding to other content key groups (not shown) as well as the content key group TKURE(i) may be present.

<Procedure for Generating Hash List>

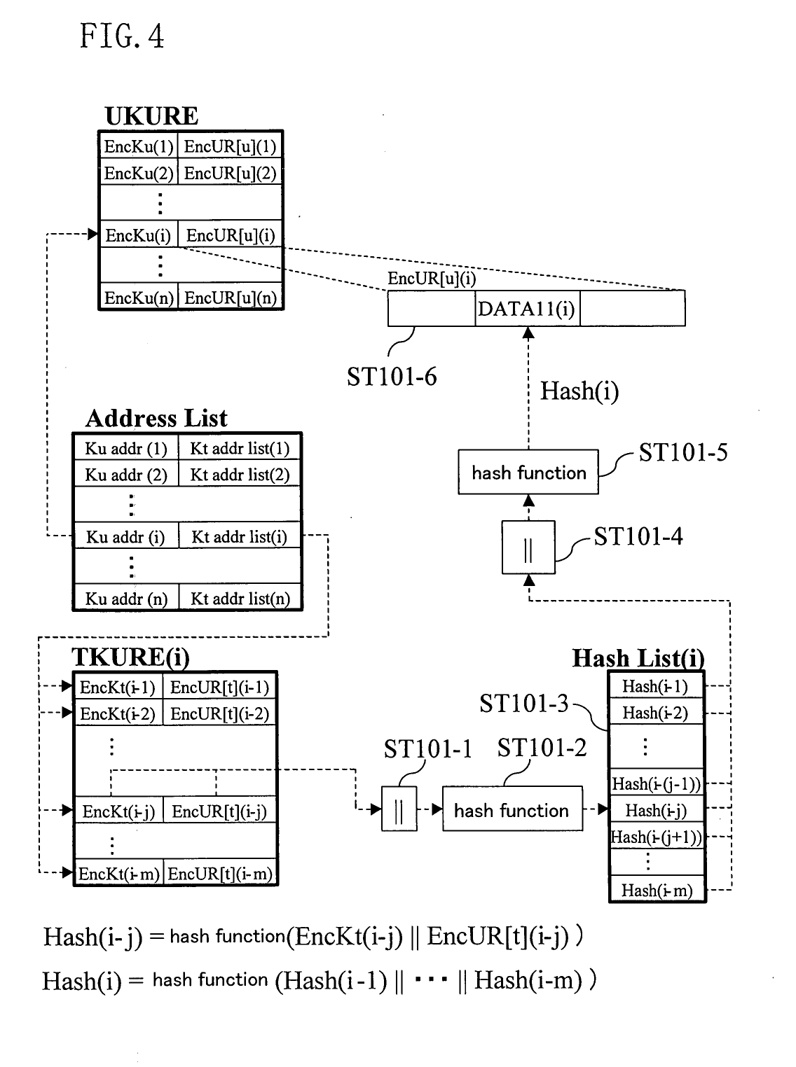

Next, a procedure for generating the hash list Hash List(i) of FIG. 2 will be described with reference to FIG. 4.

[Step ST101-1]

Initially, the encrypted content key EncKt(i−1) and the encrypted content key management information EncUR[t](i−1) are concatenated together. Each of the encrypted content keys EncKt(i−2) to EncKt(i−m) is similarly concatenated together with encrypted content key management information associated with the encrypted content key. Thereby, m pieces of concatenated data are generated.

[Step ST101-2]

Next, a hash operation is executed with respect to the concatenated data corresponding to the encrypted content key EncKt(i−1). Thereby, the hash value Hash(i−1) is calculated. Similarly, the hash operation is executed with respect to the concatenated data corresponding to each of the encrypted content keys EncKt(i−2) to EncKt(i−m). Thereby, the m hash values Hash(i−1) to Hash(i−m) are calculated.

[Step ST101-3]

Next, the calculated m hash values Hash(i−1) to Hash(i−m) are grouped into one list. Thereby, the hash list Hash List(i) corresponding to the content key group TKURE(i) is completed.

<Procedure for Generating Concatenated Hash Value>

Next, a procedure for generating the whole-check data DATA11(i) of FIG. 2 will be described with reference to FIG. 4.

[Step ST101-4]

Initially, the m hash values Hash(i−1) to Hash(i−m) present in the hash list Hash List(i) are concatenated together. Thereby, one piece of hash concatenated data is generated.

[Step ST101-5]

Next, a hash operation is executed with respect to the hash concatenated data generated in step ST101-4. Thereby, a concatenated hash value Hash(i) is calculated.

[Step ST101-6]

Next, the concatenated hash value Hash(i) calculated in step ST101-5 is stored as the whole-check data DATA11(i) at a predetermined position in the encrypted domain key management information EncUR[u](i). The encrypted domain key management information EncUR[u](i) corresponds to the hash list Hash List(i).

Here, when the encrypted domain key management information EncUR[u](i) is updated (e.g., when new content key information is put in correspondence with the existing encrypted domain key EncKu(i), or when content key information put in correspondence with the encrypted domain key EncKu(i) is deleted), the encrypted domain key management information EncUR[u](i) is temporarily decrypted into domain key management information UR[u](i) before the concatenated hash value Hash(i) is stored. Thereafter, when the concatenated hash value Hash(i) is stored into the domain key management information UR[u](i), the domain key management information UR[u](i) is encrypted and returned to the encrypted domain key management information EncUR[u](i). Thus, the whole-check data DATA11(i) is updated.

Note that, when the domain key Ku(i) is newly produced, the domain key management information UR[u](i) is also newly produced. Therefore, the temporary decryption process is not required. In this case, after the concatenated hash value Hash(i) is stored into the newly produced domain key management information UR[u](i), the domain key management information UR[u](i) is encrypted. Thus, the new encrypted domain key management information EncUR[u](i) is generated.

<Flow of Whole Process>

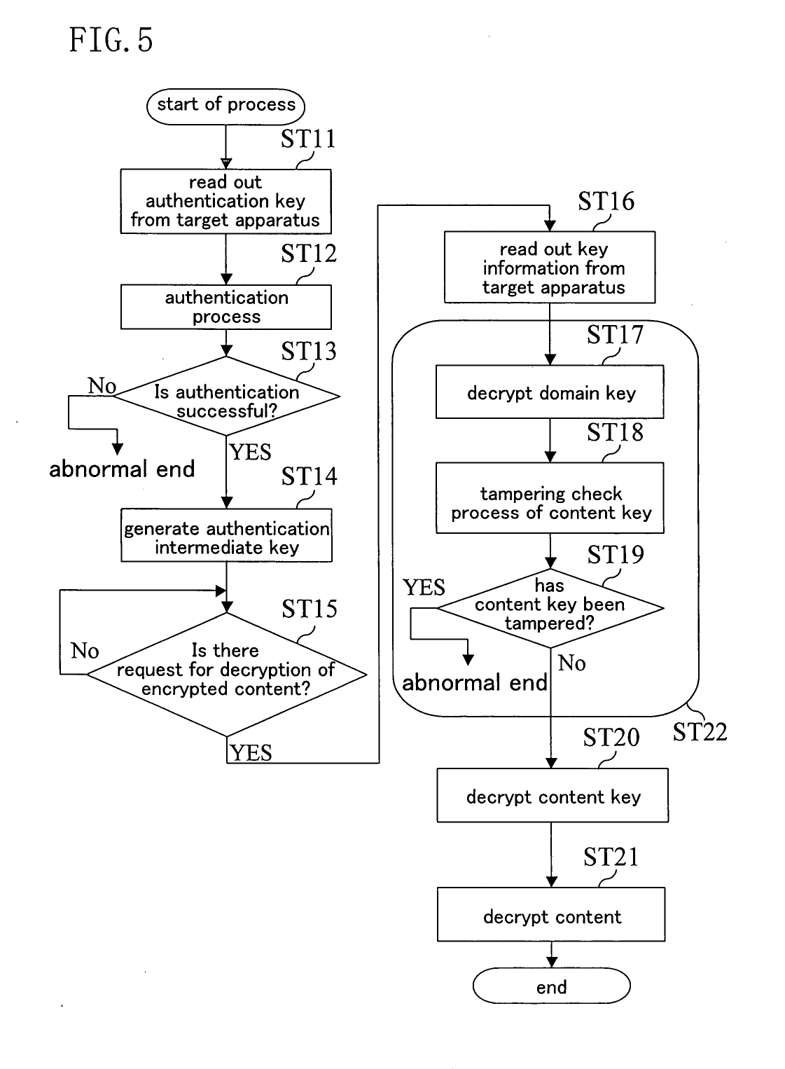

Next, a process of the host apparatus 11 decrypting an encrypted content stored in the target apparatus 10 will be described with reference to FIG. 5.

[Step ST11]

Initially, when the target apparatus 10 is connected to the host apparatus 11, the target apparatus authentication key is read out from the system area 101 of the target apparatus 10.

[Step ST12]

Next, the host apparatus 11 executes an authentication process using the target apparatus authentication key read out from the target apparatus 10 and the host apparatus authentication key possessed by itself.

[Step ST13]

As a result of the authentication process, when authentication is not successful, the host apparatus 11 determines that access is not authorized, and executes abnormal end. On the other hand, when authentication is successful in the host apparatus 11, the process goes to step ST14.

[Step ST14]

Next, the host apparatus 11 generates an authentication intermediate key based on the target apparatus authentication key read out from the target apparatus 10 and the host apparatus authentication key possessed by itself. The generated authentication intermediate key is stored into the authentication intermediate key storage area of the confidential information processing section 113. Thereby, preparation of subsequent communication between the target apparatus 10 and the host apparatus 11 is completed.

[Step ST15]

Next, the host apparatus 11 determines whether or not decryption of an encrypted content stored in the target apparatus 10 is requested by the user. When it is determined that there is the request, the process goes to step ST16.

[Step ST16]

Next, the host apparatus 11 reads out, from the target apparatus 10, confidential information (an encrypted content key, an encrypted domain key, and information associated with these keys) required for decryption of the encrypted content. As a specific process, the host apparatus 11 initially extracts a content ID from the information associated with the encrypted content, and based on the content ID, specifies a content key required for decryption of the encrypted content. A correspondence relationship between content IDs and content keys has been prepared as a table. Next, the host apparatus 11 references the key correspondence table stored in the ordinary area 103 of the target apparatus 10 based on the specified content key so as to specify a required domain key. If a content key and a domain key are specified, required key information is read out.

[Step ST17]

Next, the host apparatus 11 uses the authentication intermediate key generated in step ST14 to decrypt the encrypted domain key read out in step ST16. Thereby, the domain key in plain text is generated.

[Step ST18]

Next, the host apparatus 11 executes tampering check with respect to the encrypted content key read out in step ST16.

[Step ST19]

When tampering is detected in the encrypted content key, the host apparatus 11 determines that access is not authorized, and executes abnormal end. On the other hand, when tampering is not detected in the encrypted content key, the process goes to step ST20.

[Step ST20]

Next, the host apparatus 11 uses the domain key generated in step ST17 to decrypt the encrypted content key. Thereby, the host apparatus 11 obtains the content key in plain text.

[Step ST21]

Next, the host apparatus 11 uses the content key in plain text obtained in step ST20 to decrypt the encrypted content. Thereby, the content can be used.

<Authentication Process>

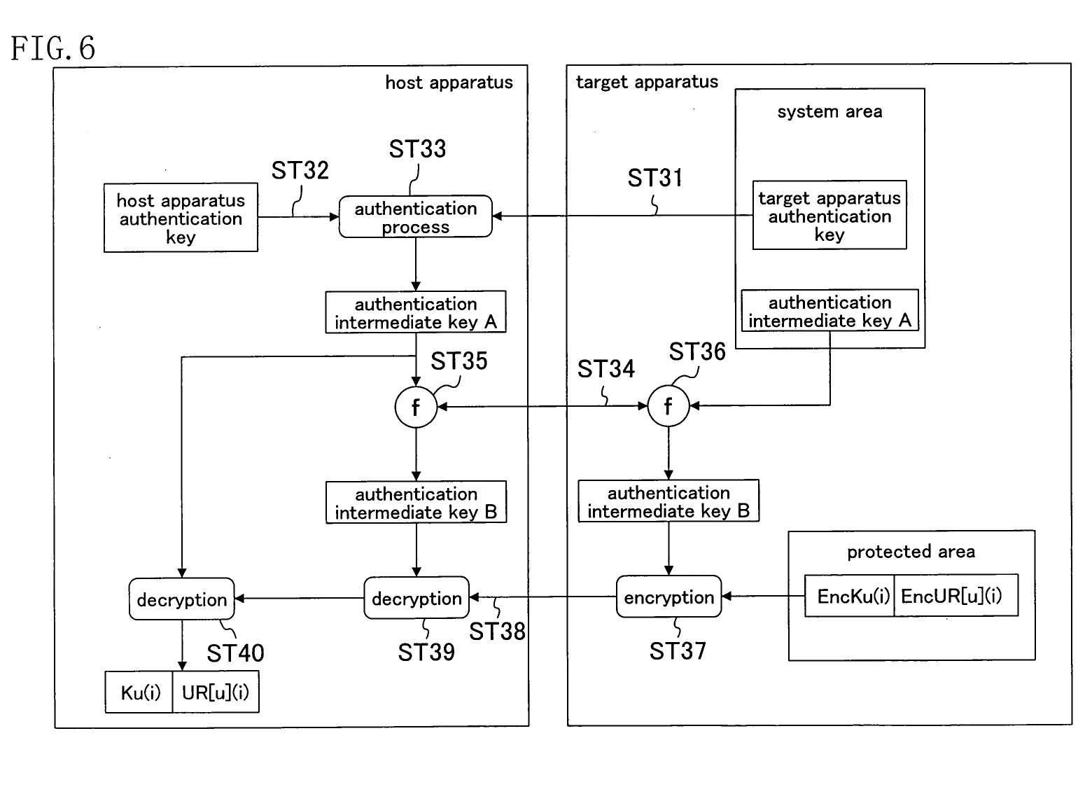

Here, an authentication process executed between the target apparatus 10 and the host apparatus 11 will be described with reference to FIG. 6.

[Step ST31]

Initially, the host apparatus 11 reads out the target apparatus authentication key stored in the system area 101 of the target apparatus 10.

[Step ST32]

Next, the host apparatus 11 reads out the host apparatus authentication key stored in the ROM 116.

[Step ST33]

Next, the host apparatus 11 generates the authentication intermediate key A based on the target apparatus authentication key and the host apparatus authentication key. Specifically, the host apparatus 11 exectes predetermined operations using the target apparatus authentication key and the host apparatus authentication key to generate the authentication intermediate key A.

[Step ST34]

Next, the host apparatus 11 and the target apparatus 10 generate predetermined functions (e.g., random numbers) separately and exchange the generated predetermined functions therebetween.

[Step ST35]

Next, the host apparatus 11 exectes predetermined operations using the authentication intermediate key A generated in step ST33 and the predetermined functions generated in the host apparatus 11 and the target apparatus 10 in step ST34 to generate an authentication intermediate key B.

[Step ST36]

On the other hand, the target apparatus 10 (specifically, a processing section (not shown) in the target apparatus 10) reads out the authentication intermediate key A stored in the system area 101, and exectes predetermined operations using the read authentication intermediate key A and the predetermined functions generated in the target apparatus 10 and the host apparatus 11 in step ST34 to generate an authentication intermediate key B.

[Step ST37]

Next, the target apparatus 10 reads out the encrypted domain key information stored in the protected area 102 (here, the encrypted domain key EncKu(i) and the encrypted domain key management information EncUR[u](i)), and encrypts the read encrypted domain key information using the authentication intermediate key B generated in step ST36.

[Step ST38]

Next, the target apparatus 10 transmits the encrypted domain key information to the host apparatus 11.

[Step ST39]

Next, the host apparatus 11 decrypts the domain key information transmitted from the target apparatus 10 using the authentication intermediate key B generated in step ST34.

[Step ST40]

Next, the host apparatus 11 further decrypts the domain key information decrypted in step ST39 using the authentication intermediate key A generated in step ST33. Thereby, the domain key information in plain text (here, the domain key Ku(i) and the domain key management information UR[u](i)) are generated.

Thus, when domain key information is communicated between the target apparatus 10 and the host apparatus 11, the domain key information is doubly encrypted using the authentication intermediate key A and the authentication intermediate key B.

<Detection of Tampering in Content Key>

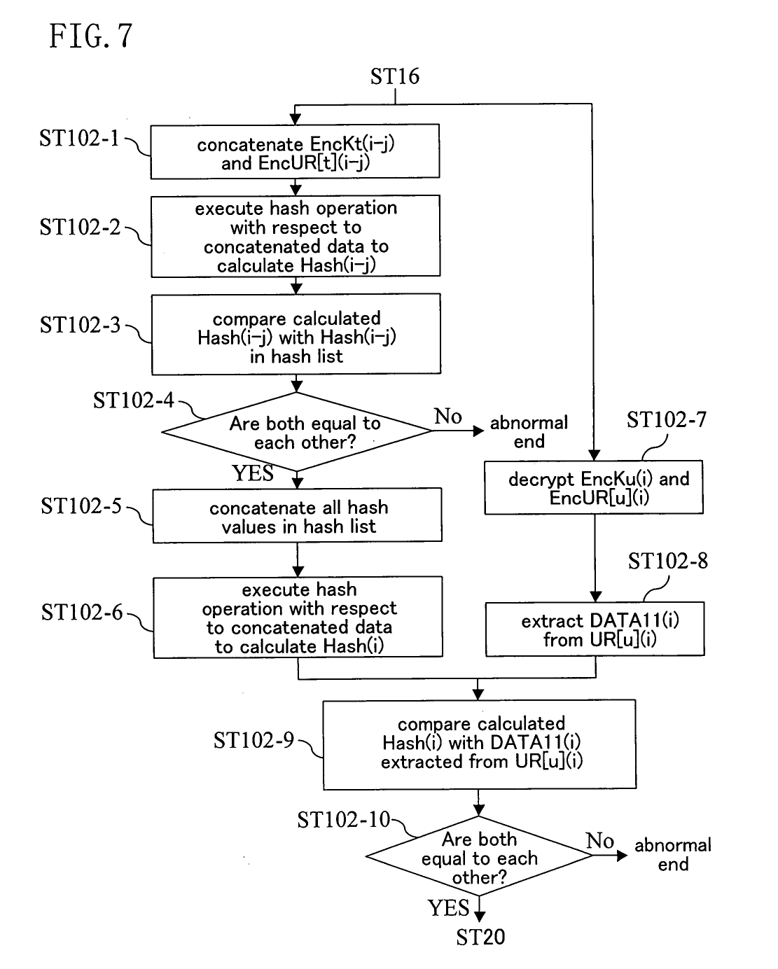

A process (a process in step ST22) of the host apparatus 11 detecting tampering in confidential information stored in the target apparatus 10 will be described with reference to FIG. 7. Here, the host apparatus 11 subjects, to detection of tampering, a j-th (j is an integer and 1≦j≦m) content key Kt(i−j) of the content keys Kt(i−1) to Kt(i−m) corresponding to the domain key Ku(i).

[Step ST102-1]

Initially, the host apparatus 11 concatenates an encrypted content key EncKt(i−j) with encrypted content key management information EncUR[t](i−j) associated therewith. Thereby, a piece of concatenated data is generated.

[Step ST102-2]

Next, the host apparatus 11 executes a hash operation with respect to the concatenated data generated in step ST102-1 to calculate a hash value Hash(i−j).

[Step ST102-3]

Next, the host apparatus 11 compares the hash value Hash(i−j) calculated in step ST102-2 with a hash value Hash(i−j) on the hash list Hash List(i) stored in the ordinary area 103 of the target apparatus 10.

[Step ST102-4]

As a result of the comparison in step ST102-3, if it is determined that the hash value Hash(i−j) calculated in step ST102-2 and the hash value Hash(i−j) on the hash list Hash List(i) are not equal to each other, the host apparatus 11 determines that the encrypted content key EncKt(i−j) or the encrypted content key management information EncUR[t](i−j) has been tampered, and executes abnormal end. On the other hand, when it is determined that both the values are equal to each other, the process goes to step ST102-5.

[Step ST102-5]

Next, the host apparatus 11 obtains (m−1) hash values Hash(i−1) to Hash(i−(j−1)) and Hash(i−(j+1)) to Hash(i−m), excluding the hash value Hash(i−j) corresponding to the content key Kt(i−j), from the hash list Hash List(i) stored in the target apparatus 10. In other words, the host apparatus 11 does not execute a hash operation with respect to (m−1) encrypted content keys other than the encrypted content key EncKt(i−j) of the encrypted content keys EncKt(i−1) to EncKt(i−m) corresponding to the encrypted domain key EncKu(i). Next, the host apparatus 11 places the hash value Hash(i−j) calculated in step ST102-2 between the hash value Hash(i−(j−1)) immediately before the hash value Hash(i−j) and the hash value Hash(i−(j+1)) immediately after the hash value Hash(i−j). Thereafter, the host apparatus 11 concatenates the hash values Hash(i−1) to Hash(i−(j−1)), Hash(i−j), and Hash(i−(j+1)) to Hash(i−m) together. Thereby, hash concatenated data is generated. Specifically, in this hash concatenated data, the hash value Hash(i−j) of the m hash values Hash(i−1) to Hash(i−m) present on the hash list Hash List(i) is replaced with the hash value Hash(i−j) calculated in step ST102-2.

Note that the replacement of the hash value Hash(i−j) is not necessarily required. Since the authenticity has already been verified by comparison with a hash value on the hash list Hash List(i), the hash list Hash List(i) as it is may be concatenated to generate hash concatenated data.

[Step ST102-6]

Next, the host apparatus 11 further performs a hash operation with respect to the hash concatenated data generated in step ST102-5 to calculate a concatenated hash value Hash(i). Next, the process goes to step ST102-9.

[Step ST102-7]

On the other hand, the host apparatus 11 references the key correspondence table Address List to detect the encrypted domain key EncKu(i) required for decryption of the encrypted content key EncKt(i−j). Thereafter, the host apparatus 11 decrypts the encrypted domain key EncKu(i) thus detected and the encrypted domain key management information EncUR[u](i) using the authentication intermediate key A. Thereby, the domain key Ku(i) and the domain key management information UR[u](i) are generated.

[Step ST102-8]

Next, the host apparatus 11 extracts the whole-check data DATA11(i) stored at a predetermined bit position from the domain key management information UR[u](i). Next, the process goes to step ST102-9.

[Step ST102-9]

Next, the host apparatus 11 compares the concatenated hash value Hash(i) calculated in step ST102-6 with the whole-check data DATA11(i) extracted in step ST102-8.

[Step ST102-10]

As a result of the comparison in step ST102-9, when it is determined that the concatenated hash value Hash(i) calculated in step ST102-6 and the whole-check data DATA11(i) extracted in step ST102-8 are not equal to each other, the host apparatus 11 determines that the hash list Hash List(i) has been tampered, and executes abnormal end. On the other hand, when it is determined that both the values are equal to each other, the process goes to step ST20.

Thus, the presence or absence of tampering is detected in confidential information stored in the target apparatus.

<Addition and Deletion of Content Key Information>

Also, it is contemplated that, in the future, a content key may be added or deleted by distribution via a network. When content key information is added or deleted, the hash list Hash List(i) and the whole-check data DATA11(i) are updated.

[Addition of Content Key Information]

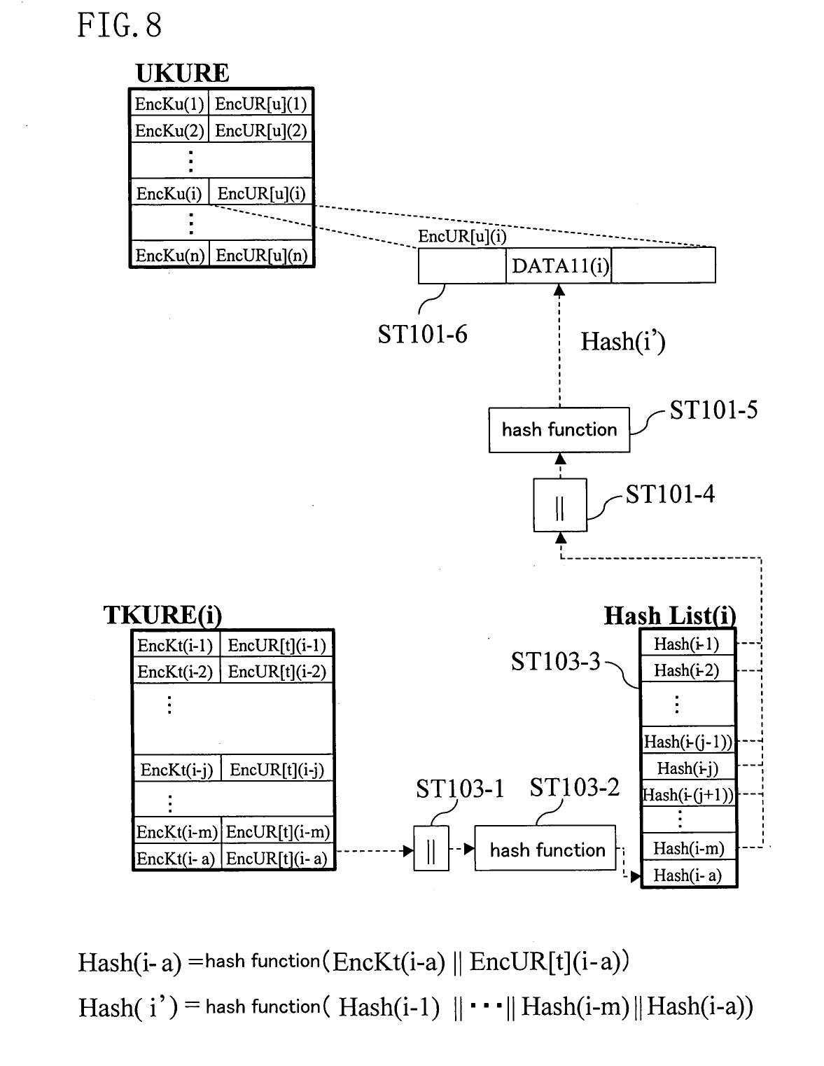

A case where content key information is added will be described with reference to FIG. 8. Note that, here, encrypted content key information including an encrypted content key EncKt(i−a) and encrypted content key management information EncUR[t](i−a) is added. The encrypted content key information is generated by encrypting content key information including a content key Kt(i−a) and content key management information UR[t](i−a) using the domain key Ku(i).

[Step ST103-1]

Initially, the encrypted content key EncKt(i−a) and the encrypted content key management information EncUR[t](i−a) thus added are concatenated together. Thereby, a piece of concatenated data is generated.

[Step ST103-2]

Next, a hash operation is executed with respect to the concatenated data generated in step ST103-1. Thereby, a hash value Hash(i−a) is calculated.

[Step ST103-3]

Next, the hash value Hash(i−a) calculated in step ST103-2 is added to the hash list Hash List(i).

Next, the hash values Hash(i−1) to Hash(i−m) present on the hash list Hash List(i) and the hash value Hash(i−a) calculated in step ST103-2 are concatenated together. Thereby, a piece of hash concatenated data is generated.

[Steps ST101-4 to 101-6]

Next, as in the processes of steps ST101-4 and 101-5, (m+1) hash values Hash(i−1) to Hash(i−m) and Hash(i−a) are concatenated together to generate hash concatenated data. A hash operation is executed with respect to the hash concatenated data to calculate a new concatenated hash value Hash(i′). Next, as in the process of step ST101-6, the new concatenated hash value Hash(i′) thus calculated is stored as new whole-check data DATA11(i) at a predetermined position in the encrypted domain key management information EncUR[u](i).

Thus, the hash list Hash List(i) and the whole-check data DATA11(i) are updated.

[Deletion of Content Key Information]

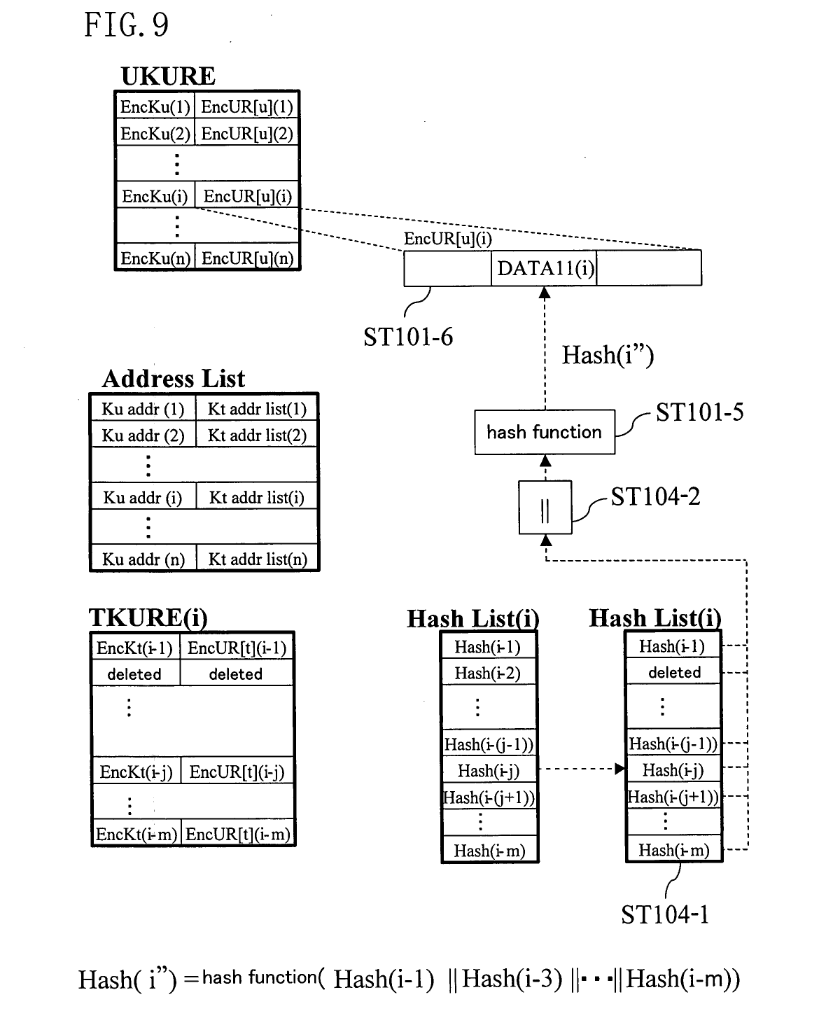

A case where content key information is deleted will be described with reference to FIG. 9. Note that, here, encrypted content key information including an encrypted content key EncKt(i−2) and encrypted content key management information EncUR[t](i−2) is deleted.

[Step ST104-1]

Initially, of the encrypted content keys EncKt(i−1) to EncKt(i−m), a hash value Hash(i−2) corresponding to the encrypted content key EncKt(i−2) is deleted from the hash list Hash List(i).

[Step ST104-2]

Next, (m−1) hash values Hash(i−1) and Hash(i−3) to hash(i−m) present on the hash list Hash List(i) are concatenated together. Thereby, a piece of hash concatenated data is generated.

[Step ST101-5]

Next, as in the process of step ST101-5, a hash operation is executed with respect to the concatenated data generated in step ST104-2 to generate a new concatenated hash value Hash(i″). The new concatenated hash value Hash(i″) thus calculated is stored as new whole-check data DATA11(i) at a predetermined position in the encrypted domain key management information EncUR[u](i).

Thus, the hash list Hash List(i) and the whole-check data DATA11(i) are updated.

<Effect>

As described above, in the process of detecting the presence or absence of tampering in confidential information, a hash operation with respect to a piece of content key information and a hash operation with respect to concatenated data including m hash values present on a hash list are executed. Thus, not the whole content key group TKURE(i) needs to be subjected to a hash operation, thereby making it possible to reduce the processing amount during the tampering detecting process.

Also, in the process of generating confidential information, after a hash value is calculated from each of m pieces of encrypted content key information, a piece of whole-check data is generated from the resultant m hash values. Thus, data (a hash list and whole-check data) used for the tampering detecting process are generated in a plurality of separate stages. Check data (whole-check data) in the final stage is stored in the protected area. Thus, the amount of data to be stored in the protected area can be reduced.

Further, when new content key information is added to confidential information, a new hash value is calculated from the added content key information, and new whole-check data is generated from the calculated hash value and m hash values on the hash list. Also, when content key information is deleted, the hash list is updated, and new whole-check data is generated from the updated hash list. Thus, not the whole content key group TKURE(i) needs to be subjected to a hash operation, thereby making it possible to reduce the processing amount during updating of confidential information.

<Entry>

In some target apparatuses, an area for storing a content key is previously secured in the form of an entry. Each entry is put in correspondence with any one of a plurality of domain keys. In other words, each domain key is put in correspondence with a plurality of entries. An encrypted content key stored in an entry can be decrypted using a domain key which is put in correspondence with the entry. In such a case, a hash list in which hash values corresponding to each entry are grouped is contemplated. Specifically, hash values for all entries which are put in correspondence with the same domain key may be stored as a hash list in the ordinary area 103 no matter whether or not content keys are actually stored. Alternatively, hash values of all entries which are put in correspondence with the same domain key may be concatenated together, a hash operation may be executed with respect to the concatenated data to calculate a hash value, and the calculated hash value may be stored in domain key management information. A smaller calculation amount of the hash operation is preferable to reduction of the processing amount. Therefore, more preferably, a hash operation is executed only with respect to entries for which content keys are actually stored to generate a hash list, a hash operation is executed to a concatenation of the hash values on the hash list, and the calculated hash value is stored into the domain key management information.

<Additional Information>

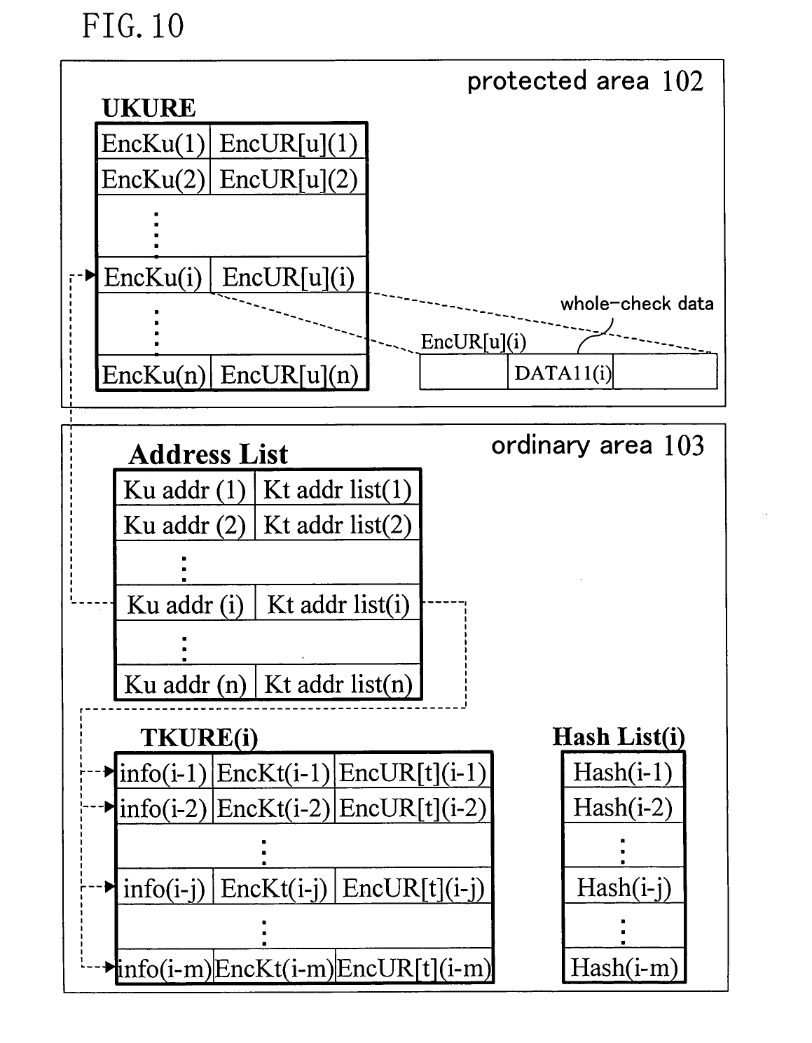

Also, as in FIG. 10, m pieces of additional information info(i−1) to info(i−m) may be put in one-to-one correspondence with the m encrypted content keys EncKt(i−1) to EncKt(i−m). Each of the m pieces of additional information info(i−1) to info(i−m) stores non-encrypted, relatively low confidential information (e.g., a song title).

Also, the additional information may be subjected to a hash operation. For example, a hash value Hash(i−j) may be calculated by executing a hash operation with respect to concatenated data including the additional information info(i−j), the encrypted content key EncKt(i−j), and the encrypted content key management information EncUR[t](i−j).

<Variations>

Various variations of this embodiment are contemplated. Representative variations will be hereinafter described.

(1) Encrypted contents do not necessarily need to be stored in the same target apparatus as that which stores encrypted content keys, and may be stored in a separate recording medium. In this case, a host apparatus obtains an encrypted content stored in the separate recording medium via a network or the like, and decrypts the encrypted content using a content key whose authenticity is guaranteed using the tampering check method of this embodiment.

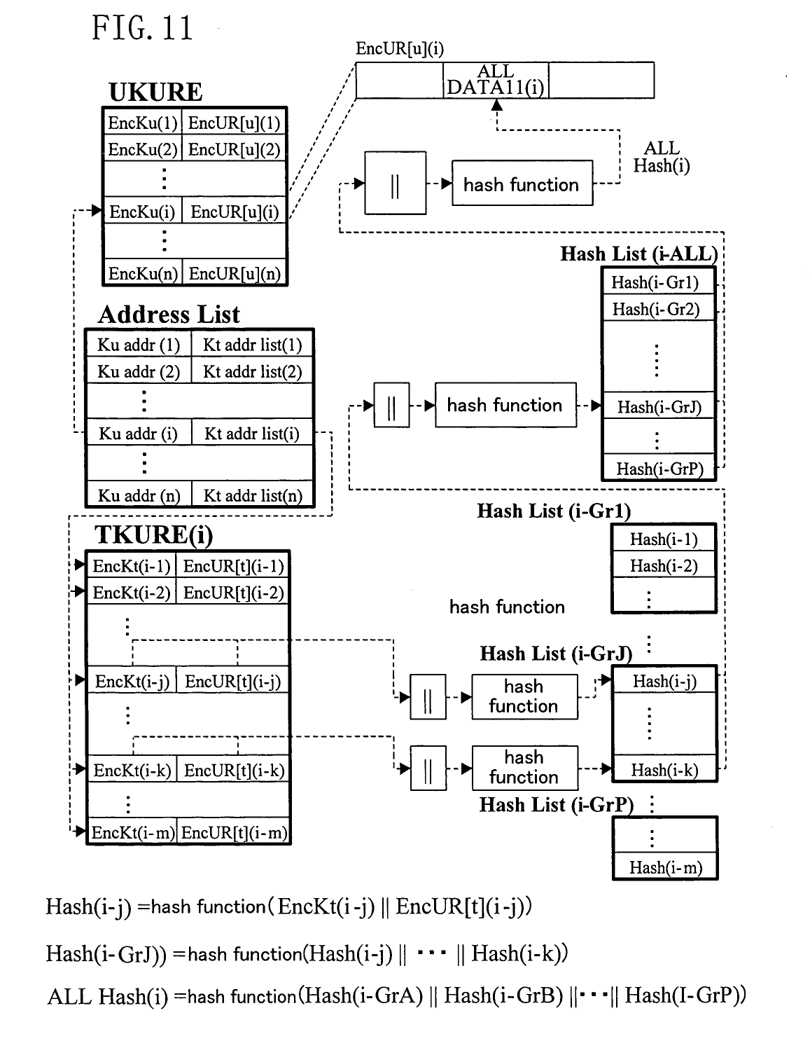

(2) Although one hash list Hash List(i) is provided for a group of content keys which are decrypted using the same domain key (content key group TKURE(i)) in the first embodiment, P (P is an integer of 2 or more) subset hash lists and one universal-set hash list can be provided for one content key group. Here, the subset hash list and the universal-set hash list will be described with reference to FIG. 11, using the content key group TKURE(i) as an example. Here, a plurality of encrypted content keys (m encrypted content keys EncKt(i−1) to EncKt(i−m) included in the content key group TKURE(i)) which can be decrypted using a domain key Ku(i) are divided into P (P is an integer of 2 or more) subsets. P subset hash lists Hash List(i−Gr1) to Hash List(i−GrP) are in one-to-one correspondence with the P subsets. For example, a subset hash list Hash List(i−GrJ) (J is an integer and 1<J<P) corresponds to a subset including a j-th content key Kt(i−j) to a k-th (k is an integer and j<k≦m) content key Kt(i−k). Also, the subset hash list Hash List(i−GrJ) includes (k−j) hash values Hash(i−j) to Hash(i−k). Also, the subset hash lists Hash List(i−Gr1) to Hash List(i−GrP) are put in correspondence with universal-set hash lists Hash List(i−ALL). The universal-set hash lists Hash List(i−ALL) include P sub-hash values Hash(i−Gr1) to Hash(i−GrP) which are in one-to-one correspondence with the P subset hash lists Hash List(i−Gr1) to Hash List(i−GrP). A universal hash value ALL Hash(i) is generated based on the universal-set hash list Hash List(i−ALL). Note that the universal hash value ALL Hash(i) is stored as whole-check data ALL DATA11(i) into encrypted domain key management information EncUR[u](i). With such a structure, when tampering check is executed with respect to an encrypted content key EncKt(i−j), a hash operation (hash operation 1) with respect to concatenated data including the encrypted content key EncKt(i−j) and encrypted content key management information EncUR[t](i−j), a hash operation (hash operation 2) with respect to the subset hash list Hash List(i−GrJ) corresponding to a subset to which the content key Kt(i−j) belongs, and a hash operation (hash operation 3) with respect to the universal-set hash list Hash List(i−ALL), are executed. The processing amount of the hash operation 2 and the hash operation 3 is smaller than the processing amount of the process of FIG. 4. Therefore, the processing speed can be expected to be further improved.

### Second Embodiment

In a second embodiment of the present invention, a content key and content key management information are encrypted/decrypted using cipher block chaining (chaining encryption/chaining decryption).

<Cipher Block Chaining>

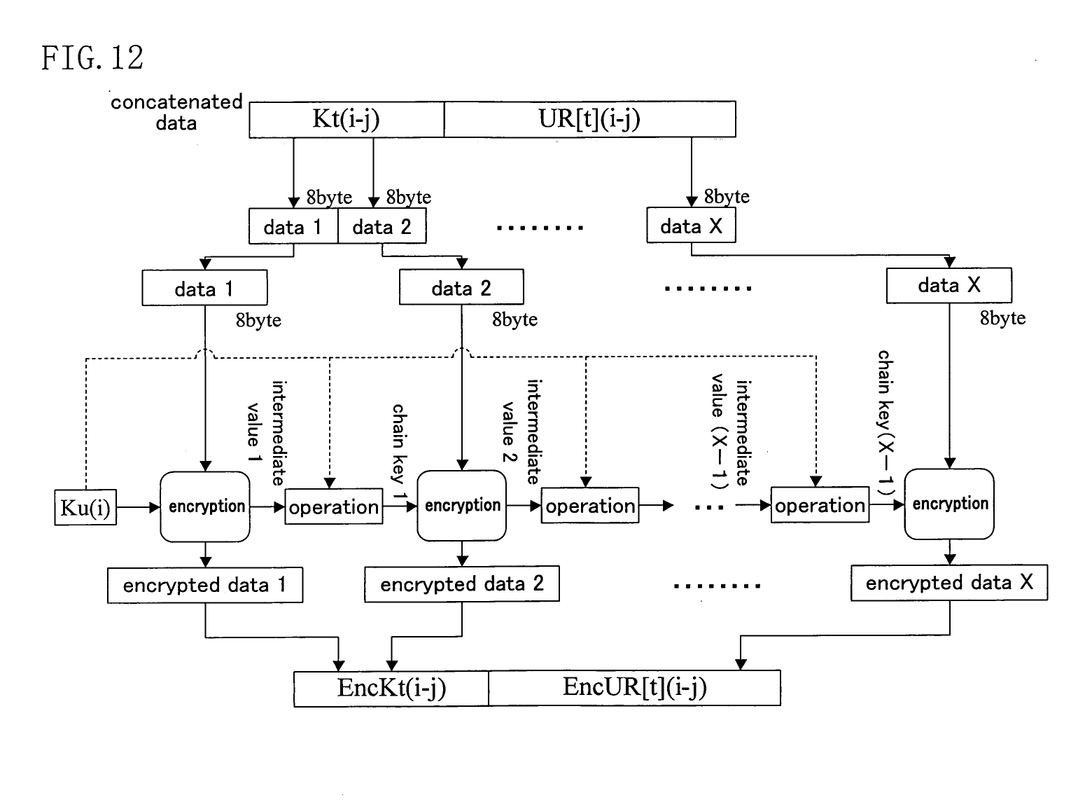

Here, an encryption method employing cipher block chaining will be described with reference to FIG. 12. Note that it is here assumed that the content key Kt(i−j) and the content key management information UR[t](i−j) are to be encrypted.

[Encryption Process]

Initially, the content key Kt(i−j) and the content key management information UR[t](i−j) are concatenated together before being divided 8-byte segments sequentially from the head, which are referred to as “data 1”, “data 2”, . . . , and “data X” (X is an integer of 2 or more). Note that the segment length is not limited to 8 bytes and may be any length.

Next, the first 8 bytes (“data 1”) on the MSB (Most significant bit or Most Significant Byte) side is encrypted using the domain key Ku(i) into “encrypted data 1”. Next, a predetermined operation is executed with respect to an intermediate value 1 obtained during encryption of the “data 1” to generate a chain key 1 (e.g., the chain key 1 is generated by executing predetermined operations using the intermediate value 1 and the domain key Ku(i)). Next, the “data 2” located immediately after the “data 1” is encrypted using the chain key 1 into “encrypted data 2”. Next, a predetermined operation is executed with respect to an intermediate value 2 obtained during encryption of the “data 2” to generate a chain key 2. Thus, the leading 8 bytes (“data 1”) are encrypted using the domain key Ku(i). Also, the second 8-byte data and later are each encrypted using the result of encryption of the immediately previous 8-byte data in sequence.

The above-described encryption process is repeatedly executed until the final 8 bytes (“data X”) as counted from the MSB (i.e, the LSB (Least Significant Bit or Least Significant Byte)), so that the “data 1” to the “data X” are caused to be “encrypted data 1” to “encrypted data X”. The set of the “encrypted data 1” to the “encrypted data X” is the set of the encrypted content key EncKt(i−j) and the encrypted content key management information EncUR[t](i−j).

[Decryption Process]

Next, a decryption method employing cipher block chaining will be described.

Initially, a set of the encrypted content key EncKt(i−j) and the encrypted content key management information EncUR[t](i−j) is divided into 8-byte segments sequentially from the head, which are referred to as “encrypted data 1”, “encrypted data 2”, . . . , and “encrypted data X”. Next, the “encrypted data 1” is decrypted using the domain key Ku(i) into “data 1”. Next, the “encrypted data 2” is decrypted using a result of the decryption of the “encrypted data 1” into “data 2”. Thus, the leading 8-byte “encrypted data 1” is decrypt using the domain key Ku(i). The second encrypted data and later are each decrypted using a result of the decryption of the immediately previous encrypted data in sequence.

In such cipher block chaining, the data segments are encrypted/decrypted in a chained manner (in units of 8-byte data). Specifically, in such cipher block chaining, if decryption fails at any stage, no encrypted data is normally decrypted on the stage and later. Therefore, for example, if the final 8 bytes (LSB) (encrypted data X) is successfully decrypted, it is guaranteed that all data are authentic.

Also, in such cipher block chaining, even assuming that the same data is encrypted, when the previously encrypted data is different, the encryption has a different result.

<Configuration>

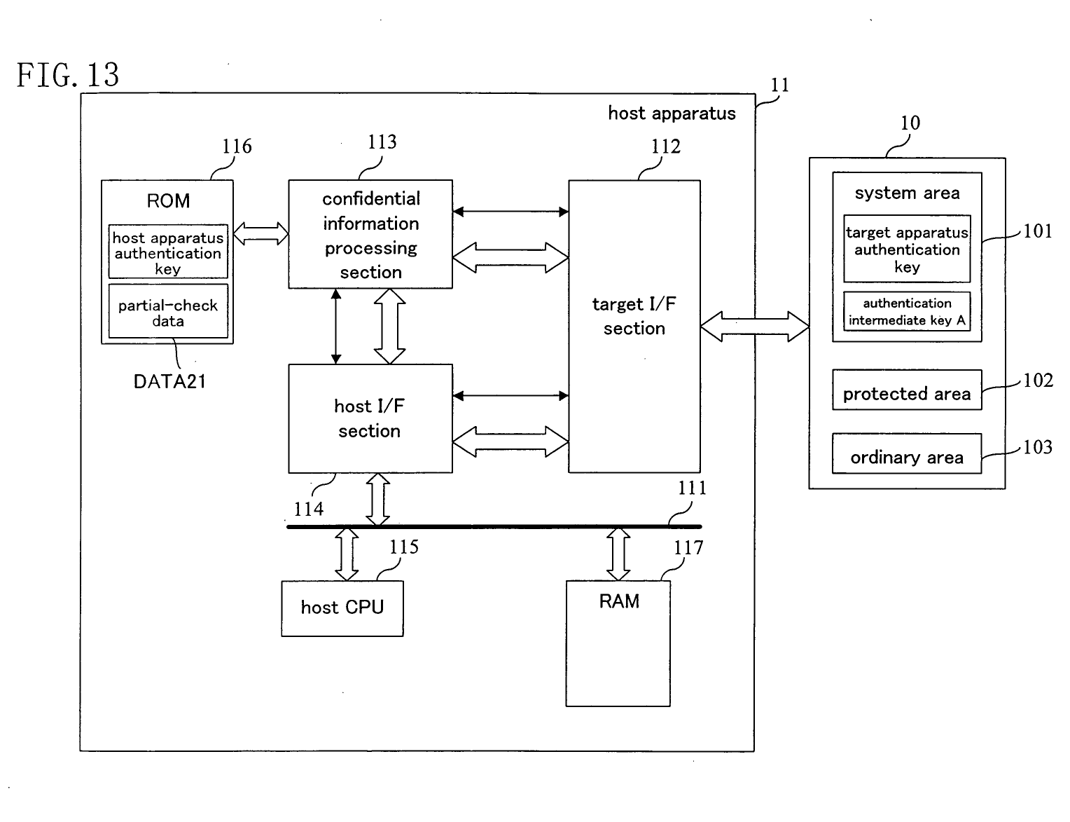

Based on the above descriptions, the confidential information processing system of the second embodiment of the present invention will be described. FIG. 13 shows a whole configuration of the confidential information processing system of the second embodiment of the present invention. Here, a ROM 116 further stores partial-check data DATA21.

<Confidential Information>

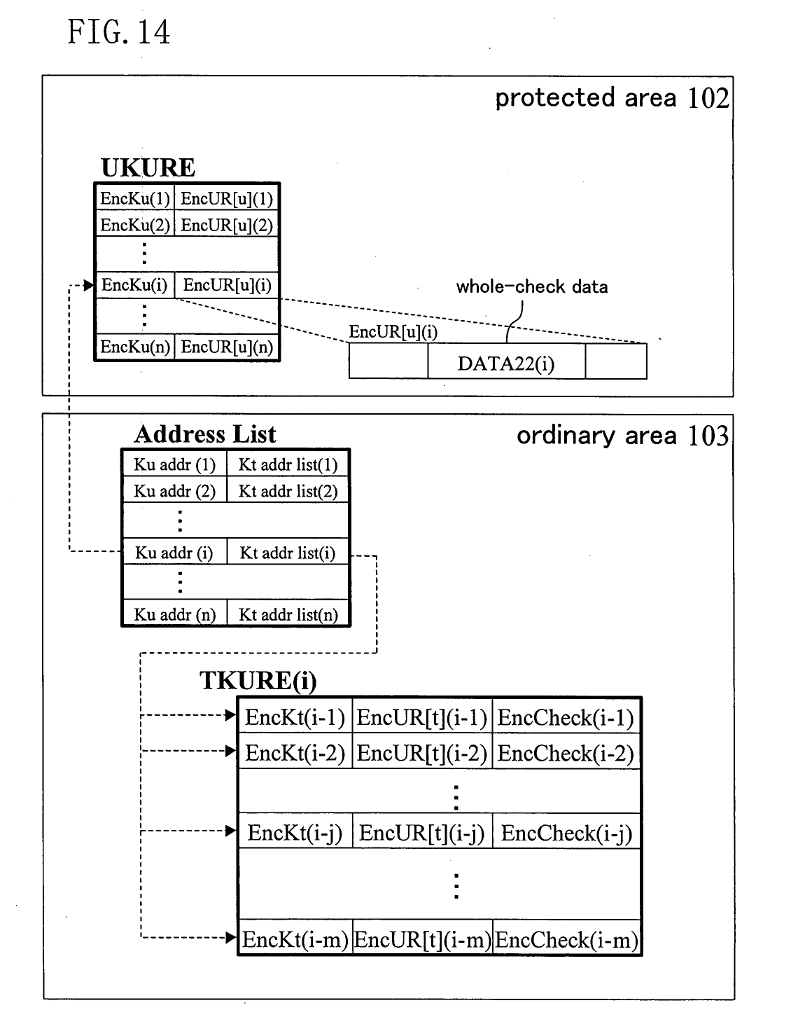

FIG. 14 shows confidential information stored in a target apparatus 10 of FIG. 13. A protected area 102 stores a domain key group UKURE. An ordinary area 103 stores a key correspondence table Address List and content key groups TKURE(i). Note that the ordinary area 103 also stores encrypted contents, which are not shown in FIG. 14.

[Domain Key Group]

The domain key group UKURE includes, as in FIG. 2, n encrypted domain keys EncKu(1) to EncKu(n) and n pieces of encrypted domain key management information EncUR[u](1) to EncUR[u](n). Also, whole-check data is stored at a predetermined position in each of the encrypted domain key management information EncUR[u](1) to EncUR[u](n). The whole-check data is generated based on a content key group corresponding to its encrypted domain key management information. For example, whole-check data DATA22(i) generated based on the content key group TKURE(i) is stored at a predetermined position in the encrypted domain key management information EncUR[u](i).

Although only the content key group TKURE(i) corresponding to the encrypted domain key EncKu(i) is shown in FIG. 14, content key groups may correspond to other encrypted domain keys as well as the encrypted domain key EncKu(i).

[Content Key Group]

The content key group TKURE(i) includes m encrypted check values EncCheck(i−1) to EncCheck(i−m) in addition to the content key group TKURE(i) of FIG. 2. The encrypted check values EncCheck(i−1) to EncCheck(i−m) are in one-to-one correspondence with the encrypted content keys EncKt(i−1) to EncKt(i−m). Each of check values Check(i−1) to Check(i−m) in plain text is partial-check data DATA21 stored in the ROM 116 of the host apparatus 11.

The key correspondence table Address List is similar to that of FIG. 2.

<Encryption of Content Key and Information Associated Therewith>

Next, processes of encrypting a content key, content key management information, and a check value will be described. Here, a content key Kt(i−j), content key management information UR[t](i−j), and a check value Check(i−j) will be described as an example.

Initially, the content key Kt(i−j) and the content key management information UR[t](i−j) are concatenated. Next, the check value Check(i−j) is buried at a predetermined position in the concatenated data including the content key Kt(i−j) and the content key management information UR[t](i−j) in accordance with designated bytes. In this example (see FIG. 14), the check value is buried at the LSB. Next, the concatenated data in which the check value Check(i−j) is buried is encrypted in accordance with cipher block chaining. Next, the encrypted concatenated data is divided into an encrypted content key EncKt(i−j), encrypted content key management information EncUR[t](i−j), and an encrypted check value EncCheck(i−j).

Thus, a content key, content key management information, and a check value are encrypted. Also, the position where a check value is buried may not be a fixed position, and may be designated by designated bytes, thereby making it possible to conceal the position where a check value is buried, resulting in an improvement in security.

<Procedure for Generating Whole-Check Data>

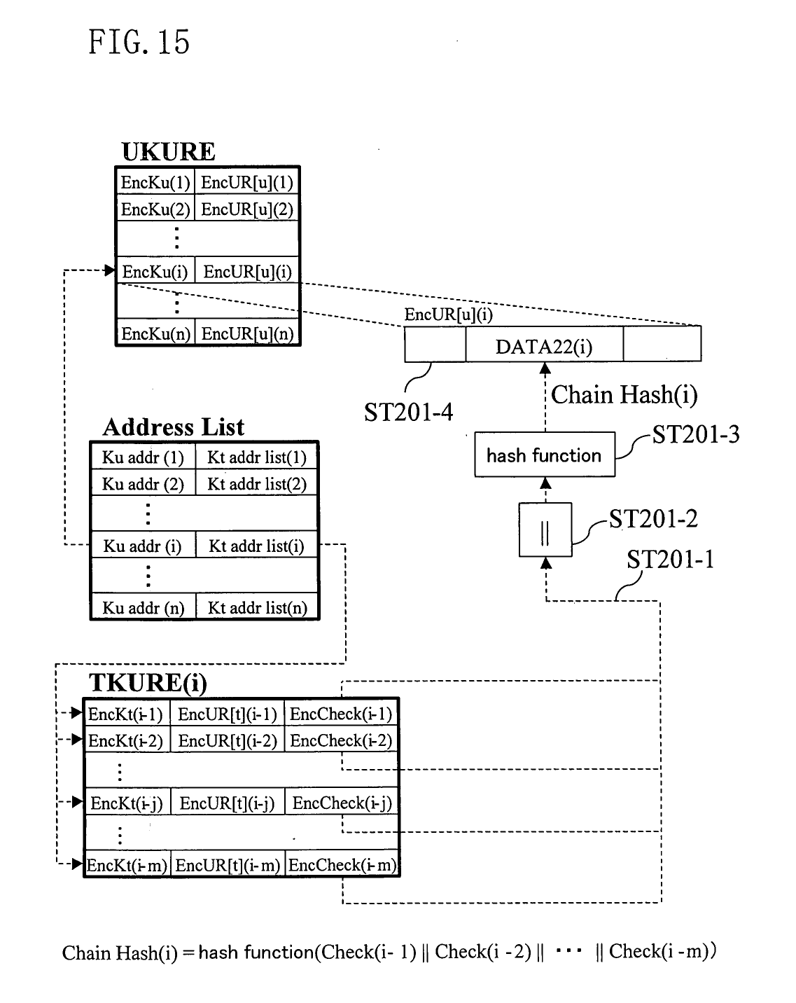

A procedure for generating the whole-check data DATA22(i) of FIG. 14 will be described with reference to FIG. 15. Note that, here, each of the encrypted content key management information EncUR[t](i−1) to EncUR[t](i−m) is assumed to be concatenated after the corresponding encrypted content key, and each of the encrypted check values EncCheck(i−1) to EncCheck(i−m) is assumed to be concatenated after the corresponding encrypted content key management information. Also, the encrypted check values EncCheck(i−1) to EncCheck(i−m) are each 8-byte data.

[Step ST201-1]

Initially, the m encrypted check values EncCheck(i−1) to EncCheck(i−m) are extracted from the content key group TKURE(i) in accordance with designated bytes. For example, from a set of the encrypted content key EncKt(i−j) and information associated therewith (the encrypted content key management information EncUR[t](i−j) and the encrypted check value EncCheck(i−j)), data at a predetermined position (here, 8-byte data present immediately after the encrypted content key management information EncUR[t](i−j)) is extracted. Thereby, the encrypted check value EncCheck(i−j) is extracted. By executing such an extraction process with respect to each of the encrypted content keys EncKt(i−1) to EncKt(i−m), the m encrypted check values EncCheck(i−1) to EncCheck(i−m) are extracted.

[Step ST201-2]

Next, the m encrypted check values EncCheck(i−1) to EncCheck(i−m) thus extracted are concatenated together. Thereby, a piece of check value concatenated data is generated.

[Step ST201-3]

Next, a hash operation is executed with respect to the check value concatenated data generated in step ST201-2. Thereby, a chain hash value Chain Hash(i) is calculated.

[Step ST201-4]

Next, the chain hash value Chain Hash(i) calculated in step ST201-3 is stored as the whole-check data DATA22(i) at a predetermined position in the encrypted domain key management information EncUR[u](i).

Here, when the encrypted domain key management information EncUR[u](i) is updated, the encrypted domain key management information EncUR[u](i) is temporarily decrypted into domain key management information UR[u](i) before the chain hash value Chain Hash(i) is stored. Thereafter, when the chain hash value Chain Hash(i) is stored into the domain key management information UR[u](i), the domain key management information UR[u](i) is encrypted and returned to the encrypted domain key management information EncUR[u](i). Thus, the whole-check data DATA22(i) is updated.

Note that, when the domain key Ku(i) is newly produced, the domain key management information UR[u](i) is also newly produced, and therefore, in this case, the temporary description process is not required. In this case, the chain hash value Chain Hash(i) is stored into the newly produced domain key management information UR[u](i) before the domain key management information UR[u](i) is encrypted. In this manner, new encrypted domain key management information EncUR[u](i) is generated.

Note that the check value is not necessarily of 8 bytes and may be of any number of bytes.

<Detection of Tampering in Content Key Information>

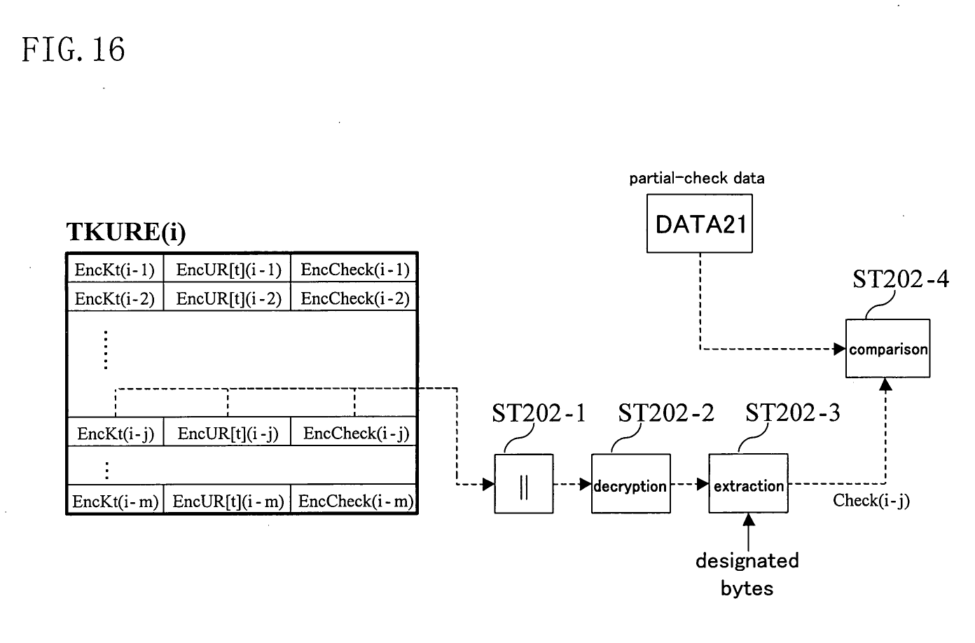

A tampering detecting method which uses the check values Check(i−1) to Check(i−m) of FIG. 14 will be described with reference to FIG. 16. Here, the encrypted content key EncKt(i−j), the encrypted content key management information EncUR[t](i−j), and the encrypted check value EncCheck(i−j) will be described as an example.

[Step ST202-1]

Initially, the encrypted content key EncKt(i−j), the encrypted content key management information EncUR[t](i−j), and the encrypted check value EncCheck(i−j) are concatenated together. Thereby, a piece of concatenated data is generated.

[Step ST202-2]

Next, concatenated data is decrypted by cipher block chaining. Thereby, concatenated data including the content key Kt(i−j), the content key management information UR[t](i−j), and the check value Check(i−j) is generated. In this concatenated data, the check value Check(i−j) is buried at a predetermined position.

[Step ST202-3]

Next, the check value Check(i−j) is extracted from the concatenated data including the content key Kt(i−j), the content key management information UR[t](i−j), and the check value Check(i−j) in accordance with designated bytes (information indicating a predetermined bit position).

[Step ST202-4]

Next, the check value Check(i−j) extracted in step ST202-3 is compared with the partial-check data DATA21 stored in the ROM 116 of the host apparatus 11.

Thus, the authenticity of each of the content keys Kt(i−1) to Kt(i−m) is verified by comparing a check value extracted from decrypted concatenated data with partial-check data stored in the ROM 116.

Note that a check value is preferably added immediately after content key management information. Specifically, in concatenated data including a content key, content key management information, and a check value, the LSB of the concatenated data is preferably the check value. This is because, in cipher block chaining, the authenticity of whole data to be decrypted can be verified by checking the LSB.

<Tampering Detecting Method>

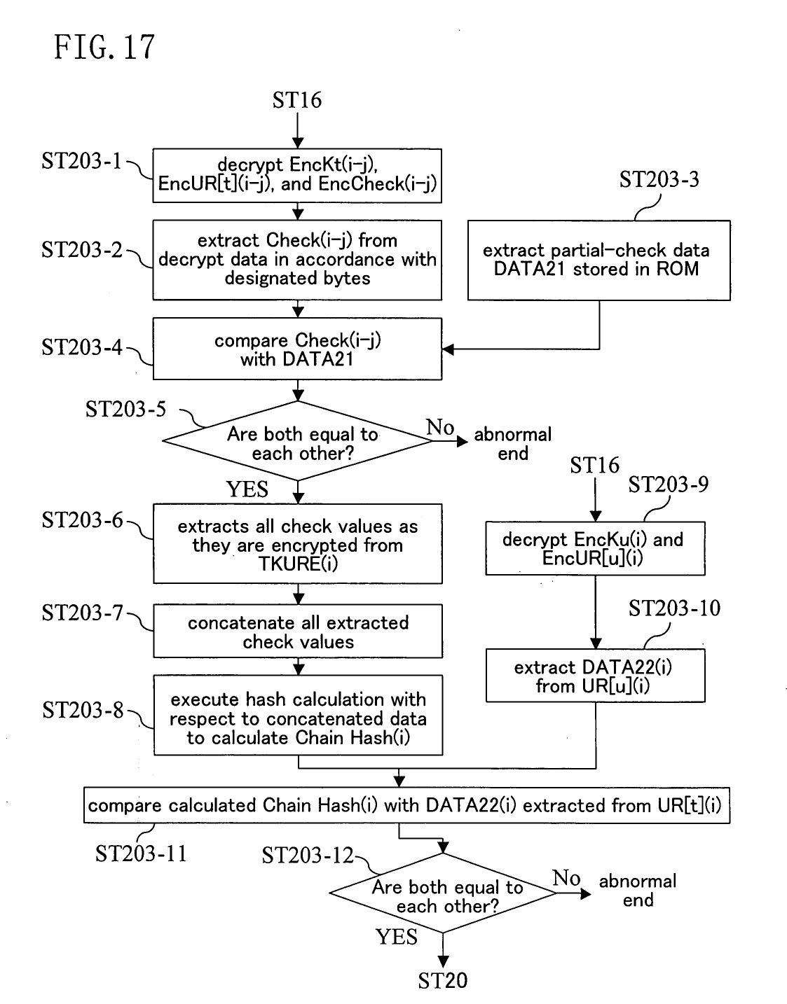

A tampering detecting method (the process of step ST22 of FIG. 5) for the confidential information processing system of FIG. 13 will be described with reference to FIG. 17. Here, the content key Kt(i−j) corresponding to the domain key Ku(i) is assumed to be subjected to tampering detection. Also, the check value Check(i−j) is assumed to be 8-byte data which is added immediately after the content key management information UR[t](i−j).

[Step ST203-1]

Initially, the host apparatus 11 decrypts the encrypted content key EncKt(i−j), the encrypted content key management information EncUR[t](i−j), and the encrypted check value EncCheck(i−j). These are encrypted as a piece of concatenated data by the above-described cipher block chaining, and therefore, the concatenated data is decrypted from the MSB (first 8 bytes) in sequence.

[Step ST203-2]

Next, the host apparatus 11 extracts 8-byte data from the concatenated data in plain text after the decryption (concatenated data including the content key Kt(i−j), the content key management information UR[t](i−j), and the check value Check(i−j)) in accordance with designated bytes. Note that, here, since the check value Check(i−j) is added immediately after the content key management information UR[t](i−j), the designated bytes indicate the LSB (final 8 bytes). Thereby, the check value Check(i−j) is extracted from the concatenated data in plain text. Next, the process goes to step ST203-4.

[Step ST203-3]

On the other hand, the host apparatus 11 extracts the partial-check data DATA21 stored in the ROM 116.

[Step ST203-4]

Next, the host apparatus 11 compares the check value Check(i−j) extracted in step ST203-2 with the partial-check data DATA21 extracted in step ST203-3. Thus, by comparing these values, the authenticity of concatenated data including a content key, content key management information, and a check value can be verified up to a position where the check value is buried.

[Step ST203-5]

As a result of the comparison in step ST203-4, when it is determined that the check value Check(i−j) extracted in step ST203-2 is not equal to the partial-check data DATA21 extracted in step ST203-3, the host apparatus 11 determines that the encrypted content key EncKt(i−j), the encrypted content key management information EncUR[t](i−j), or the encrypted check value EncCheck(i−j) has been tampered, and executes abnormal end. On the other hand, when it is determined that both the values are equal to each other, the process goes to step ST203-6.

[Step ST203-6]

Next, the host apparatus 11 extracts the m encrypted check values EncCheck(i−1) to EncCheck(i−m) from the content key group TKURE(i) in accordance with designated bytes. For example, the host apparatus 11 extracts 8-byte data from concatenated data including the encrypted content key EncKt(i−j), the encrypted content key management information EncUR[t](i−j), and the encrypted check value EncCheck(i−j) in accordance with designated bytes. Thereby, the encrypted check value EncCheck(i−j) is extracted. The host apparatus 11 executes such an extraction process with respect to pieces of concatenated data to extract the m encrypted check values EncCheck(i−1) to EncCheck(i−m).

[Step ST203-7]

Next, the host apparatus 11 concatenates together the encrypted check values EncCheck(i−1) to EncCheck(i−m) extracted in step ST203-6. Thereby, a piece of check value concatenated data is generated.

[Step ST203-8]

Next, the host apparatus 11 execute a hash operation with respect to the check value concatenated data generated in step ST203-7. Thereby, the chain hash value Chain Hash(i) is calculated. Next, the process goes to step ST203-11.

[Step ST203-9]

On the other hand, the host apparatus 11 detects the encrypted domain key EncKu(i) required for decryption of the encrypted content key EncKt(i−j) by referencing the key correspondence table Address List. Thereafter, the host apparatus 11 decrypts the encrypted domain key EncKu(i) thus detected and the encrypted domain key management information EncUR[u](i) using the authentication intermediate key A. Thereby, the host apparatus 11 obtains the domain key Ku(i) and the domain key management information UR[u](i). Note that the decrypt domain key is used for decryption of a content key in step ST203-1.

[Step ST203-10]

Next, the host apparatus 11 extracts the whole-check data DATA22(i) stored at a predetermined bit position from the domain key management information UR[u](i).

[Step ST203-11]

Next, the host apparatus 11 compares the chain hash value Chain Hash(i) calculated in step ST203-8 with the whole-check data DATA22(i) extracted in step ST203-10.

[Step ST203-12]

As a result of the comparison in step ST203-11, when it is determined that the chain hash value Chain Hash(i) calculated in step ST203-8 is not equal to the whole-check data DATA22(i) extracted in step ST203-10, the host apparatus 11 determines that the encrypted check values EncCheck(i−1) to EncCheck(i−m) have been tampered, and executes abnormal end. On the other hand, when both these values are equal to each other, the process goes to step ST20.

The host apparatus 11 uses the thus-obtained content key Kt(i−j) in plain text to decrypt an encrypted content.

<Addition and Deletion of Content Key Information>

Also, it is contemplated that, in the future, a content key may be added or deleted by distribution via a network. When content key information is added or deleted, the whole-check data DATA22(i) is updated.

[Addition of Content Key Information]

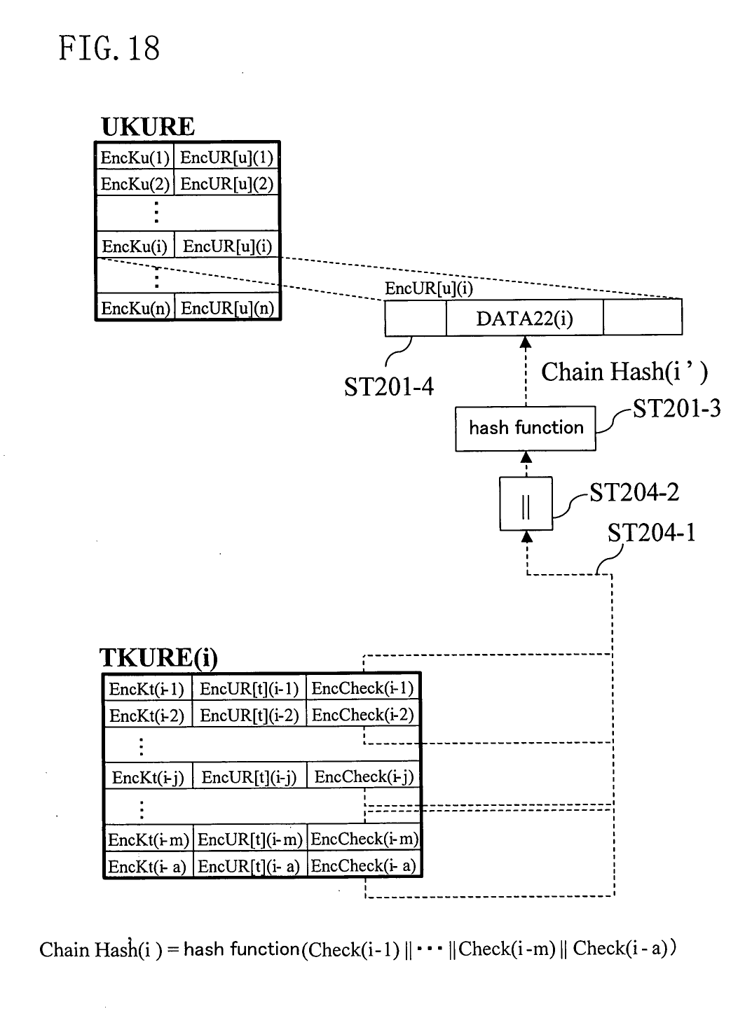

A case where a content key is added will be described with reference to FIG. 18. Note that, here, encrypted content key information including an encrypted content key EncKt(i−a) and encrypted content key management information EncUR[t](i−a) is added. The encrypted content key information is generated by adding a check value Check (i−a) to content key information including a content key Kt(i−a) and content key management information UR[t](i−a) and subjecting the resultant content key information to cipher block chaining using the domain key Ku(i). Also, when content key information is added or deleted, a tampering detecting process may be initially executed with respect to existing content key information using the above-described method (see FIG. 17), which will not be here described.

[Step ST204-1]

Initially, the encrypted check values EncCheck(i−1) to EncCheck(i−m) associated with the encrypted content keys EncKt(i−1) to EncKt(i−m), and a check value EncCheck(i−a) associated with the added encrypted content key EncKt(i−a), are extracted.

[Step ST204-2]

Next, the (m+1) encrypted check values EncCheck(i−1) to EncCheck(i−m) and EncCheck(i−a) thus extracted are concatenated together. Thereby, a piece of check value concatenated data is generated.

[Step ST201-3]

Next, as in step ST201-3, a hash operation is executed with respect to the check value concatenated data generated in step ST204-2 to calculate a new chain hash value Chain Hash(i′). The calculated new chain hash value Chain Hash(i′) is stored as new whole-check data DATA22(i) at a predetermined position in the encrypted domain key management information EncUR[u](i).

Thus, the whole-check data DATA22(i) is updated.

[Deletion of Content Key Information]

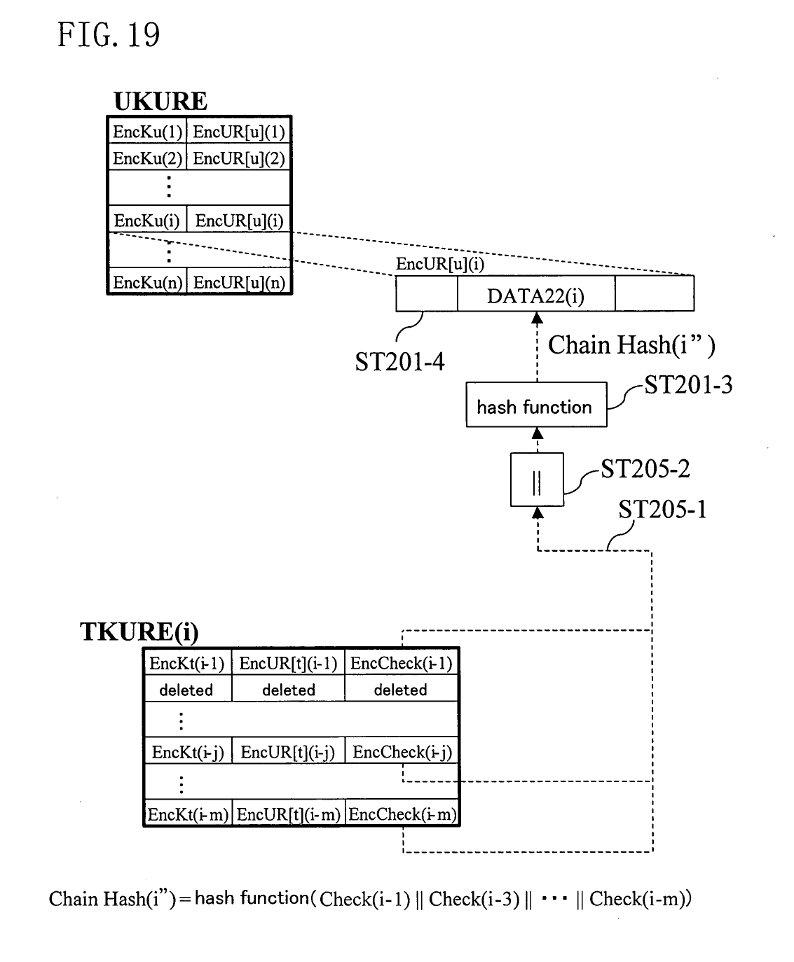

A case where content key information is deleted will be described with reference to FIG. 19. Note that, here, encrypted content key information including an encrypted content key EncKt(i−2), encrypted content key management information EncUR[t](i−2), and an encrypted check value EncCheck(i−2) is deleted.

[Step ST205-1]

Initially, the encrypted check values EncCheck(i−1) and EncCheck(i−3) to EncCheck(i−m) associated with the (m−1) encrypted content keys EncKt(i−1) and EncKt(i−3) to EncKt(i−m), excluding the encrypted content key EncKt(i−2), are extracted.

[Step ST205-2]

Next, the (m−1) encrypted check values EncCheck(i−1) and EncCheck(i−3) to EncCheck(i−m) thus extracted are concatenated together. Thereby, check value concatenated data is generated.

[Step ST201-3]

Next, as in the process of step ST201-3, a hash operation is executed with respect to the check value concatenated data generated in step ST205-2 to calculate new chain hash value Chain Hash(i″). The new chain hash value Chain Hash(i″) thus calculated is stored as new whole-check data DATA22(i) at a predetermined position in the encrypted domain key management information EncUR[u](i).

Thus, the whole-check data DATA22(i) is updated.

<Encryption Algorithm>

Here, a hash operation and an encryption algorithm using cipher block chaining will be described.

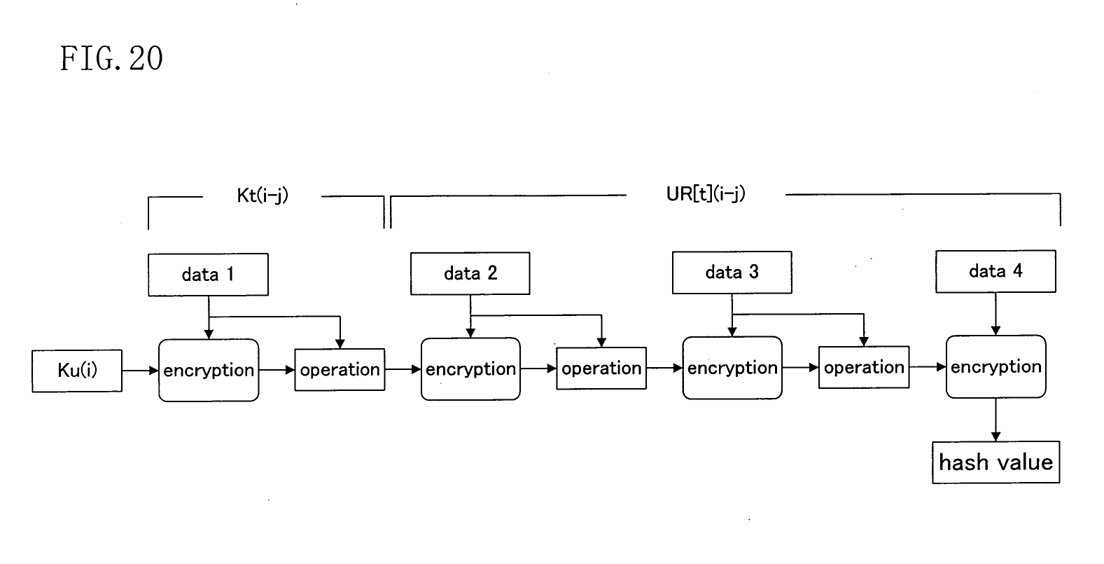

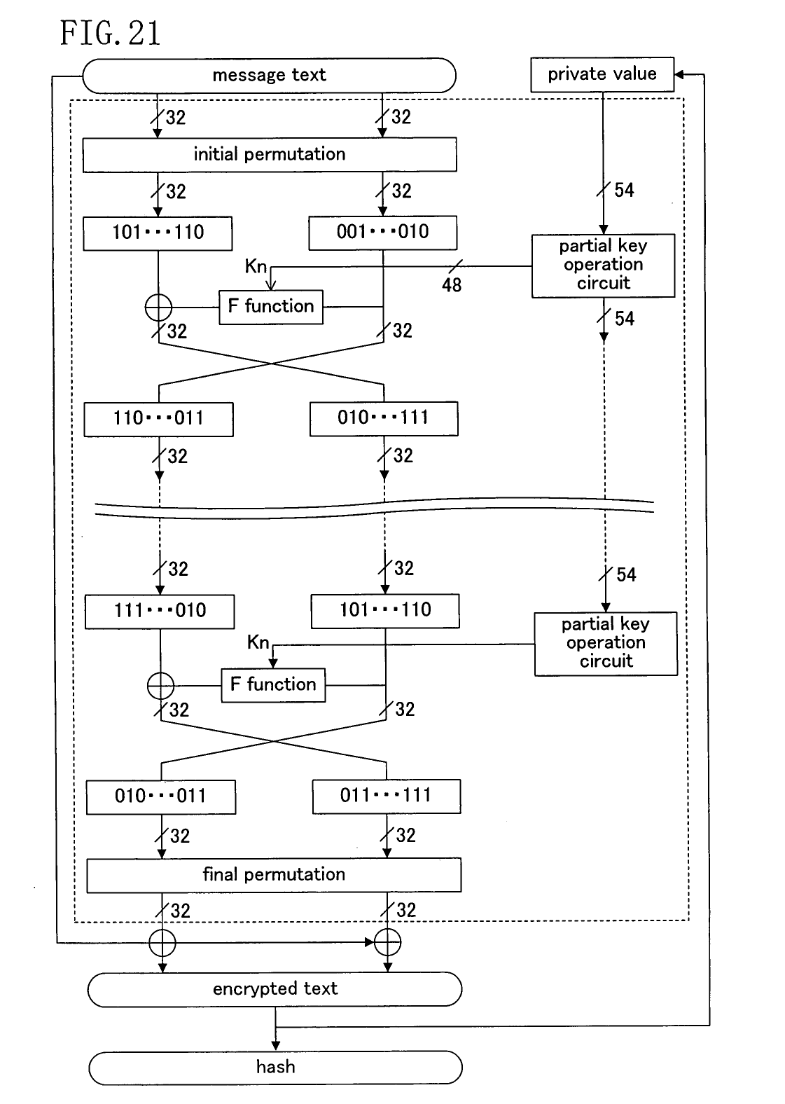

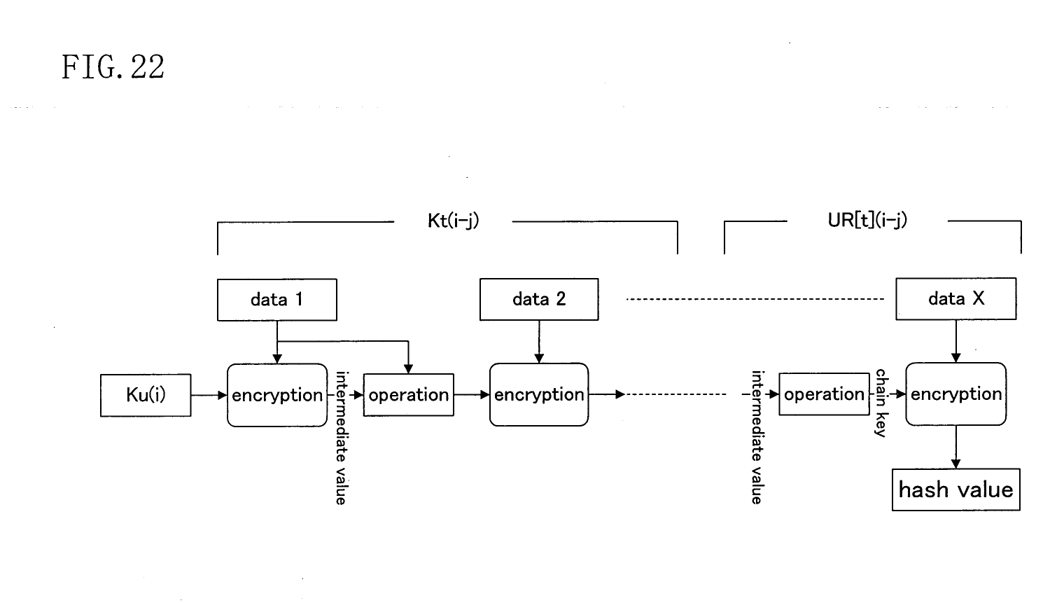

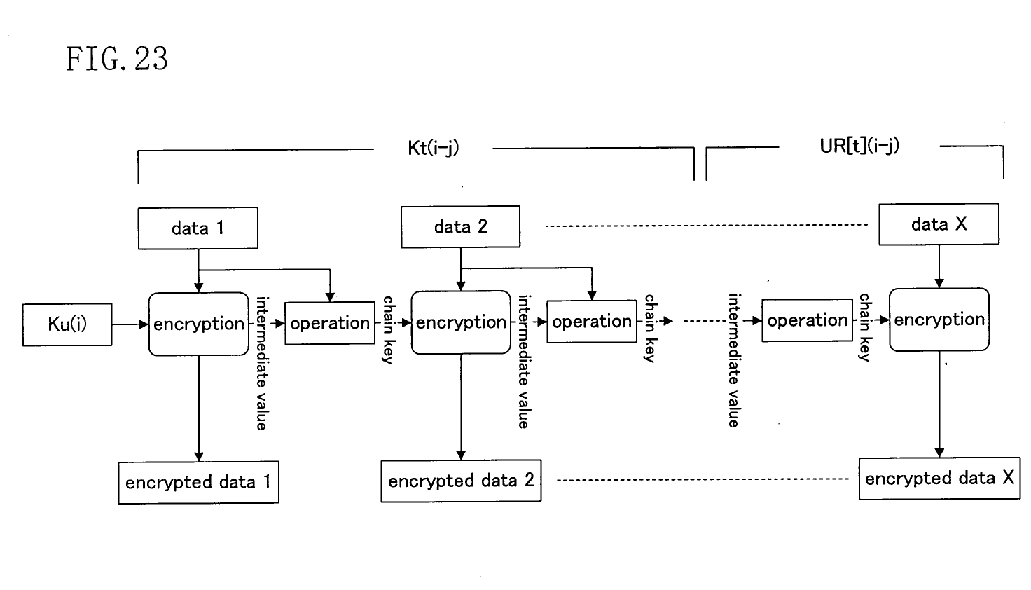

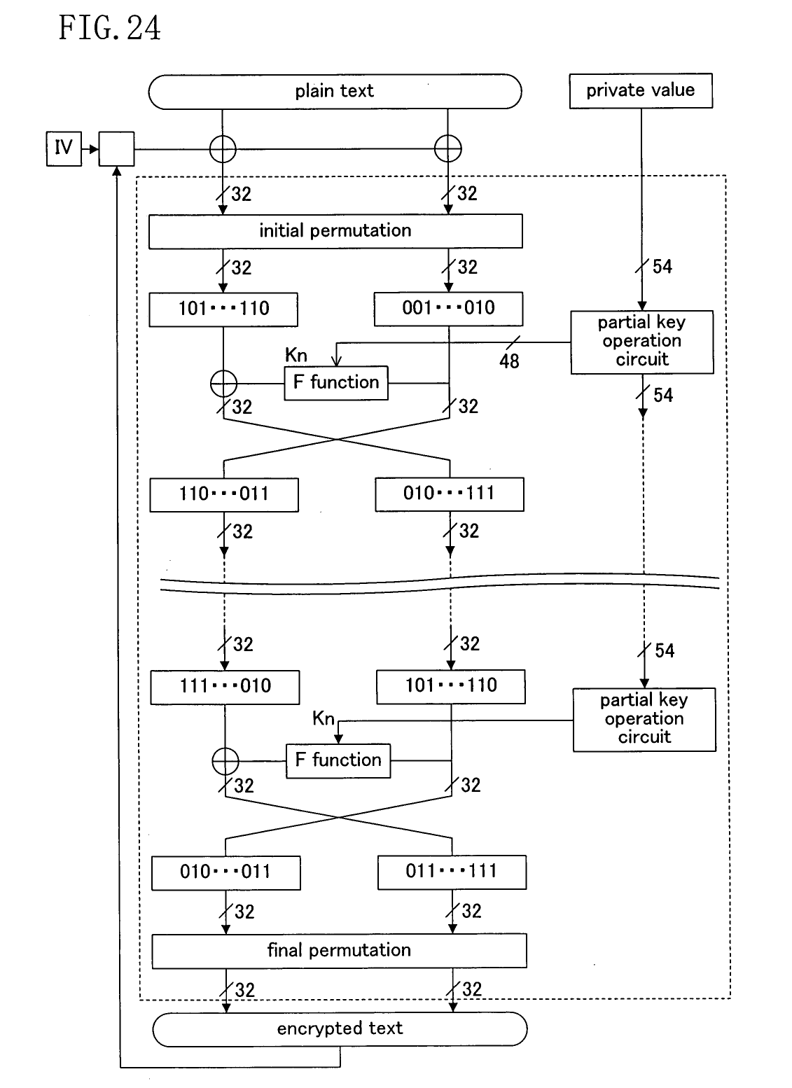

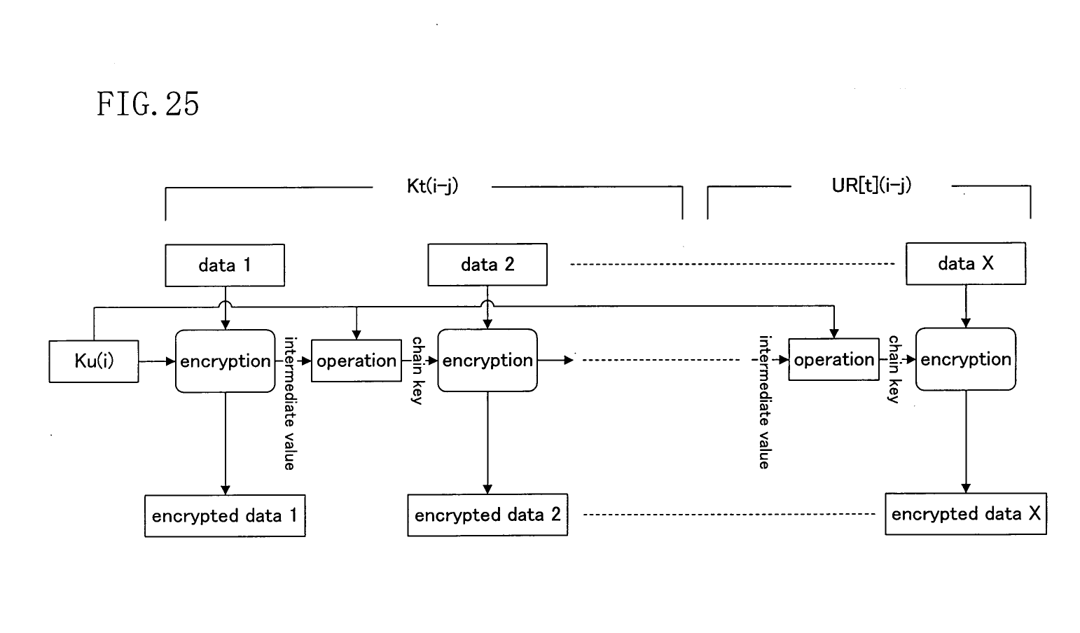

FIG. 20 is a conceptual diagram showing an encryption algorithm for a one-way function type hash operation (DES HASH). FIG. 21 is a flowchart showing the encryption algorithm for the one-way function type hash operation (DES HASH). FIG. 22 is a conceptual diagram showing an encryption algorithm for a one-way function type hash operation (C2 HASH). FIG. 23 is a conceptual diagram showing an encryption algorithm for a cipher block chaining scheme (DES E-CBC). FIG. 24 is a flowchart of the encryption algorithm for the cipher block chaining scheme (DES E-CBC). FIG. 25 is a conceptual diagram showing the encryption algorithm for a cipher block chaining scheme (C2 E-CBC).

Comparing FIG. 21 with FIG. 24, the one-way function type hash operation and the cipher block chaining share a common portion of the encryption algorithm. Therefore, an operation circuit can be shared, resulting in a reduction in circuit area.

<Effect>

As described above, in the process of detecting the presence or absence of tampering in confidential information, extraction of a check value in a piece of content key information and a hash operation with respect to concatenated data including m encrypted check values, are executed. Thus, not the whole content key group TKURE(i) needs to be subjected to a hash operation, thereby making it possible to reduce the processing amount of the tampering detecting process.

Also, in the process of generating confidential information, a check value is extracted from each of m pieces of encrypted content key information, and a piece of whole-check data is generated from the m encrypted check values. Thus, data (check values and whole-check data) used for the tampering detecting process is generated by a plurality of separate stages. Thereafter, check data (whole-check data) for the final stage is stored in a protected area. Thus, the amount of data to be stored in the protected area can be reduced.

Further, when new content key information is added to confidential information, a check value is extracted from the added content key information, while new whole-check data is generated from encrypted check values extracted from existing content key information and an encrypted check value extracted from the new content key information. Also, when content key information is deleted from confidential information, whole-check data is generated from check values included in content key information other than the deleted content key information. Thus, not the whole content key group TKURE(i) needs to be subjected to a hash operation, thereby making it possible to reduce a processing amount during updating of confidential information.

Further, in this embodiment, a tampering detecting process for each piece of content key information and a tampering detecting process for all check values are performed in different manners. Specifically, in the tampering detecting process for each content key, an extraction process is executed with respect to the content key information by executing a decryption process using cipher block chaining. On the other hand, in the tampering detecting process for all check values, a hash operation is executed for all encrypted check values. Thus, different checking means are used during tampering detection, thereby making it possible to improve the security level.

Note that the partial-check data DATA21 may not be stored in the ROM 116 or a register (not shown). Also, when the constants of the partial-check data DATA21 have some regularity, the constants can be implemented using a combination of operators without a register. In general, it is more advantageous in terms of circuit area when the constants are implemented using a combination of operators than when a register is provided.

Also, a check value may be buried in domain key management information. For example, the check value Check(i) may be buried in the domain key management information UR[u](i). In this case, if a process similar to the tampering detecting process (see FIG. 16) is executed with respect to encrypted domain key information including the encrypted domain key EncKu(i), the encrypted domain key management information EncUR[u](i), and the encrypted check value EncCheck(i), it is possible to detect the presence or absence of tampering in domain key information including the encrypted domain key EncKu(i) and the encrypted domain key management information EncUR[u](i).

<Additional Information>

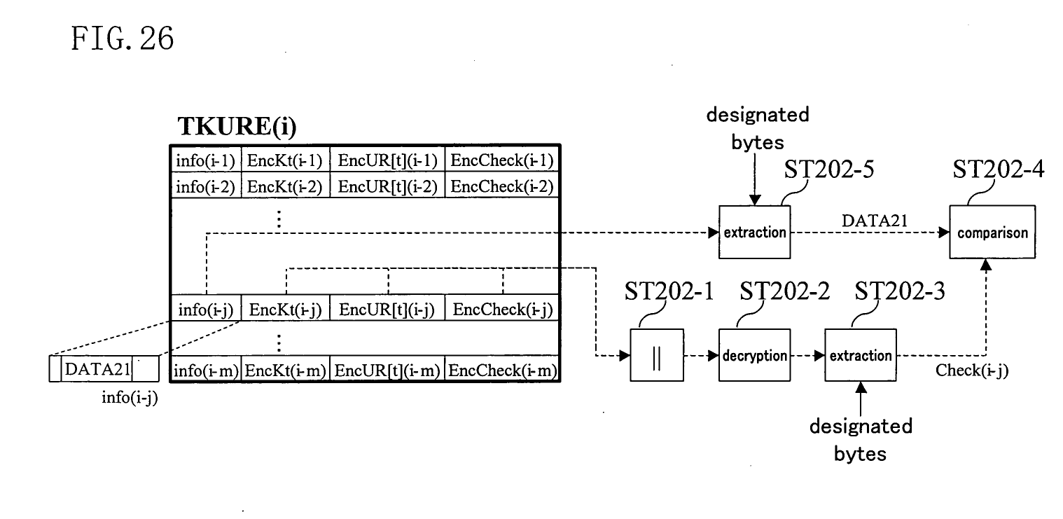

Also, as shown in FIG. 26, the m pieces of additional information info(i−1) to info(i−m) may be in correspondence with the m encrypted content keys EncKt(i−1) to EncKt(i−m). In each of the additional information info(i−1) to info(i−m), a check value in plain text corresponding to itself of the encrypted check values EncCheck(i−1) to EncCheck(i−m) is stored (in FIG. 26, only the check value Check(i−j) is shown as a representative). For example, the check value Check(i−j) in plain text is stored in the additional information info(i−j) of the encrypted content key EncKt(i−j) associated with the encrypted check value EncCheck(i−j). In this case, check values varying from content key to content key can be provided, resulting in an improvement in security. Also, the check value Check(i−j) may be stored at a predetermined position in the corresponding additional information info(i−j) in accordance with designated bytes.

Here, when tampering check is executed with respect to the encrypted content key EncKt(i−j), the partial-check data DATA21 is extracted from the additional information info(i−j) in accordance with designated bytes (ST202-5). Next, in step 202-4, the check value Check(i−j) obtained by the processes of steps ST202-1 to ST202-3 is compared with the partial-check data DATA21 extracted in step ST202-5. Thus, the presence or absence of tampering is checked in the encrypted content key EncKt(i−j).

<Entry>

Note that, in some target apparatuses, an area for storing a content key is previously secured in the form of an entry. Each entry is put in correspondence with a domain key. An encrypted content key stored in an entry can be decrypted using a domain key which is put in correspondence with the entry. In such a case, it is contemplated that a hash operation is executed with respect to a concatenation of check values corresponding to the entries. Specifically, no matter whether or not a content key is actually stored, pieces of data at a predetermined position may be extracted from all entries which are put in correspondence with the same domain key in accordance with designated bytes, the extracted pieces of data may be concatenated together and are then subjected to a hash operation, and the calculated hash value may be stored into domain key management information. In order to reduce the processing amount, the calculation amount of the hash operation is preferably small. Therefore, preferably, data extraction in accordance with designated bytes is executed only with respect to an entry(s) in which a content key is actually stored, the pieces of extracted data are concatenated together and are then subjected to a hash operation, and the calculated hash value is stored into domain key management information.

<Variations>

Various variations of this embodiment are contemplated. Representative variations will be hereinafter described.

(1) Encrypted contents do not necessarily need to be stored in the same target apparatus as that which stores encrypted content keys, and may be stored in a separate recording medium. In this case, a host apparatus obtains an encrypted content stored in the separate recording medium via a network or the like, and decrypts the encrypted content using a content key whose authenticity is guaranteed using the tampering check method of this embodiment.

(2) A position where a check value is buried may not be designated by designated bytes, and may be a fixed position. For example, if a check value is buried in the 8-byte LSB as a fixed position, it is possible to check tampering in all data (a content key and content key management information).

### Third Embodiment

In a third embodiment of the present invention, a whole-check value is used to execute tampering detection. Cipher block chaining is similar to that of FIG. 12. Also, a method for detecting the presence or absence of tampering in a content key Kt(i−j) and information UR[t](i−j) associated therewith is similar to that of the second embodiment.

<Configuration>

A whole configuration of a confidential information processing system according to the third embodiment of the present invention is similar to that of FIG. 13. Note that different confidential information is stored in the target apparatus 10.

<Confidential Information>

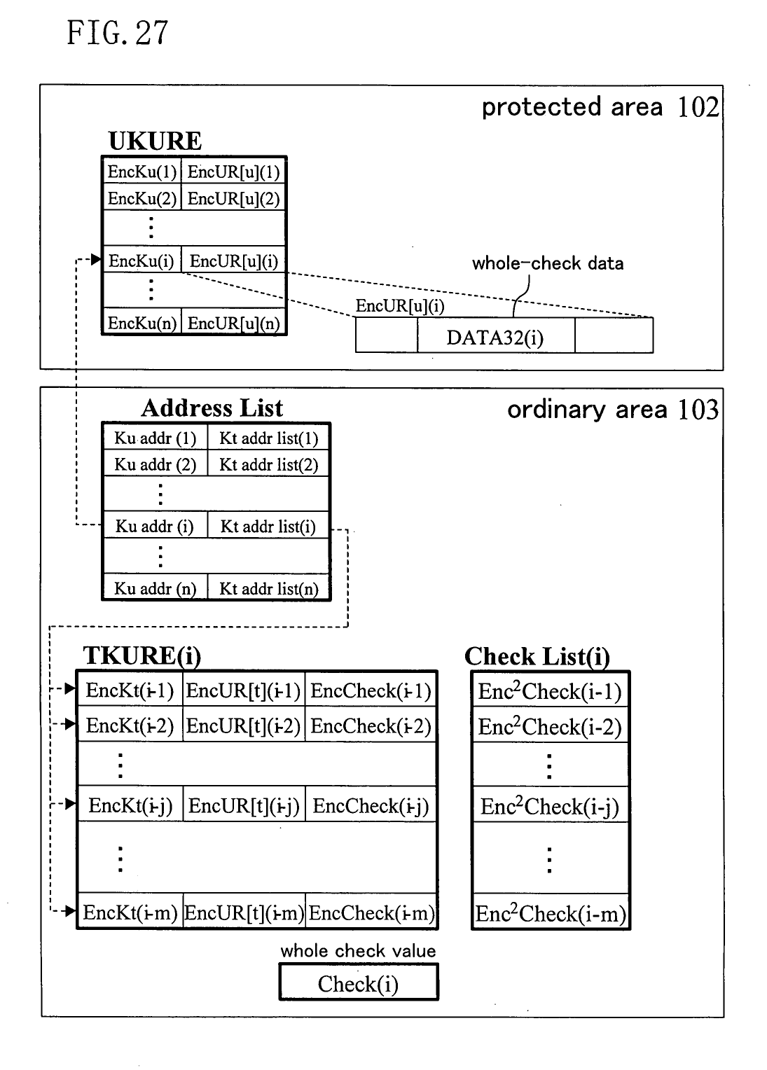

FIG. 27 shows confidential information which is stored in the target apparatus 10 of this embodiment. The protected area 102 stores a domain key group UKURE. The ordinary area 103 stores a key correspondence table Address List, a content key group TKURE(i), a check value list Check List(i), and a whole-check value Check(i). Note that the ordinary area 103 also stores encrypted contents, which are not shown in FIG. 27.

[Domain Key Group]

The domain key group UKURE includes, as in FIG. 14, n encrypted domain keys EncKu(1) to EncKu(n) and n pieces of encrypted domain key management information EncUR[u](1) to EncUR[u](n). Also, whole-check data is stored at a predetermined position in each of the encrypted domain key management information EncUR[u](1) to EncUR[u](n). The whole-check data is generated based on a content key group corresponding to its domain key and a whole-check value. For example, whole-check data DATA32(i) generated based on the content key group TKURE(i) and the whole-check value Check(i) is stored at a predetermined position in the encrypted domain key management information EncUR[u](i).

Although only the content key group TKURE(i) corresponding to the encrypted domain key EncKu(i) is shown in FIG. 27, content key groups may correspond to encrypted domain keys EncKu(1) to EncKu(n) as well as the encrypted domain key EncKu(i).

[Content Key Group and Key Correspondence Table]

The content key group TKURE(i) and the key correspondence table Address List are similar to those of FIG. 14.

[Check Value List]

The check value list Check List(i) corresponds to the content key group TKURE(i). Also, the check value list Check List(i) includes m doubly-encrypted check values Enc²Check(i−1) to Enc²Check(i−m). The doubly-encrypted check values Enc²Check(i−1) to Enc²Check(i−m) are in one-to-one correspondence with the encrypted check values EncCheck(i−1) to EncCheck(i−m) included in the content key group TKURE(i).

Although only the check value list Check List(i) corresponding to the content key group TKURE(i) is shown in FIG. 27, hash lists corresponding to other content key groups (not shown) may be present as well as the content key group TKURE(i).

[Whole-Check Value]

The whole-check value Check(i) corresponds to the content key group TKURE(i). Although only the whole-check value Check(i) corresponding to the content key group TKURE(i) is shown in FIG. 27, whole-check values corresponding to other content key groups (not shown) may be present as well as the content key group TKURE(i).

<Procedure for Generating Check Value List and Encrypted Check Value>

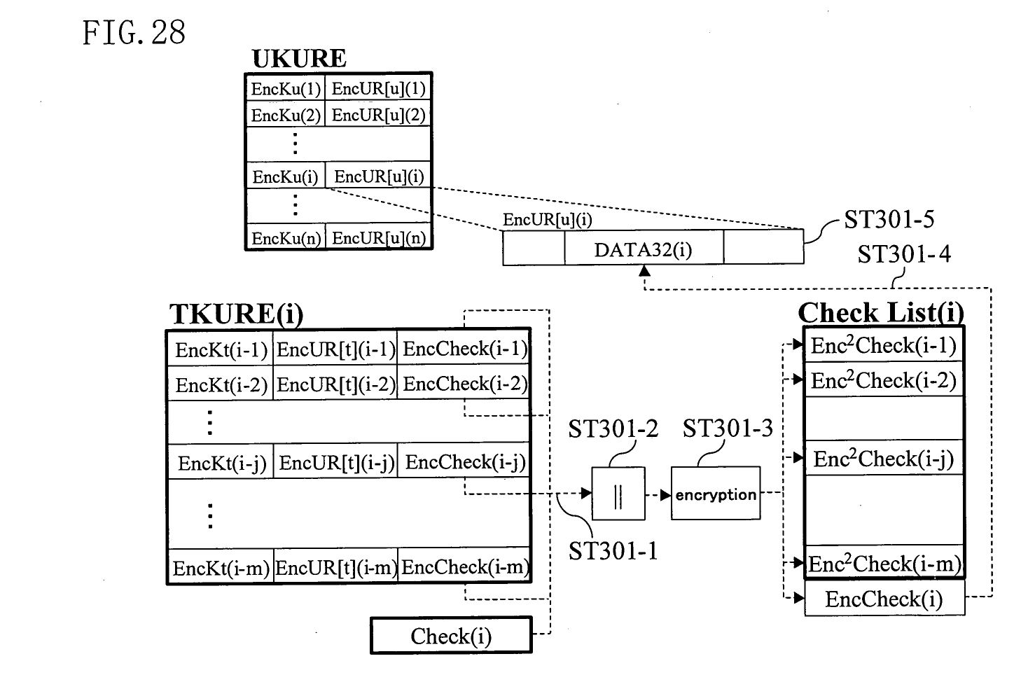

A procedure for generating the check value list Check List(i) and the whole-check data DATA32(i) of FIG. 27 will be described with reference to FIG. 28.

[Step ST301-1]

Initially, the m encrypted check values EncCheck(i−1) to EncCheck(i−m) are extracted from the content key group TKURE(i) in accordance with designated bytes. For example, from concatenated data including an encrypted content key EncKt(i−j), encrypted content key management information EncUR(i−j), and an encrypted check value EncCheck(i−j), an encrypted check value EncCheck(i−j) is extracted. Thus, the m encrypted check values EncCheck(i−1) to EncCheck(i−m) are extracted.

[Step ST301-2]

Next, the m encrypted check values EncCheck(i−1) to EncCheck(i−m) extracted in step ST301-1 and the whole-check value Check(i) are concatenated together. Thereby, a piece of check value concatenated data is generated.

[Step ST301-3]

Next, the check value concatenated data is encrypted using the domain key Ku(i) in accordance with cipher block chaining. Thereby, a set of the doubly-encrypted check values Enc²Check(i−1) to Enc²Check(i−m) and the encrypted whole-check value EncCheck(i) is generated.

[Step ST301-4]

Next, the encrypted whole-check value EncCheck(i) is extracted from the set of the doubly-encrypted check values Enc²Check(i−1) to Enc²Check(i−m) and the encrypted whole-check value EncCheck(i). Thereby, the set of the doubly-encrypted check values Enc²Check(i−1) to Enc²Check(i−m) becomes the check value list Check List(i).

[Step ST301-5]

Next, the encrypted whole-check value EncCheck(i) extracted in step ST301-4 is stored as the whole-check data DATA32(i) at a predetermined position in the domain key management information UR[u](i).

Here, when the encrypted domain key management information EncUR[u](i) is updated (e.g., when new content key information is put in correspondence with the existing encrypted domain key EncKu(i), or when content key information corresponding to the encrypted domain key EncKu(i) is deleted), the encrypted domain key management information EncUR[u](i) is temporarily decrypted into the domain key management information UR[u](i) before the encrypted whole-check value EncCheck(i) is stored. Thereafter, when the encrypted whole-check value EncCheck(i) is stored into the domain key management information UR[u](i), the domain key management information UR[u](i) is encrypted and returned to the encrypted domain key management information EncUR[u](i). Thus, the whole-check data DATA32(i) is updated.

Note that, when the domain key Ku(i) is also newly produced, the domain key management information UR[u](i) is also newly produced, so that the temporary decryption process is not required. In this case, an encrypted whole-check value EncCheck(i) is stored into the newly produced domain key management information UR[u](i) before the domain key management information UR[u](i) is encrypted. Thus, new encrypted domain key management information EncUR[u](i) is generated.

<Tampering Detecting Method>

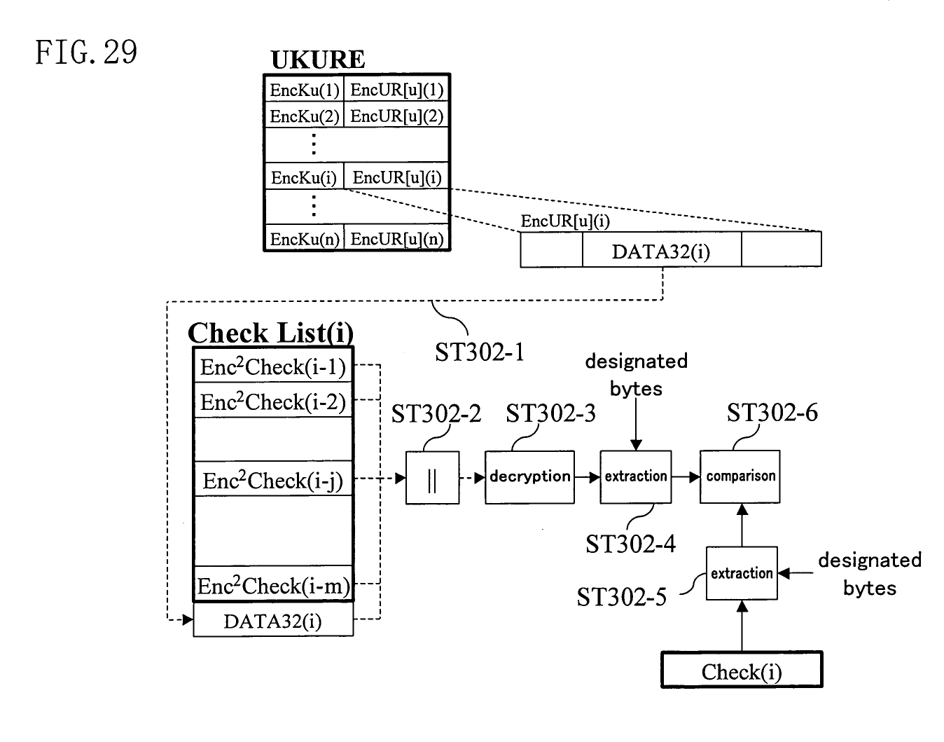

A tampering detecting method using the whole-check value Check(i) of FIG. 27 will be described with reference to FIG. 29. Here, the encrypted domain key EncKu(i), the check value list Check List(i), and the whole-check value Check(i) will be described as an example. Note that the tampering detecting method using the check values Check(i−1) to Check(i−m) of FIG. 27 is similar to the method of FIG. 16.

[Step ST302-1]

Initially, the encrypted domain key management information EncUR[u](i) is decrypted. Thereby, the domain key management information UR[u](i) is generated. Thereafter, the whole-check data DATA32(i) stored at a predetermined position in the domain key management information UR[u](i) is extracted.

[Step ST302-2]

Next, the m doubly-encrypted check values Enc²Check(i−1) to Enc²Check(i−m) which are present in the check value list Check List(i) are concatenated together. Thereafter, the whole-check data DATA32(i) extracted in step ST302-1 is further concatenated after the concatenated data including the m doubly-encrypted check values Enc²Check(i−1) to Enc²Check(i−m). Specifically, in the concatenated data including the doubly-encrypted check values Enc²Check(i−1) to Enc²Check(i−m) and the whole-check data DATA32(i), the LSB is the whole-check data DATA32(i). Thereby, a piece of check value concatenated data is generated.

[Step ST302-3]

Next, using the domain key Ku(i), decryption by cipher block chaining is executed with respect to the check value concatenated data.

[Step ST302-4]

Next, data (here, 8-byte data (LSB) in the set) at a predetermined position in the decrypted check value concatenated data is extracted. Thereby, data corresponding to the whole-check value Check(i) is extracted. Next, the process goes to step ST302-6.

[Step ST302-5]

On the other hand, the whole-check value Check(i) stored in the ordinary area 103 of the target apparatus 10 is extracted in accordance with designated bytes. Next, the process goes to step ST302-6.

[Step ST302-6]

Next, the data extracted in step ST302-4 is compared with the whole-check value Check(i) extracted in step ST302-5. Here, when both are equal to each other, it is determined that the check value list Check List(i) or the whole-check value Check(i) has not been tampered. On the other hand, when both are not equal to each other, it is determined that the check value list Check List(i) or the whole-check value Check(i) has been tampered, and abnormal end is executed.

Thus, the authenticity of the check value list Check List(i) can be verified. If the check value list has not been tampered, the presence or absence of tampering can be detected in the encrypted content key. For example, when tampering is checked in the encrypted content key EncKt(i−j), the encrypted check value EncCheck(i−j) corresponding to the content key Kt(i−j) is extracted from the check value list Check List(i) decrypted in step ST302-3. On the other hand, the encrypted check value EncCheck(i−j) is extracted from the content key group TKURE(i). Thereafter, the encrypted check value EncCheck(i−j) extracted from the decrypted check value list Check List(i) is compared with the encrypted check value EncCheck(i−j) extracted from the content key group TKURE(i). Thus, it can be verified whether or not the encrypted content key EncKt(i−j) and information associated therewith (the encrypted content key management information EncUR[t](i−j), etc.) have been tampered.

<Tampering Detecting Method>

Next, a confidential information processing system of this embodiment will be described. The whole flow of the operation of the confidential information processing system of this embodiment is similar to that of FIG. 5, except for a detailed process of checking tampering in a content key (step ST22). In this embodiment, in step ST22, the authenticity of a content key is verified by executing the tampering check method of FIG. 16 (the tampering check method using the check values Check(i−1) to Check(i−m)) and the tampering check method of FIG. 29 (the tampering check method using the whole-check value Check(i)).

<Addition and Deletion of Content Key Information>

Also, it is contemplated that, in the future, a content key may be added or deleted by distribution via a network. When content key information is added or deleted, the whole-check data DATA32(i) is updated.

[Addition of Content Key Information]

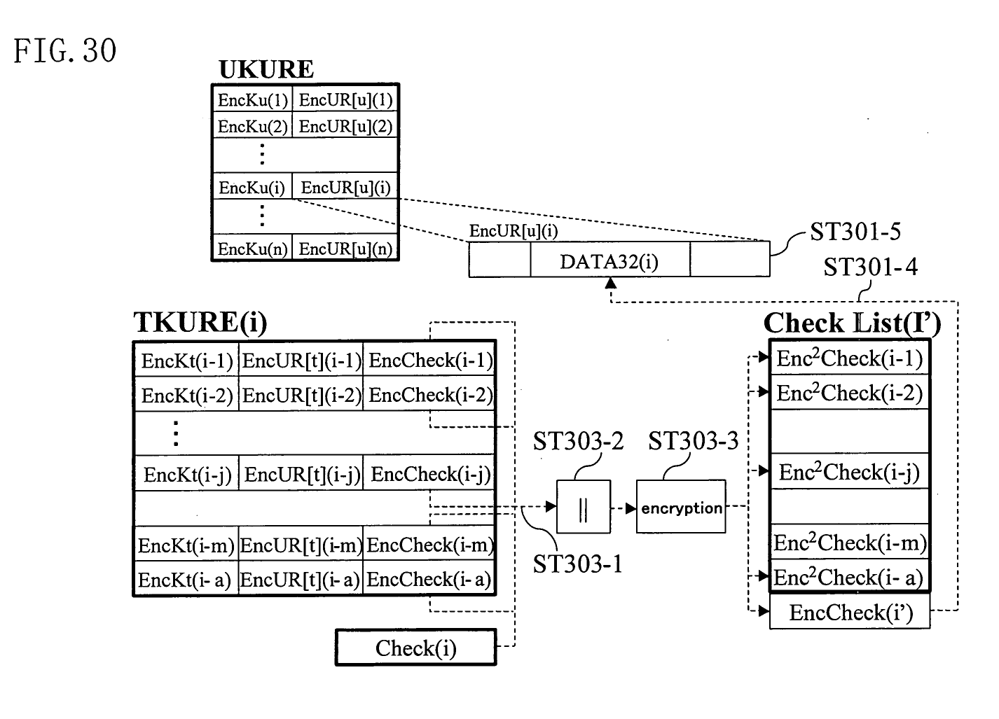

A case where a content key is added will be described with reference to FIG. 30. Note that, here, encrypted content key information including an encrypted content key EncKt(i−a), encrypted content key management information EncUR[t](i−a), and an encrypted check value EncCheck(i−a) is added. The encrypted content key information is generated by adding a check value Check (i−a) to the content key information including the content key Kt(i−a) and the content key management information UR[t](i−a) and subjecting the resultant content key information to cipher block chaining using the domain key Ku(i).

[Step ST303-1]

Initially, the encrypted check values EncCheck(i−1) to EncCheck(i−m) associated with the encrypted content keys EncKt(i−1) to EncKt(i−m), and an encrypted check value EncCheck(i−a) associated with the added encrypted content key EncKt(i−a), are extracted.

[Step ST303-2]

Next, the encrypted check values EncCheck(i−1) to EncCheck(i−m) and EncCheck(i−a) thus extracted and the whole check value Check(i) are concatenated together. Thereby, a piece of check value concatenated data is generated.

[Step ST303-3]

Next, the check value concatenated data generated in step ST303-2 is encrypted in accordance with cipher block chaining. Thereby, a set of doubly-encrypted check values Enc²Check(i−1) to Enc²Check(i−m) and Enc²Check(i−a) and an encrypted whole-check value EncCheck(i′) is generated.

[Steps ST303-4 and ST303-5]

Next, as in the process of step ST303-4, the encrypted whole-check value EncCheck(i′) is extracted from the set of the doubly-encrypted check values Enc²Check(i−1) to Enc²Check(i−m) and Enc²Check(i−a) and the encrypted whole-check value EncCheck(i). Thereby, the set of the doubly-encrypted check values Enc²Check(i−1) to Enc²Check(i−m) and Enc²Check(i−a) becomes a new check value list Check List(i′). Next, as in the process of step ST303-5, the encrypted whole-check value EncCheck(i′) thus extracted is stored as new whole-check data DATA32(i) at a predetermined position in the domain key management information UR[u](i).

Thus, the check value list Check List(i) and the whole-check data DATA32(i) are updated.

[Deletion of Content Key Information]

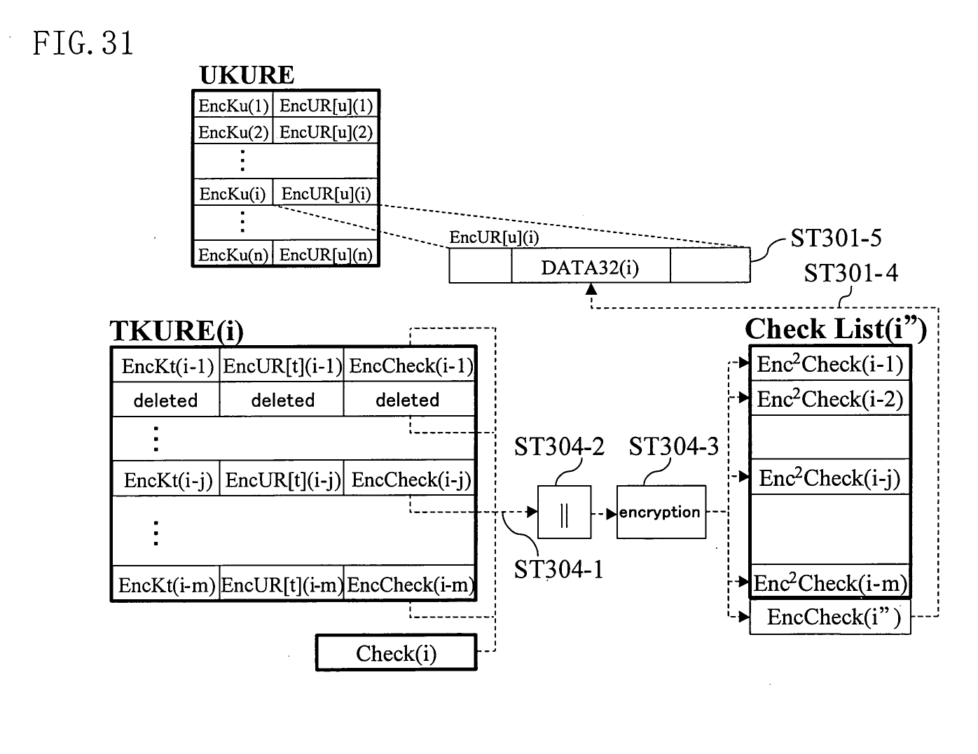

A case where content key information is deleted will be described with reference to FIG. 31. Note that, here, encrypted content key information including the encrypted content key EncKt(i−2), the encrypted content key management information EncUR[t](i−2), and the encrypted check value EncCheck(i−2) is deleted.

[Step ST304-1]

Initially, the encrypted check values EncCheck(i−1) and EncCheck(i−3) to EncCheck(i−m) associated with the (m−1) encrypted content keys EncKt(i−1) and EncKt(i−3) to EncKt(i−m) other than the encrypted content key EncKt(i−2) thus deleted, are extracted.

[Step ST304-2]

Next, the (m−1) encrypted check values EncCheck(i−1) and EncCheck(i−3) to EncCheck(i−m) thus extracted and the whole-check value Check(i) are concatenated together. Thereby, check value concatenated data is generated.

[Step ST304-3]

Next, the check value concatenated data generated in step ST304-2 is encrypted in accordance with cipher block chaining. Thereby, a set of the doubly-encrypted check values Enc²Check(i−1) and Enc²Check(i−3) to Enc²Check(i−m) and an encrypted whole-check value EncCheck(i″) is generated.

[Steps ST301-4 and ST301-5]

Next, as in the process of step ST301-4, the encrypted whole-check value EncCheck(i″) is extracted from the set of the doubly-encrypted check values Enc²Check(i−1) and Enc²Check(i−3) to Enc²Check(i−m) and the encrypted whole-check value EncCheck(i″). Thereby, the set of the doubly-encrypted check values Enc²Check(i−1) and Enc²Check(i−3) to Enc²Check(i−m) becomes a new check value list Check List(i″). Next, as in the process of step ST301-5, the encrypted whole-check value EncCheck(i″) thus extracted is stored as new whole-check data DATA32(i) at a predetermined position in the domain key management information UR[u](i).

Thus, the check value list Check List(i) and the whole-check data DATA32(i) are updated.

<Effect>

As described above, in the process of detecting the presence or absence of tampering in confidential information, a check value is extracted from a piece of content key information, and a decryption process is executed with respect to concatenated data including whole-check data and m doubly-encrypted check values. Thus, not the whole content key group TKURE(i) needs to be subjected to a hash operation, thereby making it possible to reduce a processing amount during the tampering detecting process.

Also, in the process of generating confidential information, a check value is extracted from each of m pieces of encrypted content key information, and a piece of whole-check data is generated from a whole-check value and m encrypted check values. Thus, data (check values and whole-check data) used in the tampering detecting process is generated in a plurality of separate stages. Thereafter, check data (whole-check data) for the final stage is stored in a protected area. Thus, the amount of data to be stored in the protected area can be reduced.

Further, when new content key information is added to confidential information, a check value is extracted from the added content key information, while new whole-check data is generated from concatenated data including a whole-check value, an encrypted check value extracted from existing content key information, and an encrypted check value extracted from new content key information. Also, when content key information is deleted from confidential information, a doubly-encrypted check value corresponding to the deleted content key information is deleted from a check value list, and an encryption process using cipher block chaining is executed with respect to concatenated data including a whole-check value and a doubly-encrypted check value which has not been deleted, to generate new whole-check data. Thus, not the whole content key group TKURE(i) needs to be subjected to a hash operation, thereby making it possible to reduce a processing amount during updating of confidential information.

<Variations>

Various variations of this embodiment are contemplated. Representative three variations will be hereinafter described.

(1) Encrypted contents do not necessarily need to be stored in the same target apparatus as that which stores encrypted content keys, and may be stored in a separate recording medium. In this case, a host apparatus obtains an encrypted content stored in the separate recording medium via a network or the like, and decrypts the encrypted content using a content key whose authenticity is guaranteed using the tampering check method of this embodiment.

(2) A position where a check value is buried may not be designated by designated bytes, and may be a fixed position. For example, if a check value is buried in the 8-byte LSB as a fixed position, thereby making it possible to detect the presence or absence of tampering in all data (a content key and content key management information).

(3) The whole-check value Check(i) as well as the partial-check data DATA21 may also be stored as a constant in the ROM 116, a register (not shown), or the like. Also, when the constant has some regularity, the constant can be implemented using a combination of operators without a register. In general, it is more advantageous in terms of circuit area when the constant is implemented using a combination of operators than when a register is provided.

In the above descriptions of the embodiments, the schematic flowchart of FIG. 20 5 may be changed as appropriate, depending on the tampering check method (the process of step ST22) for a content key of each embodiment. Those skilled in the art would easily change the schematic flowchart of FIG. 5 as appropriate, depending on each embodiment.

### INDUSTRIAL APPLICABILITY

The present invention is applicable to, for example, a confidential information processing system comprising a target apparatus and a host apparatus.

1. A key information generating method performed by a host apparatus comprising a data generating section for generating key information including domain key information and m (m is a natural number) pieces of content key information, the presence or absence of tampering being detected in the key information, and a data writing section for writing the key information generated by the data generating section into a target apparatus, wherein
the target apparatus includes a first memory area and a second memory area having a higher security level than that of the first memory area,
each of the m pieces of content key information includes a content key used for encryption and decryption of a content,
the domain key information includes a domain key used for encryption and decryption of the m pieces of content key information, and
the method comprises the steps:
(A) the data generating section adds first data corresponding to partial-check data used for a tampering detecting process to each of the m pieces of content key information, and subjects each of the m pieces of content key information to cipher block chaining using the domain key;
(B) the data generating section extracts the first data as it is encrypted from each of the m pieces of content key information encrypted in the step (A);
(C) the data generating section executes a predetermined operation with respect to concatenated data including the m pieces of first data extracted in the step (B) to generate second data;
(D) the data generating section adds the second data generated in the step (C) as whole-check data to the domain key information; and
(E) the data writing section writes the m pieces of encrypted content key information into the first memory area and the domain key information into the second memory area.

2. The key information generating method of claim 1, wherein the predetermined operation is a hash operation.

3. The key information generating method of claim 2, wherein an algorithm of the cipher block chaining and an algorithm of the hash operation partially overlap each other.

4. A key information generating method performed by a host apparatus comprising a data generating section for generating key information including domain key information and m (m is a natural number) pieces of content key information, the presence or absence of tampering being detected in the key information, and a data writing section for writing the key information generated by the data generating section into a target apparatus, wherein
the target apparatus includes a first memory area and a second memory area having a higher security level than that of the first memory area,
each of the m pieces of content key information includes a content key used for encryption and decryption of a content,
the domain key information includes a domain key used for encryption and decryption of the m pieces of content key information, and
the method comprises the steps:
(A) the data generating section adds first data corresponding to partial-check data used for a tampering detecting process to each of the m pieces of content key information, and subjects each of the m pieces of content key information to cipher block chaining using the domain key;
(B) the data generating section extracts the first data as it is encrypted from each of the m pieces of content key information encrypted in the step (A);
(C) the data generating section executes cipher block chaining with respect to concatenated data including second data and the m pieces of first data extracted in the step (B) and extracts the second data as it is encrypted from the encrypted concatenated data;
(D) the data generating section adds the second data extracted in the step (C) as whole-check data to the domain key information; and
(E) the data writing section writes the m pieces of encrypted first data included in the concatenated data encrypted in the step (C) into the first memory area, the m pieces of encrypted content key information into the first memory area, and the domain key information into the second memory area.

5. The key information generating method of claim 1, wherein, in each of the m pieces of content key information, the first data is provided at a previously designated position in the content key information.

6. The key information generating method of claim 1, wherein, in each of the m pieces of content key information, the first data is provided as data having a predetermined length at a least significant position in the content key information.

7. The key information generating method of claim 1, further comprising the step of:
(F) putting additional information in which the partial-check data is stored at a predetermined position in correspondence with the m pieces of content key information,
wherein, in the step (E), further, the data writing section writes the m pieces of additional information into the first memory area.

8. A key information generating method performed by a host apparatus comprising a data generating section for generating key information including domain key information and m (m is a natural number) pieces of content key information, the presence or absence of tampering being detected in the key information, and a data writing section for writing the key information generated by the data generating section into a target apparatus, wherein
the target apparatus includes a first memory area and a second memory area having a higher security level than that of the first memory area,
each of the m pieces of content key information includes a content key used for encryption and decryption of a content,
the domain key information includes a domain key used for encryption and decryption of the m pieces of content key information, and
the method comprises the steps:
(A) the data generating section encrypts each of the m pieces of content key information using the domain key;
(B) the data generating section executes a first operation with respect to each of the m pieces of content key information encrypted in the step (A) to generate m pieces of first data;
(C) the data generating section executes a second operation with respect to concatenated data including the m pieces of first data generated in the step (B) to generate second data;
(D) the data generating section adds the second data generated in the step (C) as whole-check data to the domain key information; and
(E) the data writing section writes the m pieces of first data as m pieces of partial-check data into the first memory area, the m pieces of encrypted content key information into the first memory area, and the domain key information into the second memory area.

9. The key information generating method of claim 8, wherein the first and second operations are each a hash operation.

10. The key information generating method of claim 1, wherein
the key information further includes an authentication key used for encryption and decryption of the domain key information,
the target apparatus further includes a third memory area having a higher security level than that of the second area and for storing the authentication key, and
the method further comprises the step:
(F) the data generating section encrypts the domain key information using the authentication key,
in the step (E), the data writing section writes the domain key information encrypted in the step (F) into the second memory area.

11. The key information generating method of claim 10, wherein
the first memory area can be arbitrarily accessed by the host apparatus,
the second memory area can be accessed by the host apparatus if authentication is successful between the host apparatus and the target apparatus, and
the third memory area is used to execute mutual authentication between the host apparatus and the target apparatus.

12. The key information generating method of claim 11, wherein the third memory area is caused not to be rewritable after the authentication key is written thereinto.

13. The key information generating method of claim 1, wherein the target apparatus is a portable memory device which is operated in accordance with a clock and an operation instruction from the host apparatus.

14. A key information generating apparatus for generating key information including domain key information and m (m is a natural number) pieces of content key information, the presence or absence of tampering being detected in the key information, and writing the key information into a target apparatus, wherein
the target apparatus includes a first memory area and a second memory area having a higher security level than that of the first memory area,
each of the m pieces of content key information includes a content key used for encryption and decryption of a content,
the domain key information includes a domain key used for encryption and decryption of the m pieces of content key information, and
the generating apparatus comprises:
an encryption section for adding first data corresponding to partial-check data used for a tampering detecting process to each of the m pieces of content key information, and subjecting each of the m pieces of content key information to cipher block chaining using the domain key;
a data extracting section for extracting the first data as it is encrypted from each of the m pieces of content key information encrypted by the encryption section;
a data generating section for executing a predetermined operation with respect to concatenated data including the m pieces of first data extracted by the data extracting section to generate second data;
a data adding section for adding the second data generated by the data generating section as whole-check data to the domain key information; and
a data writing section for writing the m pieces of encrypted content key information into the first memory area and the domain key information into the second memory area.

15. A key information generating apparatus for generating key information including domain key information and m (m is a natural number) pieces of content key information, the presence or absence of tampering being detected in the key information, and writing the key information into a target apparatus, wherein
the target apparatus includes a first memory area and a second memory area having a higher security level than that of the first memory area,
each of the m pieces of content key information includes a content key used for encryption and decryption of a content,
the domain key information includes a domain key used for encryption and decryption of the m pieces of content key information, and
the generating apparatus comprises:
an encryption section for adding first data corresponding to partial-check data used for a tampering detecting process to each of the m pieces of content key information, and subjecting each of the m pieces of content key information to cipher block chaining using the domain key;
a data extracting section for extracting the first data as it is encrypted from each of the m pieces of content key information encrypted by the encryption section;
a data processing section for executing cipher block chaining with respect to concatenated data including second data and the m pieces of first data extracted by the data extracting section and extracts the second data as it is encrypted from the encrypted concatenated data;
a data adding section for adding the second data extracted by the data processing section as whole-check data to the domain key information; and
a data writing section for writing the m pieces of encrypted first data included in the concatenated data encrypted by the data processing section into the first memory area, the m pieces of encrypted content key information into the first memory area, and the domain key information into the second memory area.

16. A key information generating apparatus for generating key information including domain key information and m (m is a natural number) pieces of content key information, the presence or absence of tampering being detected in the key information, and writing the key information into a target apparatus, wherein
the target apparatus includes a first memory area and a second memory area having a higher security level than that of the first memory area,
each of the m pieces of content key information includes a content key used for encryption and decryption of a content,
the domain key information includes a domain key used for encryption and decryption of the m pieces of content key information, and
the generating apparatus comprises:
an encryption section for encrypting each of the m pieces of content key information using the domain key;
a first operation section for executing a first operation with respect to each of the m pieces of content key information encrypted by the encryption section to generate m pieces of first data;
a second operation section for executing a second operation with respect to concatenated data including the m pieces of first data generated by the first operation section to generate second data;
a data adding section for adding the second data generated by the second operation section as whole-check data to the domain key information; and
a data writing section for writing the m pieces of first data as m pieces of partial-check data into the first memory area, the m pieces of encrypted content key information into the first memory area, and the domain key information into the second memory area.

17. A key information updating method performed by a host apparatus comprising a data updating section for adding new content key information to key information and updating the key information, the presence or absence of tampering being detected in the key information, and a data writing section for writing the key information updated by the data updating section into a target apparatus, wherein
the target apparatus includes a first memory area and a second memory area having a higher security level than that of the first memory area,
the key information includes domain key information and m (m is a natural number) pieces of content key information,
each of the m pieces of content key information includes a content key used for encryption and decryption of a content, and first data corresponding to partial-check data used for a tampering detecting process,
the domain key information includes a domain key used for encryption and decryption of the m pieces of content key information, and whole-check data,
each of the m pieces of content key information is encrypted, and
the updating method comprises the steps:
(A) the data updating section adds the first data to the new content key information and executes cipher block chaining with respect to the content key information using the domain key;
(B) the data updating section extracts the first data as it is encrypted from the content key information encrypted in the step (A);
(C) the data updating section executes a predetermined operation with respect to concatenated data including the first data extracted in the step (B) and the first data included in each of the m pieces of encrypted content key information, to generate second data;
(D) the data updating section rewrites the whole-check data included in the domain key information with the second data generated in the step (C); and
(E) the data writing section writes the m pieces of encrypted content key information and the encrypted new content key information into the first memory area and the domain key information into the second memory area.

18. A key information updating method performed by a host apparatus comprising a data updating section for adding new content key information to key information and updating the key information, the presence or absence of tampering being detected in the key information, and a data writing section for writing the key information updated by the data updating section into a target apparatus, wherein
the target apparatus includes a first memory area and a second memory area having a higher security level than that of the first memory area,
the key information includes domain key information, m (m is a natural number) pieces of content key information, m pieces of encrypted first data, and second data,
each of the m pieces of content key information includes a content key used for encryption and decryption of a content, and first data corresponding to partial-check data used for a tampering detecting process,
the domain key information includes a domain key used for encryption and decryption of the m pieces of content key information, and whole-check data,
each of the m pieces of content key information is encrypted, and
the updating method comprises the steps:
(A) the data updating section adds the first data to the new content key information and executes cipher block chaining with respect to the content key information using the domain key;
(B) the data updating section extracts the first data as it is encrypted from the content key information encrypted in the step (A);
(C) the data updating section executes cipher block chaining using the domain key with respect to concatenated data including the second data, the m pieces of encrypted first data, and the first data extracted in the step (B), and extracts the second data as it is encrypted from the encrypted concatenated data;
(D) the data updating section rewrites the whole-check data included in the domain key information with the second data generated in the step (C); and
(E) the data writing section writes the (m+1) pieces of first data included in the concatenated data encrypted in the step (C) into the first memory area, the m pieces of encrypted content key information and the encrypted new content key information into the first memory area, and the domain key information into the second memory area.

19. A key information updating method performed by a host apparatus comprising a data updating section for adding new content key information to key information and updating the key information, the presence or absence of tampering being detected in the key information, and a data writing section for writing the key information updated by the data updating section into a target apparatus, wherein
the target apparatus includes a first memory area and a second memory area having a higher security level than that of the first memory area,
the key information includes domain key information, m (m is a natural number) pieces of content key information, and m pieces of partial-check data,
each of the m pieces of content key information includes a content key used for encryption and decryption of a content,
the domain key information includes a domain key used for encryption and decryption of the m pieces of content key information, and whole-check data,
each of the m pieces of content key information is encrypted, and
the updating method comprises the steps:
(A) the data updating section encrypts the new content key information;
(B) the data updating section executes a first operation with respect to the new content key information encrypted in the step (A) to generate first data;
(C) the data updating section executes a second operation with respect to concatenated data including the m pieces of partial-check data and the first data generated in the step (B), to generate second data;
(D) the data updating section rewrites the whole-check data included in the domain key information with the second data generated in the step (C); and
(E) the data writing section writes the m pieces of partial-check data and the first data as (m+1) pieces of partial-check data into the first memory area, the m pieces of encrypted content key information and the encrypted new content key information into the first memory area, and the domain key information into the second memory area.

20. A key information updating method performed by a host apparatus comprising a data updating section for deleting any one piece of content key information from key information and updating the key information, the presence or absence of tampering being detected in the key information, and a data writing section for writing the key information updated by the data updating section into a target apparatus, wherein
the target apparatus includes a first memory area and a second memory area having a higher security level than that of the first memory area,
the key information includes domain key information and m (m is a natural number) pieces of content key information,
each of the m pieces of content key information includes a content key used for encryption and decryption of a content, and first data corresponding to partial-check data used for a tampering detecting process,
the domain key information includes a domain key used for encryption and decryption of the m pieces of content key information, and whole-check data,
each of the m pieces of content key information is encrypted, and
the updating method comprises the steps:
(A) the data updating section deletes any one of the m pieces of encrypted content key information;
(B) the data updating section extracts first data as it is encrypted from each of the (m−1) pieces of encrypted content key information which are not deleted in the step (A);
(C) the data updating section executes a predetermined operation with respect to concatenated data including the (m−1) pieces of first data extracted in the step (B) to generate second data;
(D) the data updating section rewrites the whole-check data included in the domain key information with the second data generated in the step (C); and
(E) the data writing section writes the (m−1) pieces of encrypted content key information into the first memory area and the domain key information into the second memory area.

21. A key information updating method performed by a host apparatus comprising a data updating section for deleting any one piece of content key information from key information and updating the key information, the presence or absence of tampering being detected in the key information, and a data writing section for writing the key information updated by the data updating section into a target apparatus, wherein
the target apparatus includes a first memory area and a second memory area having a higher security level than that of the first memory area,
the key information includes domain key information, m (m is a natural number) pieces of content key information, m pieces of encrypted first data, and second data,
each of the m pieces of content key information includes a content key used for encryption and decryption of a content, and first data corresponding to partial-check data used for a tampering detecting process,
the domain key information includes a domain key used for encryption and decryption of the m pieces of content key information, and whole-check data,
the m pieces of encrypted first data are in one-to-one correspondence with the m pieces of content key information,
each of the m pieces of content key information is encrypted, and
the updating method comprises the steps:
(A) the data updating section deletes any one of the m pieces of content key information;
(B) the data updating section extracts first data as it is encrypted from each of the (m−1) pieces of encrypted content key information which are not deleted in the step (A);
(C) the data updating section deletes first data corresponding to content key information deleted in the step (A) of the m pieces of encrypted first data;
(D) the data updating section executes cipher block chaining using the domain key with respect to concatenated data including the second data and the (m−1) encrypted first data which are not deleted in the step (C), and extracts the second data as it is encrypted from the encrypted concatenated data;
(E) the data updating section rewrites the whole-check data included in the domain key information with the second data extracted in the step (D); and
(F) the data writing section writes the (m−1) pieces of first data included in the concatenated data encrypted in the step (D) into the first memory area, the (m−1) pieces of encrypted content key information into the first memory area, and the domain key information into the second memory area.

22. A key information updating method performed by a host apparatus comprising a data updating section for deleting any one piece of content key information from key information and updating the key information, the presence or absence of tampering being detected in the key information, and a data writing section for writing the key information updated by the data updating section into a target apparatus, wherein
the target apparatus includes a first memory area and a second memory area having a higher security level than that of the first memory area,
the key information includes domain key information, m (m is a natural number) pieces of content key information, and m pieces of partial-check data,
each of the m pieces of content key information includes a content key used for encryption and decryption of a content,
the domain key information includes a domain key used for encryption and decryption of the m pieces of content key information, and whole-check data,
the m pieces of partial-check data are in one-to-one correspondence with the m pieces of content key information,
each of the m pieces of content key information is encrypted,
the updating method comprises the steps:
(A) the data updating section deletes any one of the m pieces of encrypted content key information;
(B) the data updating section deletes partial-check data corresponding to the content key information deleted in the step (A) of the m pieces of partial-check data;
(C) the data updating section executes a second operation with respect to concatenated data including the (m−1) partial-check data which are not deleted in the step (B) to generate second data;
(D) the data updating section rewrites the whole-check data included in the domain key information with the second data generated in step (C); and
(E) the data writing section writes the (m−1) partial-check data which are not deleted in the step (B) into the first memory area, the (m−1) pieces of encrypted content key information into the first memory area, and the domain key information into the second memory area.

23. A tampering detecting method performed by a host apparatus for detecting the presence or absence of tampering in key information stored in a target apparatus, wherein
the key information includes domain key information and m (m is a natural number) pieces of content key information,
each of the m pieces of content key information includes a content key used for encryption and decryption of a content, and first data corresponding to partial-check data used for a tampering detecting process,
the domain key information includes a domain key used for encryption and decryption of the m content keys, and whole-check data,
each of the m pieces of content key information is encrypted, and
the detecting method comprises the steps:
(A) executing chaining decryption using the domain key with respect to any one of the m pieces of encrypted content key information, and extracting the first data from the decrypted content key information;
(B) comparing the first data extracted in the step (A) with previously prepared partial-check data;
(C) extracting the first data as it is encrypted from each of the m pieces of content key information, and executing a predetermined operation with respect to concatenated data including the m pieces of extracted first data to generate second data;
(D) comparing the second data generated in the step (C) with the whole-check data included in the domain key information; and
(E) determining that the key information has not been tampered if the first data matches the partial-check data in the step (B) and the second data matches the whole-check data in the step (D).

24. The tampering detecting method of claim 23, wherein the whole-check data corresponds to data which is obtained by extracting m pieces of first data as they are encrypted from m pieces of encrypted content key information which have not been tampered, and executing a predetermined operation with respect to concatenated data including the m pieces of extracted first data.

25. The tampering detecting method of claim 23, wherein
the target apparatus includes:
a first memory area for storing the m pieces of encrypted content key information; and
a second memory area having a higher security level than that of the first memory area and for storing the domain key information.

26. The tampering detecting method of claim 23, wherein the predetermined operation is a hash operation.

27. The tampering detecting method of claim 26, wherein an algorithm of the hash operation and an algorithm of the cipher block chaining partially overlap each other.

28. A tampering detecting method performed by a host apparatus for detecting the presence or absence of tampering in key information stored in a target apparatus, wherein
the key information includes domain key information, m (m is a natural number) pieces of content key information, m pieces of encrypted first data, and second data,
each of the m pieces of content key information includes a content key used for encryption and decryption of a content, and first data corresponding to partial-check data used for a tampering detecting process,
the domain key information includes a domain key used for encryption and decryption of the m content keys, and whole-check data,
each of the m pieces of content key information is encrypted, and
the detecting method comprises the steps:
(A) executing chaining decryption using the domain key with respect to any one of the m pieces of encrypted content key information, and extracting the first data from the decrypted content key information;
(B) comparing the first data extracted in the step (A) with previously prepared partial-check data;
(C) executing chaining decryption using the domain key with respect to concatenated data including the whole-check data included in the domain key information and the m pieces of encrypted first data, and extracting the whole-check data from the decrypted concatenated data;
(D) comparing the second data with the whole-check data extracted in the step (C); and
(E) determining that the key information has not been tampered if the first data matches the partial-check data in the step (B) and the second data matches the whole-check data in the step (D).

29. The tampering detecting method of claim 28, wherein the whole-check data corresponds to second data which is obtained by executing cipher block chaining using the domain key with respect to concatenated data including m pieces of encrypted first data which have not been tampered and the second data, and extracting the second data as it is encrypted from the encrypted concatenated data.

30. The tampering detecting method of claim 28, wherein
the target apparatus includes:
a first memory area for storing the m pieces of encrypted content key information, the m pieces of encrypted first data, and the second data; and
a second memory area having a higher security level than that of the first memory area and for storing the domain key information.

31. The tampering detecting method of claim 23, wherein, in each of the m pieces of content key information, the first data is provided at a previously designated position in the content key information.

32. The tampering detecting method of claim 23, wherein, in each of the m pieces of content key information, the first data is provided as data having a predetermined length at a least significant position in the content key information.

33. The tampering detecting method of claim 23, wherein
the key information further includes m pieces of additional information in one-to-one correspondence with m pieces of content key information,
the partial-check data is stored at a predetermined position in each of the m pieces of additional information, and
in the step (B), the first data extracted in the step (A) is compared with partial-check data stored in additional information corresponding to content key information from which the first data is extracted.

34. A tampering detecting method performed by a host apparatus for detecting the presence or absence of tampering in key information stored in a target apparatus, wherein
the key information includes domain key information, m (m is a natural number) pieces of content key information, and m pieces of partial-check data,
each of the m pieces of content key information includes a content key used for encryption and decryption of a content,
the domain key information includes a domain key used for encryption and decryption of the m content keys, and whole-check data,
the m pieces of partial-check data are in one-to-one correspondence with the m pieces of content key information,
each of the m pieces of content key information is encrypted, and
the detecting method comprises the steps:
(A) executing a first operation with respect to any one of the m pieces of encrypted content key information to generate first data;
(B) comparing the first data generated in the step (A) with partial-check data corresponding to content key information subjected to the first operation in the step (A) of the m pieces of partial-check data;
(C) executing a second operation with respect to concatenated data including the m pieces of partial-check data to generate second data;
(D) comparing the second data generated in the step (C) with the whole-check data included in the domain key information; and
(E) determining that the key information has not been tampered if the first data matches the partial-check data in the step (B) and the second data matches the whole-check data in the step (D).

35. The tampering detecting method of claim 34, wherein
each of the m pieces of partial-check data corresponds to data which is obtained by executing the first operation with respect to content key information which corresponds to the partial-check data and has not been tampered, and
the whole-check data corresponds to data which is obtained by executing the second operation with respect to concatenated data including m pieces of partial-check data which have not been tampered.

36. The tampering detecting method of claim 34, wherein
the target apparatus includes:
a first memory area for storing the m pieces of encrypted content key information and the m pieces of partial-check data; and
a second memory area having a higher security level than that of the first memory area and for storing the domain key information.

37. The tampering detecting method of claim 34, wherein the first and second operations are each a hash operation.

38. The tampering detecting method of claim 25, wherein
the key information further includes an authentication key used for encryption and decryption of the domain key information,
the target apparatus further includes a third memory area having a higher security level than that of the second area and for storing the authentication key, and
the domain key information is encrypted.

39. The tampering detecting method of claim 38, wherein
the first memory area can be arbitrarily accessed by the host apparatus,
the second memory area can be accessed by the host apparatus if authentication is successful between the host apparatus and the target apparatus, and
the third memory area is used to execute mutual authentication between the host apparatus and the target apparatus.

40. The tampering detecting method of claim 39, wherein the third memory area is caused not to be rewritable after the authentication key is written thereinto.

41. The tampering detecting method of claim 23, wherein the target apparatus is a portable memory device which is operated in accordance with a clock and an operation instruction from the host apparatus.

42. A tampering detecting apparatus for detecting the presence or absence of tampering in key information stored in a target apparatus, wherein
the key information includes domain key information and m (m is a natural number) pieces of content key information,
each of the m pieces of content key information includes a content key used for encryption and decryption of a content, and first data corresponding to partial-check data used for a tampering detecting process,
the domain key information includes a domain key used for encryption and decryption of the m content keys, and whole-check data,
each of the m pieces of content key information is encrypted, and
the detecting apparatus comprises:
a data processing section for executing chaining decryption using the domain key with respect to any one of the m pieces of encrypted content key information, and extracting the first data from the decrypted content key information;
a first comparison section for comparing the first data extracted by the data processing section with previously prepared partial-check data;
a data generating section for extracting the first data as it is encrypted from each of the m pieces of content key information, and executing a predetermined operation with respect to concatenated data including the m pieces of extracted first data to generate second data;
a second comparison section for comparing the second data generated by the data generating section with the whole-check data included in the domain key information; and
a tampering determining section for determining that the key information has not been tampered if the first data matches the partial-check data in the first comparison section and the second data matches the whole-check data in the second comparison section.

43. A tampering detecting apparatus for detecting the presence or absence of tampering in key information stored in a target apparatus, wherein
the key information includes domain key information, m (m is a natural number) pieces of content key information, m pieces of encrypted first data, and second data,
each of the m pieces of content key information includes a content key used for encryption and decryption of a content, and first data corresponding to partial-check data used for a tampering detecting process,
the domain key information includes a domain key used for encryption and decryption of the m content keys, and whole-check data,
each of the m pieces of content key information is encrypted, and
the detecting apparatus comprises:
a first data processing section for executing chaining decryption using the domain key with respect to any one of the m pieces of encrypted content key information, and extracting the first data from the decrypted content key information;
a first comparison section for comparing the first data extracted by the first data processing section with previously prepared partial-check data;
a second data processing section for executing chaining decryption using the domain key with respect to concatenated data including the whole-check data included in the domain key information and the m pieces of encrypted first data, and extracting the whole-check data from the decrypted concatenated data;
a second comparison section for comparing the second data with the whole-check data extracted by the second data processing section; and
a tampering determining section for determining that the key information has not been tampered if the first data matches the partial-check data in the first comparison section and the second data matches the whole-check data in the second comparison section.

44. A tampering detecting apparatus for detecting the presence or absence of tampering in key information stored in a target apparatus, wherein
the key information includes domain key information, m (m is a natural number) pieces of content key information, and m pieces of partial-check data,
each of the m pieces of content key information includes a content key used for encryption and decryption of a content,
the domain key information includes a domain key used for encryption and decryption of the m content keys, and whole-check data,
the m pieces of partial-check data are in one-to-one correspondence with the m pieces of content key information,
each of the m pieces of content key information is encrypted, and
the detecting apparatus comprises:
a first operation section for executing a first operation with respect to any one of the m pieces of encrypted content key information to generate first data;
a first comparison section for comparing the first data generated by the first operation section with partial-check data corresponding to content key information subjected to the first operation by the first operation section of the m pieces of partial-check data;
a second operation section for executing a second operation with respect to concatenated data including the m pieces of partial-check data to generate second data;
a second comparison section for comparing the second data generated by the second operation section with the whole-check data included in the domain key information; and
a tampering determining section for determining that the key information have not been tampered if the first data matches the partial-check data in the first comparison section and the second data matches the whole-check data in the second comparison section.

45. A data structure of key information, wherein
the key information is stored in a target apparatus including a first memory area and a second memory area having a higher security level than that of the first memory area, and the presence or absence of tampering is detected therein by a host apparatus,
the key information comprises:
m (m is a natural number) pieces of content key information stored in the first memory area; and
domain key information stored in the second memory area,
each of the m pieces of content key information includes a content key used for encryption and decryption of a content, and first data corresponding to partial-check data used for a tampering detecting process by the host apparatus,
the domain key information includes a domain key used for encryption and decryption of the m pieces of content key information, and whole-check data used for the tampering detecting process by the host apparatus,
each of the m pieces of content key information is encrypted, and
the whole-check data corresponds to data which is obtained by extracting the first data as it is encrypted from each of m pieces of encrypted content key information which have not been tampered, and executing a predetermined operation with respect to concatenated data including the m pieces of extracted first data.

46. The key information data structure of claim 45, wherein the predetermined operation is a hash operation.

47. A data structure of key information, wherein
the key information is stored in a target apparatus including a first memory area and a second memory area having a higher security level than that of the first memory area, and the presence or absence of tampering is detected therein by a host apparatus,
the key information comprises:
m (m is a natural number) pieces of content key information, m pieces of encrypted first data, and second data stored in the first memory area; and
domain key information stored in the second memory area,
each of the m pieces of content key information includes a content key used for encryption and decryption of a content, and first data corresponding to partial-check data used for a tampering detecting process by the host apparatus,
the domain key information includes a domain key used for encryption and decryption of the m pieces of content key information, and whole-check data used for the tampering detecting process by the host apparatus,
the m pieces of encrypted first data are in one-to-one correspondence with the m pieces of content key information,
each of the m pieces of content key information is encrypted, and
the whole-check data corresponds to second data which is obtained by executing cipher block chaining using the domain key with respect to concatenated data including m pieces of encrypted first data which have not been tampered and the second data, and extracting the second data as it is encrypted from the encrypted concatenated data.

48. The key information data structure of claim 45, wherein, in each of the m pieces of content key information, the first data is provided at a previously designated position in the content key information.

49. The key information data structure of claim 45, wherein, in each of the m pieces of content key information, the first data is provided as data having a predetermined length at a least significant position in the content key information.

50. The key information data structure of claim 45, wherein
the key information further includes m pieces of additional information in one-to-one correspondence with m pieces of content key information,
the partial-check data is stored at a predetermined position in each of the m pieces of additional information.

51. A data structure of key information, wherein
the key information is stored in a target apparatus including a first memory area and a second memory area having a higher security level than that of the first memory area, and the presence or absence of tampering is detected therein by a host apparatus,
the key information comprises:
m (m is a natural number) pieces of content key information and m pieces of partial-check data stored in the first memory area; and
domain key information stored in the second memory area,
each of the m pieces of content key information includes a content key used for encryption and decryption of a content,
the domain key information includes a domain key used for encryption and decryption of the m pieces of content key information, and whole-check data used for a tampering detecting process by the host apparatus,
the m pieces of partial-check data are in one-to-one correspondence with the m pieces of content key information,
each of the m pieces of partial-check data corresponds to data which is obtained by executing a first operation with respect to content key information which corresponds to the partial-check data and has not been tampered, and
the whole-check data corresponds to data which is obtained by executing a second operation with respect to concatenated data including m pieces of partial-check data which have not been tampered.

52. The key information data structure of claim 51, wherein the first and second operations are each a hash operation.

53. The key information generating method of claim 4, wherein, in each of the m pieces of content key information, the first data is provided at a previously designated position in the content key information.

54. The key information generating method of claim 4, wherein, in each of the m pieces of content key information, the first data is provided as data having a predetermined length at a least significant position in the content key information.

55. The key information generating method of claim 4 further comprising the step of:
(F) putting additional information in which the partial-check data is stored at a predetermined position in correspondence with the m pieces of content key information,
wherein, in the step (E), further, the data writing section writes the m pieces of additional information into the first memory area.

56. The key information generating method of claims 4, wherein
the key information further includes an authentication key used for encryption and decryption of the domain key information,
the target apparatus further includes a third memory area having a higher security level than that of the second area and for storing the authentication key, and
the method further comprises the step:
(F) the data generating section encrypts the domain key information using the authentication key,
in the step (E), the data writing section writes the domain key information encrypted in the step (F) into the second memory area.

57. The key information generating method of claim 56, wherein
the first memory area can be arbitrarily accessed by the host apparatus,
the second memory area can be accessed by the host apparatus if authentication is successful between the host apparatus and the target apparatus, and
the third memory area is used to execute mutual authentication between the host apparatus and the target apparatus.

58. The key information generating method of claim 57, wherein the third memory area is caused not to be rewritable after the authentication key is written thereinto.

59. The key information generating method of claims 4, wherein the target apparatus is a portable memory device which is operated in accordance with a clock and an operation instruction from the host apparatus.

60. The key information generating method of claims 8, wherein
the key information further includes an authentication key used for encryption and decryption of the domain key information,
the target apparatus further includes a third memory area having a higher security level than that of the second area and for storing the authentication key, and
the method further comprises the step:
(F) the data generating section encrypts the domain key information using the authentication key,
in the step (E), the data writing section writes the domain key information encrypted in the step (F) into the second memory area.

61. The key information generating method of claim 60, wherein
the first memory area can be arbitrarily accessed by the host apparatus,
the second memory area can be accessed by the host apparatus if authentication is successful between the host apparatus and the target apparatus, and
the third memory area is used to execute mutual authentication between the host apparatus and the target apparatus.

62. The key information generating method of claim 61, wherein the third memory area is caused not to be rewritable after the authentication key is written thereinto.

63. The key information generating method of claims 8, wherein the target apparatus is a portable memory device which is operated in accordance with a clock and an operation instruction from the host apparatus.

64. The tampering detecting method of claim 28, wherein, in each of the m pieces of content key information, the first data is provided at a previously designated position in the content key information.

65. The tampering detecting method of claim 28, wherein, in each of the m pieces of content key information, the first data is provided as data having a predetermined length at a least significant position in the content key information.

66. The tampering detecting method of claim 28, wherein
the key information further includes m pieces of additional information in one-to-one correspondence with m pieces of content key information,
the partial-check data is stored at a predetermined position in each of the m pieces of additional information, and
in the step (B), the first data extracted in the step (A) is compared with partial-check data stored in additional information corresponding to content key information from which the first data is extracted.

67. The tampering detecting method of claim 30, wherein
the key information further includes an authentication key used for encryption and decryption of the domain key information,
the target apparatus further includes a third memory area having a higher security level than that of the second area and for storing the authentication key, and
the domain key information is encrypted.

68. The tampering detecting method of claim 67, wherein
the first memory area can be arbitrarily accessed by the host apparatus,
the second memory area can be accessed by the host apparatus if authentication is successful between the host apparatus and the target apparatus, and
the third memory area is used to execute mutual authentication between the host apparatus and the target apparatus.

69. The tampering detecting method of claim 68, wherein the third memory area is caused not to be rewritable after the authentication key is written thereinto.

70. The tampering detecting method of claim 28, wherein the target apparatus is a portable memory device which is operated in accordance with a clock and an operation instruction from the host apparatus.

71. The tampering detecting method of claim 36, wherein
the key information further includes an authentication key used for encryption and decryption of the domain key information,
the target apparatus further includes a third memory area having a higher security level than that of the second area and for storing the authentication key, and
the domain key information is encrypted.

72. The tampering detecting method of claim 71, wherein
the first memory area can be arbitrarily accessed by the host apparatus,
the second memory area can be accessed by the host apparatus if authentication is successful between the host apparatus and the target apparatus, and
the third memory area is used to execute mutual authentication between the host apparatus and the target apparatus.

73. The tampering detecting method of claim 72, wherein the third memory area is caused not to be rewritable after the authentication key is written thereinto.

74. The tampering detecting method of claim 34, wherein the target apparatus is a portable memory device which is operated in accordance with a clock and an operation instruction from the host apparatus.

75. The key information data structure of claim 47, wherein, in each of the m pieces of content key information, the first data is provided at a previously designated position in the content key information.

76. The key information data structure of claim 47, wherein, in each of the m pieces of content key information, the first data is provided as data having a predetermined length at a least significant position in the content key information.

77. The key information data structure of claim 47, wherein
the key information further includes m pieces of additional information in one-to-one correspondence with m pieces of content key information,
the partial-check data is stored at a predetermined position in each of the m pieces of additional information.
